(19) United States
(12) Patent Application Publication
(10) Pub. No.: US 2018/0089962 A1
(43) Pub. Date: Mar. 29, 2018

(54) DICE COLLECTION SKILL COMPETITION WAGERING SYSTEM

(71) Applicant: Gamblit Gaming, LLC, Glendale, CA (US)

(72) Inventor: Frank Cire, Pasadena, CA (US)

(21) Appl. No.: 15/716,317

(22) Filed: Sep. 26, 2017

Related U.S. Application Data
(60) Provisional application No. 62/489,051, filed on Apr. 24, 2017.
(60) Provisional application No. 62/471,519, filed on Mar. 15, 2017.
(60) Provisional application No. 62/400,050, filed on Sep. 26, 2016.

(51) Int. Cl. G07F 17/32

(52) U.S. Cl. CPC G07F 17/3295; G07F 17/3223; G07F 17/3209; G07F 17/3211; G07F 17/3244

(57) ABSTRACT

A dice collection skill competition wagering system is disclosed. The system includes an interactive controller, a credit processing controller, and a process controller. The interactive controller detects a skill outcome of a player's skillful play of a skill-based game and communicates the skill outcome to the process controller. The process controller communicates the skill outcome to a metering sub controller. The metering sub controller determines an application state, generates a unique identifier for the player, and communicates the application state and the unique identifier to the process controller. The process controller communicates the application state and the unique identifier to the credit processing controller, and the credit processing controller generate a credit output using the application state and the unique identifier. At the end of an application session, the player uses the credit output with the unique identifier to claim a prize.

### CROSS REFERENCE TO RELATED APPLICATIONS

This application claims the benefit of U.S. Provisional Patent Application No. 62/400,006, filed Sep. 26, 2016, U.S. Provisional Patent Application No. 62/471,519, filed Mar. 15, 2017, and of U.S. Provisional Patent Application No. 62/489,051 filed Apr. 24, 2017, the contents of which are incorporated by reference herein in its entirety.

### FIELD OF THE INVENTION

Embodiments of the invention are generally related to communications within data processing systems. More particularly, the invention relates to the communication and processing of wagering data.

### BACKGROUND

The gaming industry has traditionally developed electronic gaming machines (EGMs) that implement simple wagers. However, more complicated wagering processes need communication and processing systems that are better suited for implementing these more complicated wagering processes. Various aspects of embodiments of the invention meet such a need.

### SUMMARY OF THE INVENTION

Systems and methods in accordance with embodiments of the invention provide a communication and data processing system constructed for a dice collection skill competition wagering system.

In an embodiment of the invention, a process controller operates as an interface between an interactive controller that determines skill outcomes and a wagering sub-controller that determines chance-based components. By virtue of this feature, the wagering sub-controller is isolated from the interactive controller allowing the interactive controller to operate in an unregulated environment while allowing the wagering sub-controller to operate in a regulated environment, thus providing for more efficient management of the operations of such a system.

In another embodiment of the invention, a single wagering sub-controller may provide services to two or more interactive controllers, thus allowing a dice collection skill competition wagering system to operate more efficiently over a large range of scaling.

In another embodiment of the invention, multiple types of interactive controllers using different operating systems may be interfaced to a single type of process controller without requiring customization of the process controller and/or the wagering sub-controller, thus improving the efficiency of the process controller and/or the wagering sub-controller by reducing complexity associated with maintaining separate process controllers and/or wagering sub-controllers for each type of interactive controller.

In another embodiment of the invention, an interactive controller may be provided as a user device under control of a user while maintaining the process controller in an environment under the control of a regulated operator of wagering equipment, thus providing for a more economical system as the regulated operator need not expend capital to purchase interactive controllers.

In another embodiment of the invention, data communicated between the controllers may be encrypted to increase security of the dice collection skill competition wagering system.

In another embodiment of the invention, a process controller isolates chance-based component logic and skill proposition logic as unregulated logic from a regulated wagering sub-controller, thus allowing errors in the skill proposition logic and/or chance-based component logic to be corrected, new skill proposition logic and/or chance-based component logic to be used, or modifications to be made to the skill proposition logic and/or chance-based component logic without a need for time-consuming regulatory approval.

In another embodiment of the invention, an interactive application may require extensive processing resources from an interactive controller leaving few processing resources for the functions performed by a process controller and/or a wagering sub-controller. By virtue of an architecture of some embodiments of the invention, processing loads may be distributed across multiple devices such that operations of the interactive controller may be dedicated to an interactive application and the processes of the process controller and/or wagering sub-controller are not burdened by the requirements of the interactive application.

In another embodiment of the invention, a dice collection skill competition wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, one or more components of a dice collection skill competition wagering system are distributed in close proximity to each other and communicate using a local area network and/or a communication bus. In several embodiments, an interactive controller and a process controller of a dice collection skill competition wagering system are in a common location. In some embodiments, a process controller communicates with an external interactive controller. In various embodiments, these multiple controllers and sub-controllers can be constructed from or configured using a single device or a plurality of devices such that a dice collection skill competition wagering system is executed as a system in a virtualized space such as, but not limited to, where a wagering sub-controller and a process controller are large scale centralized servers and are operatively connected to distributed interactive controllers via a wide area network such as the Internet or a local area network. In such embodiments, the components of a dice collection skill competition wagering system may communicate using a networking protocol or other type of device-to-device communications protocol.

In another embodiment of the invention, an interactive controller is an interactive server acting as a host for managing head-to-head user interactions over a network of interactive sub-controllers connected to the interactive server using a communication link. The interactive server provides an environment where users can compete directly with one another and interact with other users.

### BRIEF DESCRIPTION OF THE DRAWINGS

FIG. 1 is a diagram of a structure of a dice collection skill competition wagering system in accordance with various embodiments of the invention.

FIG. 2A is a diagram of an electronic gaming machine configuration of a dice collection skill competition wagering system in accordance with various embodiments of the invention.

FIG. 2B is a diagram of a table electronic gaming machine configuration of a dice collection skill competition wagering system in accordance with various embodiments of the invention.

FIG. 2C is a diagram of virtual reality gaming machine configuration of a variable skill objective wagering system in accordance with various embodiments of the invention.

FIG. 3 is a diagram of distributed dice collection skill competition wagering systems in accordance with various embodiments of the invention.

FIGS. 4A and 4B are diagrams of a structure of an interactive controller of a dice collection skill competition wagering system in accordance with various embodiments of the invention.

FIG. 5 is a diagram of a structure of a process controller of a dice collection skill competition wagering system in accordance with various embodiments of the invention.

FIG. 6 is a diagram of a structure of a credit processing controller of a dice collection skill competition wagering system in accordance with various embodiments of the invention.

FIG. 7 is a block diagram of a process of a dice collection skill competition wagering system in accordance with various embodiments of the invention.

FIG. 8 is a sequence diagram of interactions between components of a dice collection skill competition wagering system in accordance with various embodiments of the invention.

FIG. 9 is a process flow diagram of interactions between components of a dice collection skill competition wagering system in accordance with various embodiments of the invention.

FIG. 10 is another process flow diagram of interactions between components of a dice collection skill competition wagering system in accordance with various embodiments of the invention.

FIG. 11 is another process flow diagram of interactions between components of a dice collection skill competition wagering system in accordance with various embodiments of the invention.

FIG. 12 is a program flow diagram of gameplay within a dice collection skill competition wagering system in accordance with various embodiments of the invention.

FIG. 13 is a program flow diagram of gameplay within a dice collection skill competition wagering system in accordance with various embodiments of the invention.

FIG. 14 is a program flow diagram of gameplay within a dice collection skill competition wagering system in accordance with various embodiments of the invention.

FIG. 15 is a diagram of some components of a dice collection baccarat skill competition wagering system in accordance with various embodiments of the invention.

FIG. 16 is a sequence diagram of a process implemented by components of a dice collection skill competition wagering system in accordance with various embodiments of the invention.

FIG. 17 is a sequence diagram of a process implemented by components of a dice collection skill competition wagering system in accordance with various embodiments of the invention.

FIGS. 18a and 18b are an example graphical user interface for a dice collection skill competition wagering system in accordance with various embodiments of the invention.

FIGS. 19a and 19b are an example graphical user interface for a dice collection skill competition wagering system in accordance with various embodiments of the invention.

FIGS. 20a and 20b are an example graphical user interface for a dice collection skill competition wagering system in accordance with various embodiments of the invention.

FIGS. 21a and 21b are an example graphical user interface for a dice collection skill competition wagering system in accordance with various embodiments of the invention.

FIGS. 22a and 22b are an example graphical user interface for a dice collection skill competition wagering system in accordance with various embodiments of the invention.

FIGS. 23a and 23b are an example graphical user interface for a dice collection skill competition wagering system in accordance with various embodiments of the invention.

FIGS. 24a and 24b are an example graphical user interface for a dice collection skill competition wagering system in accordance with various embodiments of the invention.

FIGS. 25a and 25b are an example graphical user interface for a dice collection skill competition wagering system in accordance with various embodiments of the invention.

FIGS. 26 to 31 are illustrations of a process of a dice collection skill competition wagering system in accordance with various embodiments of the invention.

### DETAILED DESCRIPTION

A dice collection skill competition wagering system allows for the management of a wagering proposition having a skill proposition for one or more users where the skill proposition has one or more chance-based components generated in accordance with a chance proposition. In some embodiments of a dice collection skill competition wagering system, an interactive application executed by an interactive controller provides skill proposition components of the dice collection skill competition wagering system. The interactive controller is operatively connected to a process controller that manages and configures the interactive controller and the interactive application, and determines skill propositions having chance-based components determined by a wagering sub-controller that are resolved as skill outcomes determined by the interactive application.

In some embodiments, the interactive controller also provides a wagering user interface that is used to receive commands and display data for a wagering process and wagering outcome determined from the skill outcome in accordance with a wagering proposition. The content of the wagering user interface is controlled by the process controller and includes content provided by the wagering sub-controller and the interactive controller.

In various embodiments, an interactive controller provides a management user interface used to manage a user profile.

Many different types of interactive applications may be utilized with the dice collection skill competition wagering system. In some embodiments, the interactive application reacts to the physical activity of a user. In these embodiments, the interactive application senses user interactions with the interactive application through one or more sensors that monitor the user's physical activities. Such sensors may include, but are not limited to, physiological sensors that monitor the physiology of the user, environmental sensors that monitor the physical environment of the interactive controller, accelerometers that monitor changes in motion of the interactive controller, and location sensors that monitor the location of the interactive controller such as global positioning sensors.

In some embodiments, the interactive application implements a skill-based game and interacts with the user by sensing skillful interactions with an interactive user interface generated by the interactive application.

In many embodiments, the interactive application generates various types of interactive elements in an interactive application environment. In some embodiments, these interactive elements are interactive application resources utilized within the interactive application environment to provide an interactive experience for a user.

In accordance with some embodiments, a chance-based component of the skill proposition can influence interactive elements in the interactive application environment such as, but not limited to, automatically providing one or more new interactive elements, automatically restoring one or more consumed interactive elements, automatically causing the loss of one or more interactive elements, and automatic restoration or placement of one or more fixed interactive elements.

In various embodiments, the wagers may be made using one or more credits.

In some embodiments, credits can be one or more credits that are purchased using, and redeemed in, a real world currency having a real world value.

In many embodiments, credits can be one or more credits in a virtual currency. Virtual currency is an alternate currency that can be acquired, purchased or transferred by or to a user, but does not necessarily directly correlate to a real world currency. In many such embodiments, credits in a virtual currency are allowed to be purchased using a real world currency but are prevented from being redeemed in a real world currency having a real world value.

In several embodiments, interaction with the interactive elements of the interactive application, application credits can be optionally consumed and/or accrued within the interactive application as a result of interaction with the interactive elements. Application credits can be in the form of, but not limited to, application environment credits, experience points, and points generally.

In various embodiments, application credits are awarded on the basis of skillful interactions with the interactive elements of a skill-based interactive application. The skill-based interactive application can have one or more scoring criteria, embedded within a process controller and/or an interactive controller that provides the skill-based interactive application, that can be used to determine user performance against one or more goals of the skill-based interactive application in accordance with a skill proposition.

In many embodiments, application credits can be used to purchase in-application items, including but not limited to, application interactive elements that have particular properties, power ups for existing items, and other item enhancements.

In some embodiments, application credits may be used to earn entrance into a sweepstakes drawing, to earn entrance in a tournament with prizes, to score in the tournament, and/or to participate and/or score in any other game event.

In several embodiments, application credits can be stored on a user-tracking card, voucher or in a network-based user tracking system where the application credits are attributed to a specific user.

In many embodiments, a wagering proposition includes a wager of application credits for payout of application credits, interactive application elements, and/or interactive application objects in accordance with the chance-based proposition.

In a number of embodiments, a wager of an amount of credits results in a payout of application credits, interactive elements, and/or interactive application objects that have a credit value if cashed out.

In some embodiments, interactive application objects include in-application objects that may be utilized to enhance user interactions with the interactive application. Such objects include, but are not limited to, power-ups, enhanced in-application items, and the like. In some embodiments, the interactive application objects include objects that are detrimental to user interactions with the interactive application such as, but not limited to, obstructions in the interactive application space, a temporary handicap, an enhanced opponent, and the like.

In numerous embodiments, an interactive application command is an instruction by a process controller to an interactive controller and/or an interactive application of the interactive controller to modify a state of an interactive application or modify one or more interactive application resources or interactive elements. In some embodiments, the interactive application commands may be automatically generated by the process controller using one or more of a chance-based component and/or application environment variables. An interactive application command can be used by a process controller control many processes of an interactive application, such as, but not limited to, an causing an addition of a period of time available for a current interactive application session for the interactive application, an addition of a period of time available for a future dice collection skill competition wagering system interactive application session or any other modification to the interactive application interactive elements that can be utilized during an interactive application session.

In some embodiments, asynchronous communications provided for by a dice collection skill competition wagering system may reduce an amount of idle waiting time by an interactive controller of the dice collection skill competition wagering system, thus increasing an amount of processing resources that the interactive controller may provide to an interactive application or other processes of the interactive controller. In many embodiments, asynchronous communications provided for by a dice collection skill competition wagering system reduces an amount of idle waiting time by a process controller, thus increasing an amount of processing resources that the process controller may provide to determine chance-based components, and other processes provided by the process controller.

In some embodiments, a wagering sub-controller of a dice collection skill competition wagering system may be operatively connected to a plurality of interactive controllers through a process controller and the asynchronous communications provided for by the process controllers allows the wagering sub-controller to operate more efficiently by providing chance outcomes to a larger number of interactive controllers than would be achievable without the process controller of the dice collection skill competition wagering system.

In some embodiments, a dice collection skill competition wagering system including a process controller operatively connected to a wagering sub-controller and operatively connected to an interactive controller wherein the process controller provides for simplified communication protocols for communications of the interactive controller as the interactive controller may communicate interactions with an interactive application provided by the interactive controller to the process controller without regard to a nature of a chance-based proposition.

In various embodiments, a dice collection skill competition wagering system including a process controller operatively connected to a wagering sub-controller and operatively connected to an interactive controller may provide for simplified communication protocols for communications of the wagering sub-controller as the wagering sub-controller may receive skill proposition requests and communicate determined skill propositions having chance-based components without regard to a nature of an interactive application provided by the interactive controller.

In some embodiments, a dice collection skill competition wagering system including a process controller operatively connecting a wagering sub-controller to an interactive controller may provide for reduced processing requirement for the interactive controller by offloading the execution of a random number generator from the interactive controller to the process controller. In various such embodiments, additional processing resources may be made available to graphics processing or other processing intensive operations by the interactive controller because of the offloaded random number processing.

In various embodiments, a dice collection skill competition wagering system including a process controller operatively connecting a wagering sub-controller to an interactive controller provides for operation of the interactive controller in an unsecure location or manner, while providing for operation of the wagering sub-controller in a secure location or manner.

In some embodiments, a dice collection skill competition wagering system including a process controller operatively connecting a wagering sub-controller to an interactive controller allows the skill competition wagering system to have regulated components coupled to unregulated components in a heterogeneous regulated environment. For example, in several such embodiments, the interactive controller may be a device that is not regulated by a wagering regulatory agency whereas the wagering sub-controller is regulated by the wagering regulatory agency. A process controller of a dice collection skill competition wagering system may provide for isolation of the processing of the interactive controller from the processing of the wagering sub-controller. In such a heterogeneous regulatory environment, the process controller may or may not be itself a regulated by the wagering regulatory authority. In addition, components of an interactive application executed by the interactive controller may be either regulated or unregulated by the wagering regulatory agency.

dice collection Skill Competition Systems

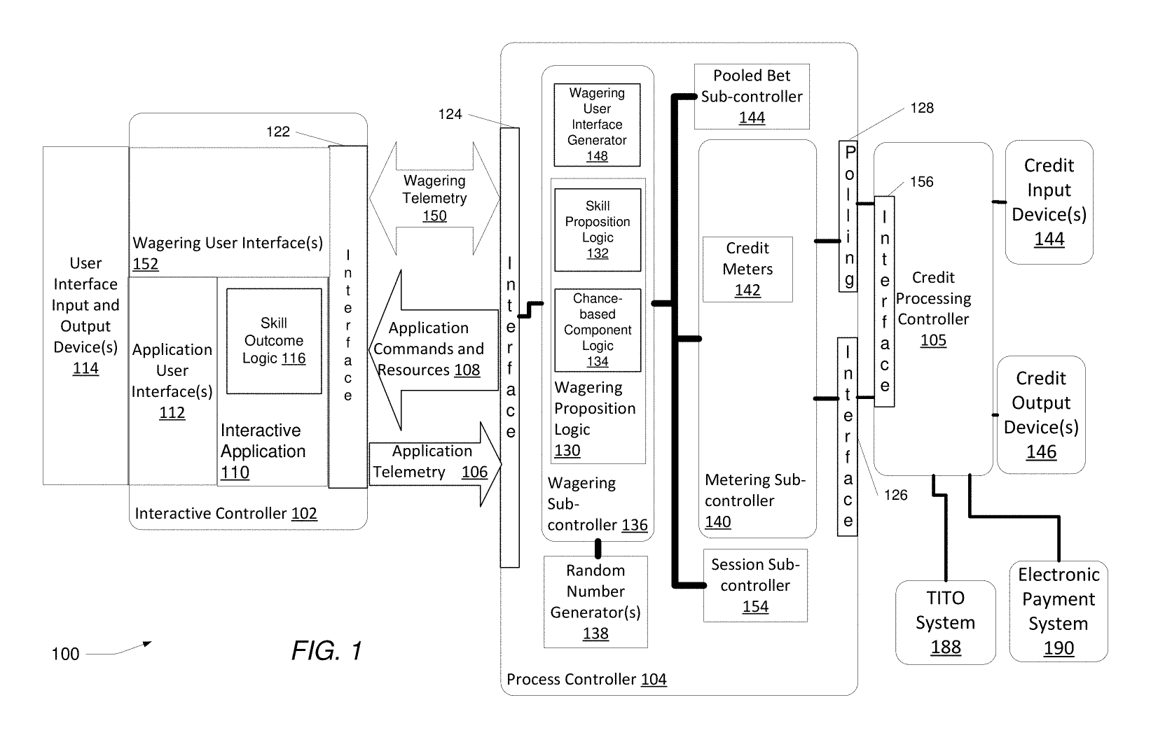

FIG. 1 is a diagram of a structure of a dice collection skill competition wagering system in accordance with various embodiments of the invention. The dice collection skill competition wagering system 100 includes an interactive controller 102, a process controller 104, and a credit processing controller 105. The interactive controller 102 is operatively connected to, and communicates with, the process controller 104. The process controller 104 is also operatively connected to, and communicates with, the credit processing controller 105.

In various embodiments, the interactive controller 102 executes an interactive application 110 and provides one or more user interface input and output devices 114 so that one or more users can interact with the interactive application 110. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The interactive controller 102 provides for user interactions with the interactive application 110 by executing the interactive application 110 that generates an application user interface 112 that utilizes the user interface input devices to detect user interactions with the interactive controller 102 and generates an interactive user interface that is presented to the user utilizing the user interface output devices.

In some embodiments, one or more components an interactive controller are housed in an enclosure such as a housing, cabinet, casing or the like. The enclosure further includes one or more user accessible openings or surfaces that to mount the user interface input devices and/or the user interface output devices.

The interactive controller 102 is operatively connected to, and communicates with, the process controller 104. The interactive controller 102 receives application command and resource data 108 including skill proposition data, application command data, and resource data, from the process controller 104. Via the communication of the application command and resource data 108, the process controller 104 can control the operation of the interactive controller 102 by communicating control parameters to the interactive application 110 during the interactive application's execution by the interactive controller 102.

In some embodiments, during execution of the interactive application 110 by the interactive controller 102, the interactive controller 102 communicates, as application telemetry data 106, user interactions with one or more interactive elements of the application user interfaces 112 of the interactive application to the process controller 104. the application telemetry data 106 may include, but is not limited to, application environment variables that indicate the state of the interactive application 110, interactive controller data indicating a state of the interactive controller 102, user actions and interactions between one or more users and the interactive application 110 provided by the interactive controller 102, and utilization of interactive elements in the interactive application 110 by one or more users.

In some embodiments, the application telemetry 106 includes a skill outcome as determined by the interactive application 110 using skill outcome logic 116, the application command and resource data 108, and user interactions with one or more application user interfaces 112 of the interactive application.

In some embodiments, the interactive application 110 is a skill-based interactive application. In such embodiments, execution of the skill-based interactive application 110 by the interactive controller 102 is based on one or more users' skillful interaction with the interactive application 110, such as, but not limited to, the users' utilization of the interactive elements of the interactive application during the users' skillful interaction with the skill-based interactive application. In such an embodiment, the process controller 104 communicates with the interactive controller 102 in order to allow the coupling of the skill-based interactive application to chance-based components determined in accordance with a chance-based proposition of the wagering sub-controller 136.

In some embodiments, the interactive application 110 uses skill proposition data, interactive application command data, and/or resource data included in the application commands and resources 108 to generate a skill proposition presented to one or more users as one or more application user interfaces 112 using one or more output devices of user interface and output device(s) 114. The one or more users skillfully interact with the one or more application user interfaces 112 using one or more of input devices of the user interface input and output devices 114. The interactive application 110 determines a skill outcome based on the skillful interactions of the one or more users and communicates data of the determined skill outcome to the process controller 104 as part of the application telemetry 106. In some embodiments, the interactive application 110 also communicates as part of the application telemetry data 106, data encoding the one or more users' interactions with the interactive application 110.

In some embodiments, the skill outcome logic 116 and the skill proposition data included in the application commands and resources 108 are for a skill proposition for one or more users. The interactive application 110 determines skill outcomes based on the skill proposition and the one or more users' skillful interactions with the interactive application. The skill outcomes are communicated by the interactive controller 102 to the process controller 104 included in the application telemetry 106.

In some embodiments, the interactive controller 102 includes one or more sensors that sense various aspects of the physical environment of the interactive controller 102. Examples of sensors include, but are not limited to: global positioning sensors (GPSs) for sensing communications from a GPS system to determine a position or location of the interactive controller; temperature sensors; accelerometers; pressure sensors; and the like. Sensor telemetry data is communicated by the interactive controller to the process controller 104 as part of the application telemetry data 106. The process controller 104 receives the sensor telemetry data and uses the sensor telemetry data to make wagering decisions.

In many embodiments, the interactive controller 102 includes one or more wagering user interfaces 118 used to display wagering data, via one or more of the user interface input and output devices 114, to one or more users.

In various embodiments, an application control interface 122 resident in the interactive controller 102 provides an interface between the interactive controller 102 and the process controller 104.

In some embodiments, the application control interface 122 implements an interactive controller to process controller communication protocol employing an interprocess communication protocol so that the interactive controller and the process controller may be implemented on the same device. In operation, the application control interface 122 provides application programming interfaces that are used by the interactive application 110 of the interactive controller 102 to communicate outgoing data and receive incoming data by passing parameter data to another process or application.

In some embodiments, the application control interface 122 implements an interactive controller to process controller communication protocol employing an interdevice communication protocol so that the interactive controller and the process controller may be implemented on different devices. The interdevice protocol may utilize a wired communication bus or wireless connection as a physical layer.

In various embodiments, the application control interface 122 implements an interactive controller to process controller communication protocol employing a networking protocol so that the interactive controller and the process controller may be implemented on different devices connected by a network. The networking protocol may utilize a wired communication bus or wireless connection as a physical layer. In many such embodiments, the network includes a cellular telephone network or the like and the interactive controller is a mobile device such as a smartphone or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

The process controller 104 provides an interface between a skill propositison resolved for one or more users when skillfully interacting with the interactive application 110 provided by the interactive controller 102, and a chance-based component, provided in-part by a wagering sub-controller 136.

In various embodiments, the process controller 104 includes a wagering sub-controller 136 having a rule-based decision engine that receives application telemetry data 106 from the interactive controller 102. The rule-based decision engine has wagering proposition logic 130 including skill proposition logic 132 and chance-based component logic 134. The decision engine uses the application telemetry data 106, along with chance-based component logic 134, and a random outcome generated by one or more random number generators (RNGs) 138 to generate a chance-based component of a skill proposition.

In an embodiment, the application telemetry data 106 used by the decision engine encodes data about the operation of the interactive application 110 executed by the interactive controller 102.

In some embodiments, the application telemetry data 106 encodes interactions of a user, such as a user's interaction with an interactive element of the interactive application 110.

In many embodiments, the application telemetry data 106 includes a state of the interactive application 110, such as values of variables that change as the interactive application 110 executes.

In several embodiments, the decision engine includes one or more rules as part of chance-based component logic 134 used by the decision engine 122 to determine how a chance-based component should generated. Each rule includes one or more variable values constituting a pattern that is to be matched by the wagering sub-controller 136 using the decision engine to one or more variable values encoded in the application telemetry data 106. Each rule also includes one or more actions that are to be taken if the pattern is matched. Actions can include automatically generating the chance-based component in accordance with the chance-based component logic 134 and a random outcome generated by one or more random number generators 138. During operation, the decision engine receives application telemetry data 106 from the interactive controller 102 via interface 160. The decision engine performs a matching process of matching the variable values encoded in the application telemetry data 106 to one or more variable patterns of one or more rules. If a match between the variable values and a pattern of a rule is determined, then the wagering controller 104 performs the action of the matched rule.

In some embodiments, the wagering sub-controller 136 uses the chance-based component in conjunction with the application telemetry data 106 and skill proposition logic 132, to automatically generate application command and resource data 108 including skill proposition data of a skill proposition that the process controller 104 communicates to the interactive controller 102 via interfaces 124 and 122.

In some embodiments, the decision engine includes one or more rules as part of skill proposition logic 132 used by the decision engine to automatically generate the application command and resource data 108 that is then communicated to the interactive controller 102. Each rule includes one or more variable values constituting a pattern that is to be matched to one or more variable values encoded in the application telemetry data 106 and the chance-based component. Each rule also includes one or more actions that are to be automatically taken by the wagering sub-controller 136 if the pattern is matched. Actions can include automatically generating skill proposition data, interactive application command data, and/or resource data 108 and using the skill proposition data, interactive application command data, and/or resource data 108 to control the interactive controller 102 to affect execution of the interactive application 110 as described herein. In operation, wagering sub-controller 104 uses the decision engine 122 to match the variable values encoded in the in the chance-based component data to one or more patterns of one or more rules of the skill proposition logic 132. If a match between the variable values and a pattern of a rule is found, then the process controller automatically performs the action of the matched rule. In some embodiments, the process controller 104 uses the application telemetry data 106 received from the interactive controller 102 in conjunction with the chance-based component to generate the skill proposition data, interactive application command data, and/or resource data 108.

The interactive controller receives the skill proposition data, interactive application command data, and resource data 108 and automatically uses the skill proposition data, interactive application command data, and/or resource data 108 to configure and command the processes of the interactive application 110.

In some embodiments, the interactive application 110 operates utilizing a scripting language. The interactive application 110 parses scripts written in the scripting language and executes commands encoded in the scripts and sets variable values as defined in the scripts. In operation of such embodiments, the process controller 104 automatically generates skill proposition data, interactive application command data, and/or resource data 108 in the form of scripts written in the scripting language that are communicated to the interactive controller 102 during execution of the interactive application 110. The interactive controller 102 receives the scripts and passes them to the interactive application 110. The interactive application 110 receives the scripts, parses the scripts and automatically executes the commands and sets the variable values as encoded in the scripts.

In many embodiments, the interactive application 110 automatically performs processes as instructed by commands communicated from the process controller 104. The commands command the interactive application 110 to perform specified operations such as executing specified commands and/or setting the values of variables utilized by the interactive application 110. In operation of such embodiments, the process controller 104 automatically generates commands that are encoded into the skill proposition data, interactive application command data, and/or resource data 108 that are communicated to the interactive controller 102. The interactive controller 102 passes the skill proposition data, interactive application command data, and/or resource data 108 to the interactive application 110. The interactive application parses the skill proposition data, interactive application command data, and/or resource data and automatically performs operations in accordance with the commands encoded in the skill proposition data, interactive application command data, and/or resource data 108.

In many embodiments, the process controller 104 includes a pseudo random or random result generator used to generate random results that are used by the decision engine to generate portions of the skill proposition data, interactive application command data, and/or resource data 108.

In various embodiments, the process controller 104 includes one or more interfaces, 124, 126 and 128 that operatively connect the process controller 104 to one or more interactive controllers, such as interactive controller 102, and to one or more credit processing controllers, such as credit processing controller 105.

In some embodiments, one or more of the process controller interfaces implement a process controller to device or server communication protocol employing an interprocess communication protocol so that the process controller and one or more of an interactive controller, a wagering sub-controller, and/or a session sub-controller may be implemented on the same device. In operation, the process controller interfaces provide application programming interfaces or the like that are used by the process controller to communicate outgoing data and receive incoming data by passing parameter data to another process or application running on the same device.

In some embodiments, one or more of the process controller interfaces implement a process controller communication protocol employing an interdevice communication protocol so that the process controller may be implemented on a device separate from the one or more interactive controllers, the one or more session sub-controllers and/or the one or more wagering sub-controllers. The interdevice protocol may utilize a wired communication bus or wireless connection as a physical layer. In various embodiments, one or more of the process controller interfaces implement a process controller communication protocol employing a networking protocol so that the process controller may be operatively connected to the one or more interactive controllers, the one or more session sub-controllers, and/or the one or more wagering sub-controllers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more process controller interfaces communicate outgoing data to an external device or server by encoding the data into a signal and transmitting the signal to the external device or server. The one or more process controller interfaces receive incoming data from an external device or server by receiving a signal transmitted by the external device or server and decoding the signal to obtain the incoming data.

In several embodiments, the wagering sub-controller 136 is a controller for providing one or more wagers in accordance with one or more skill propositions provided by the dice collection skill competition wagering system 100. Types of value of a wager can be one or more of several different types. Types of value of a wager can include, but are not limited to, a wager of an amount of credits corresponding to a real currency or a virtual currency, a wager of an amount of application credits earned through interaction with an interactive application, a wager of an amount of interactive elements of an interactive application, and a wager of an amount of objects used in an interactive application. A skill outcome determined for a wager in accordance with a skill proposition can increase or decrease an amount of the type of value used in the wager, such as, but not limited to, increasing or decreasing an amount of credits for a wager of credits. In various embodiments, a skill outcome determined for a wager in accordance with a skill proposition can increase or decrease an amount of a type of value that is different than a type of value of the wager, such as, but not limited to, increasing an amount of an object of an interactive application for a wager of credits.

In many embodiments, the process controller 104 includes one or more random number generators (RNGs) 138 for generating random outcomes. The wagering sub-controller uses the one or more random outcomes along with the chance-based component logic 130 to generate a chance-based component of a skill proposition.

In several embodiments, the process controller 104 includes a metering sub-controller 140 operatively connected to the credit processing controller 105 via interfaces 126 and 128. The metering sub-controller 140 communicates with the credit processing controller 105 to receive incoming credit data from the credit processing controller 105. The metering sub-controller 140 uses the incoming credit data to transfer credits into the dice collection skill competition wagering system and onto one or more credit meters 142. The metering sub-controller 140 communicates outgoing credit data to the credit processing controller 105 to transfer credits off of the one or more credit meters 142 and out of the dice collection skill competition wagering system.

In several embodiments, during operation, the metering sub-controller 140 communicates with the credit processing controller 105 to receive incoming credit data from the credit processing controller 105 and adds credits onto the one or more credit meters 110 at least partially on the basis of the incoming credit data. The one or more random number generators 138 execute processes that generate random results. The wagering sub-controller 136 uses the change-based component logic 134 and the random results to generate a chance-based component of a skill proposition. The wagering sub-controller uses the chance-based component along with the skill proposition logic 132 to generate a skill proposition. The skill proposition is communicated by the process controller as part of the application command and resource data 108 to the interactive controller 102. The interactive application 110 uses the skill proposition data along with the skill outcome logic 116 to generate a presentation for the use including the one or more user interfaces 112. One or more users interact with the one or more application user interfaces 112 through the one or more user interface input and output devices 114. The interactive application 110 determines a skill outcome based on the interactions of the one or more users and communicates data of the skill outcome as part of the application telemetry data 106 to the process controller 104. The wagering sub controller 136 receives the skill outcome data and instructs the metering sub-controller 140 to add credits to, or deduct credits from, the one or more credit meters 110 based in part on the skill outcome data. For example, in some embodiments, the metering sub-controller is instructed to add an amount of credits to a credit meter of the one or more credit meters 110 when the skill outcome indicates a win for a user associated with the credit meter. In various embodiments, the metering sub-controller is instructed to deduct an amount of credits from the credit meter when the skill outcome indicates a loss for the user. At an end of a wagering session, the metering sub-controller 140 transfers credits off of the one or more credit meters 110 and out of the dice collection skill competition wagering system by communicating outgoing credit data to the credit processing controller 105.

In many embodiments, the one or more random number generators 138 generate random numbers by continuously generating pseudo random numbers using a pseudo random number generator. A most current pseudo random number is stored in a buffer thus constantly refreshing the buffer. In many embodiments, the buffer is refreshed at a rate exceeding 100 times per second. When the wagering sub-controller 136 requests a random result, the wagering sub-controller 136 receives the stored most current pseudo random number from the buffer. As timing between requests for a random result is not deterministic, the resulting output from the buffer is a random result such as a random number.

In some embodiments, a range of the value of a random number is mapped to one or more symbols representing one or more elements of a traditional chance-based proposition. In several such embodiments, a random number is mapped to a virtual card of a deck of virtual cards. In another such embodiment, the random number is mapped to a virtual face of a virtual die. In yet another such embodiment, the random number is mapped to symbol of a virtual reel strip on a virtual reel slot machine. In yet another such embodiment, the random number is mapped to a pocket of a virtual roulette wheel. In some embodiments, two or more random numbers are mapped to appropriate symbols to represent a completed chance-based proposition. In one such embodiment, two or more random numbers are mapped to faces of two or more virtual dice to simulate a random result generated by throwing two or more dice. In another such embodiment, multiple random numbers are mapped to virtual cards from a virtual deck of cards without replacement. In yet another such embodiment, two or more random numbers are mapped to two or more virtual reel strips to create stop positions for a virtual multi-reel slot machine.

In some embodiments, a wagering sub-controller determines a chance-based component and a skill proposition by executing proposition determination commands included in chance-based component logic and skill proposition logic that define processes of a wagering proposition where the proposition determination commands are formatted in a scripting language. In operation, a decision engine of a process controller generates the proposition determination commands in the form of a script written in the scripting language. The script includes the proposition determination commands that describe how the wagering sub-controller is to generate a skill proposition. The wagering sub-controller parses the script encoded in the chance proposition determination command data and executes the commands included in the script to generate the skill proposition.

In some embodiments, a wagering sub-controller determines a chance-based component and a skill proposition by executing proposition determination commands that define processes of the wagering user interface. In operation, a decision engine of a process controller generates the proposition determination commands. The wagering sub-controller receives the proposition determination commands and executes the proposition determination commands to generate the skill proposition.

In various embodiments, the process controller 104 uses a rule-based decision engine to automatically determine an amount of application credits to award to a user based at least in part on the application telemetry data 106 including skill outcome data and user interaction data with the interactive application 110 of the dice collection skill competition wagering system. In numerous embodiments, the interactive application 110 is a skill-based interactive application and the application credits are awarded for a user's skillful interaction with the interactive application 110.

In some embodiments, the wagering sub-controller 136 uses a wagering user interface generator 148 to automatically generate wagering telemetry data 150 on the basis of amounts of credits on the one or more credit meters 142. The wagering telemetry data 150 is used by the process controller 104 to command the interactive controller 102 to automatically generate one or more wagering user interfaces 152 describing a state of wagered credit accumulation and loss for the dice collection skill competition wagering system. When a user interacts with the one or more wagering user interfaces 152, wagering user interface telemetry data 150 is generated by the one or more wagering user interfaces 152 and communicated by the interactive controller 102 to the process controller 104 using interfaces 122 and 124.

In some embodiments, the wagering telemetry data 150 may include, but is not limited to, amounts of application credits and interactive elements earned, lost or accumulated through interaction with the interactive application 110, and credits, application credits and interactive elements amounts won, lost or accumulated.

In some embodiments, the skill proposition data, interactive application command data, and/or resource data 108 are communicated to the wagering user interface generator 148 and used as a partial basis for generation of the wagering telemetry data 150 communicated to the interactive controller 102.

In various embodiments, the wagering user interface generator 148 also receives chance-based component data that is used as a partial basis for generation of the wagering telemetry data 150 communicated to the interactive controller 102. In some embodiments, the chance-based component data also includes data about one or more states of a wager of the skill proposition as generated by the wagering sub-controller 136. In various such embodiments, the wagering user interface generator 148 generates a chance-based component generation process display and/or chance-based component state display using the one or more states of the chance-based component. The chance-based component generation process display and/or chance-based component state display is included in the wagering telemetry data 150 that is communicated to the interactive controller 102. The wagering process display and/or wagering state display is automatically displayed by the interactive controller 102 using the one or more wagering user interfaces 152. In other such embodiments, the one or more states of the chance-based component are communicated to the interactive controller 102 and the interactive controller 102 is instructed to automatically generate the chance-based component generation process display and/or chance-based component state display of the one or more wagering user interfaces 152 using the one or more states of the chance-based component for display.

In some embodiments, the chance-based component includes state data about execution of a chance-based proposition of the chance-based component logic 134, including but not limited to a final state, intermediate state and/or beginning state of the chance-based proposition. For example, in a chance-based proposition that is based on slot machine math, the final state of the chance-based proposition may be reel positions, in a chance-based proposition that is based on roulette wheel math, the final state may be a pocket where a ball may have come to rest, in a chance-based proposition that is a based on card math, the beginning, intermediate and final states may represent a sequence of cards being drawn from a deck of cards, etc.

In some embodiments, an interactive controller generates a wagering user interface by executing commands that define processes of the wagering user interface where the commands are formatted in a scripting language. In operation, a wagering user interface generator of a process controller generates commands in the form of a script written in the scripting language. The script includes commands that describe how the interactive controller is to display wagering outcome data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. In operation, a wagering user interface generator of a process controller generates a document composed in the document markup language. The document includes commands that describe how the interactive controller is to display wagering outcome data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. In operation, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic and audio display resources that the interactive controller uses to generate a wagering user interface as described herein.

In many embodiments, a process controller communicates graphic and audio display resources as part of wagering telemetry data to an interactive controller. The interactive controller uses the graphic and audio display resources to generate a wagering user interface as described herein.

In many embodiments, the process controller 104 may additionally include various audit logs and activity meters.

The process controller 104 can further operatively connect to a metering sub-controller to determine an amount of credit or interactive elements available and other wagering metrics of a wagering proposition. Thus, the process controller 104 may potentially affect an amount of credits in play for participation in the wagering events of the wagering proposition provided by the wagering sub-controller. In some embodiments, the process controller 104 can also couple to a centralized server for exchanging various data related to users and the activities of the users during utilization of a dice collection skill competition wagering system.

In a number of embodiments, communication of chance-based component determination commands and skill proposition commands between the wagering sub-controller 136 and the process controller 104 can further be used to communicate various wagering control factors that the wagering sub-controller uses as input. Examples of wagering control factors include, but are not limited to, an amount of credits, amount of application credits, amount of interactive elements, or amounts of objects consumed wager, and/or a user's election to enter a jackpot round.

In many embodiments, two or more users can be engaged in using the interactive application 110 executed by the interactive controller 102. In various embodiments, a dice collection skill competition wagering system can include an interactive application 110 that provides a skill-based interactive application that includes head-to-head play between a single user and a computing device, between two or more users against one another, or multiple users playing against a computer device and/or each other. In some embodiments, the interactive application 110 can be a skill-based interactive application where the user is not skillfully playing against the computer or any other user such as skill-based interactive applications where the user is effectively skillfully playing against himself or herself.

In some embodiments, the process controller 104 utilizes the one or more wagering user interfaces 152 to communicate certain interactive application data to the user, including but not limited to, club points, user status, control of the selection of choices, and messages which a user can find useful in order to adjust the interactive application experience or understand the wagering status of the user.

In some embodiments, the process controller 104 utilizes the one or more wagering user interfaces 152 to communicate aspects of a wagering proposition to a user including, but not limited to, amount of credits, application credits, interactive elements, or objects in play, and amounts of credits, application credits, interactive elements, or objects available.

In a number of embodiments, the wagering sub-controller 136 can accept wagering proposition factors including, but not limited to, modifications in the amount of credits, application credits, interactive elements, or objects wagered on each individual wagering event, entrance into a bonus round, and other factors. In several embodiments, the process controller 104 can communicate a number of factors back and forth to the wagering sub-controller, such that an increase/decrease in a wagered amount can be related to the change in user profile of the user in the interactive application. In this manner, a user can control a wager amount per wagering event in accordance with the wagering proposition with the change mapping to a parameter or component that is applicable to the interactive application experience.

In some embodiments, the process controller 104 includes a session sub-controller 154 is used to regulate a dice collection skill competition wagering system session.

In various embodiments, the session sub-controller 154 includes one or more session sub-controller interfaces that operatively connect the session sub-controller 154 to one or more wagering sub-controllers, metering sub-controllers and pooled bet sub-controllers through their respective interfaces.

In some embodiments, one or more of the session sub-controller interfaces implement a session sub-controller to device or server communication protocol employing an interprocess communication protocol so that the session sub-controller and one or more of an interactive controller, a wagering sub-controller, and/or a process controller may be implemented on the same device. In operation, the session sub-controller interfaces provide application programming interfaces or the like that are used by the session sub-controller to communicate outgoing data and receive incoming data by passing parameter data to another process or application running on the same device.

In some embodiments, one or more of the session sub-controller interfaces implement a session sub-controller communication protocol employing an interdevice communication protocol so that the session sub-controller may be implemented on a device separate from the one or more interactive controllers, the one or more process controllers and/or the one or more wagering sub-controllers. The interdevice protocol may utilize a wired communication bus or wireless connection as a physical layer. In various embodiments, one or more of the session sub-controller interfaces implement a session sub-controller communication protocol employing a networking protocol so that the process session sub-controller may be operatively connected to the one or more interactive controllers, the one or more process controllers, and/or the one or more wagering sub-controllers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more session sub-controller interfaces communicate outgoing data to an external device or server by encoding the data into a signal and transmitting the signal to the external device or server. The one or more session sub-controller interfaces receive incoming data from an external device or server by receiving a signal transmitted by the external device or server and decoding the signal to obtain the incoming data.

In various embodiments, components of the process controller 104 communicate session data to the session sub-controller. The session data may include, but is not limited to, user data, interactive controller data, pooled bet and side bet data, process controller data and wagering sub-controller data used by the session sub-controller to regulate a dice collection skill competition wagering system session.

In some embodiments, the session sub-controller 154 may also assert control of a dice collection skill competition wagering system session by communicating session control data to components of the process controller 104. Such control may include, but is not limited to, commanding the process controller 104 to end a dice collection skill competition wagering system session, initiating wagering in a dice collection skill competition wagering system session, ending wagering in a dice collection skill competition wagering system session but not ending a user's use of the interactive application portion of the dice collection skill competition wagering system, and changing from real credit wagering in a dice collection skill competition wagering system to virtual credit wagering, or vice versa.

In many embodiments, the session sub-controller 154 manages user profiles for a plurality of users. The session sub-controller 154 stores and manages data about users in order to provide authentication and authorization of users of the dice collection skill competition wagering system 100. In some embodiments, the session sub-controller 154 also manages geolocation information to ensure that the dice collection skill competition wagering system 100 is only used by users in jurisdictions were wagering is approved. In various embodiments, the session sub-controller 154 stores application credits that are associated with the user's use of the interactive application of the dice collection skill competition wagering system 100.

In some embodiments, the session sub-controller 154 communicates user and session management data to the user using a management user interface (not shown) of the interactive controller. The user interacts with the management user interface and the management user interface generates management telemetry data that is communicated to the session sub-controller 154 via interfaces 122 and 124.

In some embodiments, the wagering sub-controller 136 communicates wagering session data to the session sub-controller 154. In various embodiments, the session sub-controller communicates wagering session control data to the wagering sub-controller 136.

In some embodiments, a process controller operates as an interface between an interactive controller and a wagering sub-controller. By virtue of this construction, the wagering sub-controller is isolated from the interactive controller allowing the interactive controller to operate in an unregulated environment while allowing the wagering sub-controller to operate in a regulated environment.

In some embodiments, a single wagering sub-controller may provide services to two or more interactive controllers and/or two or more process controllers, thus allowing a dice collection skill competition wagering system to operate over a large range of scaling.

In various embodiments, multiple types of interactive controllers using different operating systems may be interfaced to a single type of process controller and/or wagering sub-controller without requiring customization of the process controller and/or the wagering sub-controller.

In many embodiments, an interactive controller may be provided as a user device under control of a user while maintaining the wagering sub-controller in an environment under the control of a regulated operator of wagering equipment.

In several embodiments, data communicated between the controllers may be encrypted to increase security of the dice collection skill competition wagering system.

In some embodiments, a process controller isolates chance-based component logic and skill proposition logic as unregulated logic from a regulated wagering sub-controller, thus allowing errors in the skill proposition logic and/or chance-based component logic to be corrected, new skill proposition logic and/or chance-based component logic to be used, or modifications to be made to the skill proposition logic and/or chance-based component logic without a need for regulatory approval.

In various embodiments, an interactive application may require extensive processing resources from an interactive controller leaving few processing resources for the functions performed by a process controller and/or a wagering sub-controller. By virtue of the architecture described herein, processing loads may be distributed across multiple devices such that operations of the interactive controller may be dedicated to the interactive application and the processes of the process controller and/or wagering sub-controller are not burdened by the requirements of the interactive application.

In many embodiments, a dice collection skill competition wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a dice collection skill competition wagering system are distributed in close proximity to each other and communicate using a local area network and/or a communication bus. In several embodiments, an interactive controller and a process controller of a dice collection skill competition wagering system are in a common location and communicate with an external wagering sub-controller. In some embodiments, a process controller and a wagering sub-controller of a dice collection skill competition wagering system are in a common location and communicate with an external interactive controller. In many embodiments, an interactive controller, a process controller, and a wagering sub-controller of a dice collection skill competition wagering system are located in a common location. In some embodiments, a session sub-controller is located in a common location with a process controller and/or a wagering sub-controller.

In various embodiments, these multiple devices can be constructed from or configured using a single device or a plurality of devices such that a dice collection skill competition wagering system is executed as a system in a virtualized space such as, but not limited to, where a wagering sub-controller and a process controller are large scale centralized servers in the cloud operatively connected to widely distributed interactive controllers via a wide area network such as the Internet or a local area network. In such embodiments, the components of a dice collection skill competition wagering system may communicate using a networking protocol or other type of device-to-device communications protocol.

In some embodiments, a dice collection skill competition wagering system is deployed over a local area network or a wide area network in an interactive configuration. An interactive configuration of a dice collection skill competition wagering system includes an interactive controller operatively connected by a network to a process controller and a wagering sub-controller.

In some embodiments, a dice collection skill competition wagering system is deployed over a local area network or a wide area network in a mobile configuration. A mobile configuration of a dice collection skill competition wagering system is useful for deployment over wireless communication network, such as a wireless local area network or a wireless telecommunications network. A mobile configuration of a dice collection skill competition wagering system includes an interactive controller operatively connected by a wireless network to a process controller and a wagering sub-controller.

In several embodiments, a centralized process controller is operatively connected to one or more interactive controllers and one or more wagering sub-controllers using a communication link. The centralized process controller can perform the functionality of a process controller across various dice collection skill competition wagering systems.

In numerous embodiments, an interactive application server provides a host for managing head-to-head play operating over a network of interactive controllers connected to the interactive application server using a communication link. The interactive application server provides an environment where users can compete directly with one another and interact with other users.

In many embodiments, the credit processing controller 105 operatively connects to one or more credit input devices for generating incoming credit data from a credit input. Credit inputs can include, but are not limited to, credit items used to transfer credits. The incoming credit data are communicated by the credit processing controller 105 to the metering sub-controller 140. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing controller 105 includes one or more credit output devices 146 for generating a credit output based on outgoing credit data 192 communicated from the wagering sub-controller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller 105 is operatively connected to, and communicates with, a TITO system or the like to determine incoming credit data representing amounts of credits to be transferred into the dice collection skill competition wagering system and to determine outgoing credit data representing amounts of credits to be transferred out of the dice collection skill competition wagering system. In operation, the credit processing controller 105 communicates with a connected credit input device, such as a bill validator/ticket scanner, used to scan a credit input in the form of a TITO ticket having indicia of credit account data of a credit account of the TITO system. The credit processing controller 105 communicates the credit account data to the TITO system. The TITO system uses the credit account data to determine an amount of credits to transfer to the credit processing controller 105, and thus to the metering sub-controller 140 of the process controller 104. The TITO system communicates the amount of credits to the credit processing controller 105. The credit processing controller 105 communicates the amount of credits as incoming credit data to the metering sub-controller 140 and the metering sub-controller 140 credits one or more credit meters 142 with the amount of credits so that the credits can be used when a user makes wagers using the dice collection skill competition wagering system 100.

In many embodiments, the credit processing controller 105 is operatively connected to a bill validator/ticket scanner as one of the one or more credit input devices 144. The credit processing controller 105 communicates with the bill validator/ticket scanner to scan currency used as a credit input to determine an amount of credits as incoming credit data to transfer credit to one or more credit meters 110 associated with one or more users. The skill metering sub-controller 140 credits the one or more credit meters 110 with the amount of credits so that the credits can be used when a user makes wagers using the dice collection skill competition wagering system 100.

In some embodiments, the credit processing controller 105 can use a TITO system along with a ticket or voucher printer as one of the one or more credit output devices 146 to generate a TITO ticket as a credit output for a user. In operation, the credit processing controller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller 105. The credit processing controller 105 uses the ticket or voucher printer to print indicia of the credit account data onto a TITO ticket or voucher as a credit output.

In various embodiments, a credit processing interface 156 resident in the credit processing controller 105 provides an interface between the credit processing controller 156 and the process controller 104.

In some embodiments, the application control interface 122 implements a credit processing controller to process controller communication protocol employing an interprocess communication protocol so that the interactive controller 104 and the credit processing controller 105 may be implemented on the same device. In operation, the credit processing interface 156 provides application programming interfaces that are used by the credit processing controller 105 to communicate outgoing data and receive incoming data by passing parameter data to another process or application.

In some embodiments, the credit processing interface 156 implements an interactive controller to credit processing controller communication protocol employing an interdevice communication protocol so that the interactive controller and the credit processing controller may be implemented on different devices. The interdevice protocol may utilize a wired communication bus or wireless connection as a physical layer.

In various embodiments, the credit processing interface 156 implements an interactive controller to credit processing controller communication protocol employing a networking protocol so that the interactive controller 104 and the credit processing controller 105 may be implemented on different devices connected by a network. The networking protocol may utilize a wired communication bus or wireless connection as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing controller 105 provides an interface to an electronic payment management system 190 such as an electronic wallet or the like. The electronic payment system provides credit account data that is used for generating incoming credit data as a credit input and outgoing credit data as a credit output.

In some embodiments, the credit processing controller is operatively connected to, and communicates with, a TITO system 188 or the like to determine incoming credit data representing amounts of credits to be transferred into the dice collection skill competition wagering system 100 and to determine outgoing credit data representing amounts of credits to be transferred out of the dice collection skill competition wagering system 100.

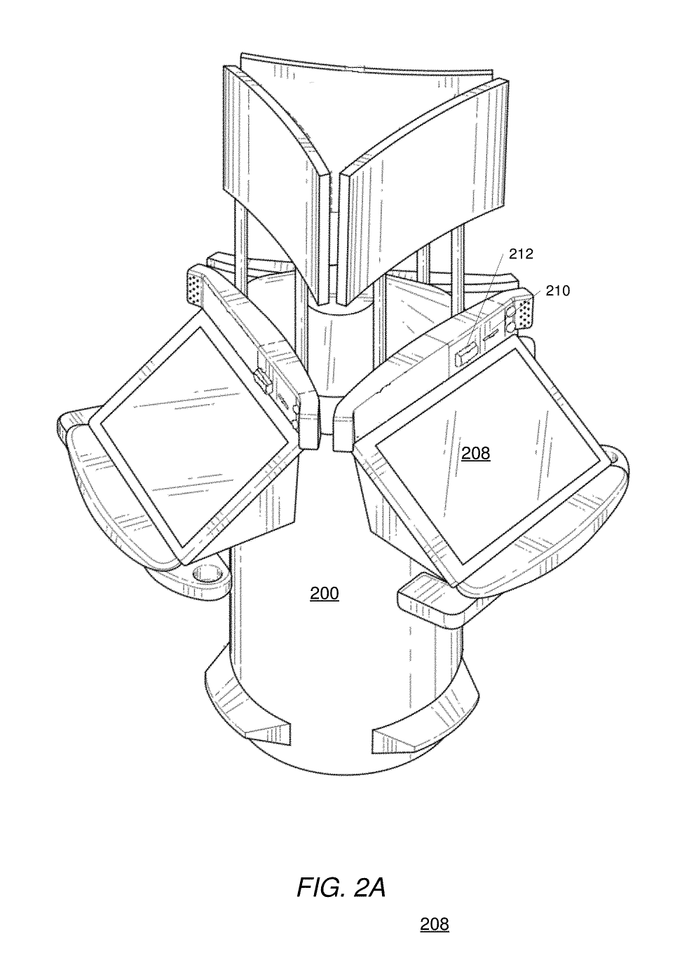

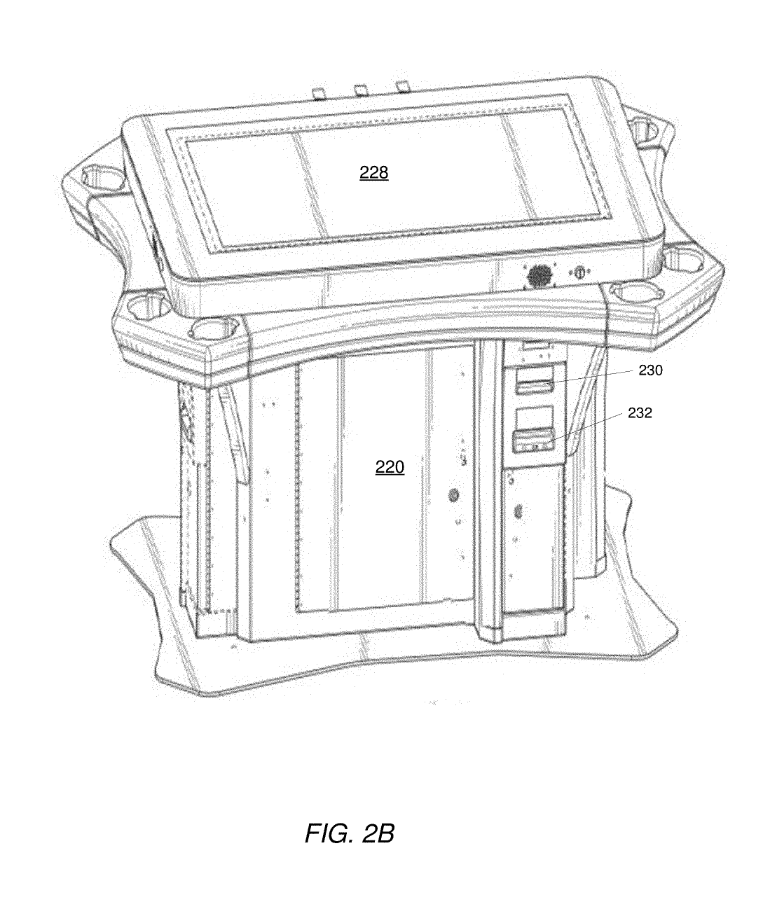

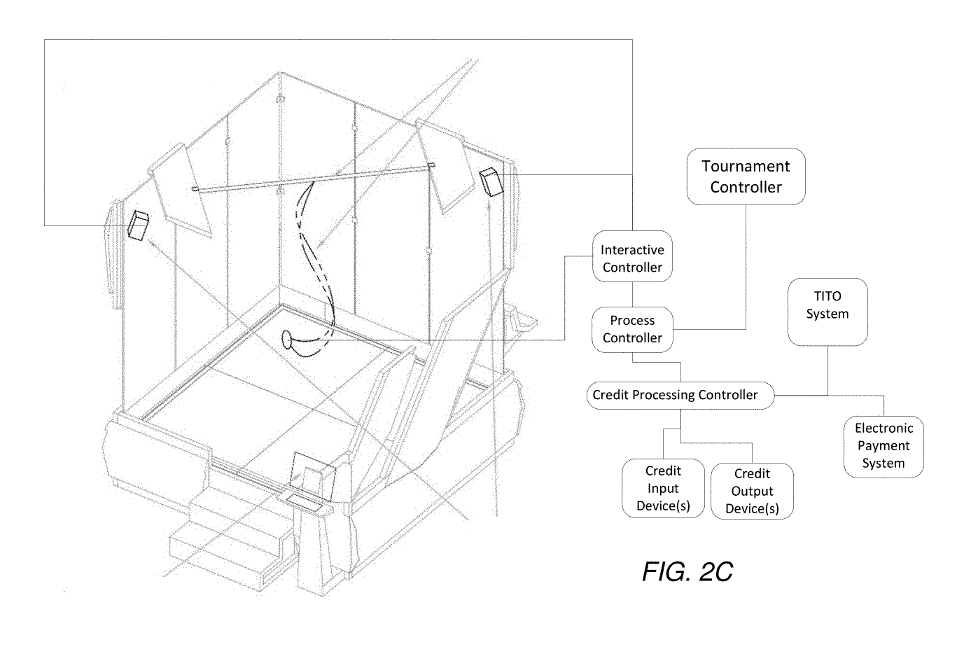

FIG. 2A is a diagram of an electronic gaming machine configuration of a dice collection skill competition wagering system in accordance with various embodiments of the invention. Electronic gaming machine configurations of a dice collection skill competition wagering system include, but are not limited to, electronic gaming machines such as slot machines, table games, video arcade consoles and the like. An electronic gaming machine configuration 200 of a dice collection skill competition wagering system includes an interactive controller, such as interactive controller 102 of FIG. 1, a process controller, such as process controller 104 of FIG. 1, and a credit processing controller, such as credit processing controller 105 of FIG. 1, in an enclosure such as a housing, cabinet, casing or the like. The enclosure may further include one or more user accessible openings or surfaces that may be used to mount one or more user accessible user input devices and user output devices, such as but not limited to touchscreen 208, one or more user accessible credit input devices 210 and one or more credit output devices 212. The interactive controller communicates with the user input devices to detect user interactions with the dice collection skill competition wagering system and commands and controls the user output devices to provide a user interface to one or more users of the dice collection skill competition wagering system as described herein. The process controller communicates with the credit processing controller or user credit processing devices and to transfer credits into and out of the dice collection skill competition wagering system as described herein.

In many embodiments, the process controller is operatively connected to an external session sub-controller (not shown). The session sub-controller may provide session control for a wagering session or may provide services for management of a player account for the storage of player points, application credits and the like.

In various embodiments, the process controller is operatively connected to the credit processing controller. In many embodiments, the credit processing controller is operatively connected to one or more credit input devices 210 for generating incoming credit data from a credit input as described herein. The incoming credit data are communicated to the process controller. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller is operatively connected to the one or more credit output devices 212 for generating a credit output based on outgoing credit data communicated from the process controller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller is operatively connected to, and communicates with, a TITO system (not shown) or the like to determine incoming credit data representing amounts of credits to be transferred into the dice collection skill competition wagering system 200 and to determine outgoing credit data representing amounts of credits to be transferred out of the dice collection skill competition wagering system 200. In operation, the credit processing controller communicates with one of the one or more connected credit input devices 210, such as a bill validator/ticket scanner, used to scan a credit input in the form of a TITO ticket having indicia of credit account data of a credit account of the TITO system. The credit processing controller communicates the credit account data to the TITO system. The TITO system uses the credit account data to determine an amount of credits to transfer to the credit processing controller of the dice collection skill competition wagering system. The TITO system communicates the amount of credits to the credit processing controller. The credit processing controller communicates the amount of credits as incoming credit data to the process controller which credits one or more credit meters with the amount of credits so that the credits can be used when a user makes wagers using the dice collection skill competition wagering system.

In many embodiments, the credit processing controller includes a bill validator/ticket scanner as one of the one or more credit input devices 210. The credit processing controller communicates with the bill validator/ticket scanner to scan currency used as a credit input to determine an amount of credits as incoming credit data to transfer credit to one or more credit meters associated with one or more users. The process controller credits the one or more credit meters with the amount of credits so that the credits can be used when a user makes wagers using the dice collection skill competition wagering system 200.

In some embodiments, the credit processing controller can use the TITO system along with a ticket or voucher printer as one of the one or more credit output devices 212 to generate a TITO ticket as a credit output for a user. In operation, the credit processing controller communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller. The credit processing controller uses the ticket or voucher printer to print indicia of the credit account data onto a TITO ticket as a credit output.

In various embodiments, the credit processing controller provides an interface to an electronic payment system (not shown) such an electronic wallet or the like. The electronic payment system provides credit account data that is used for generating incoming credit data as a credit input and outgoing credit data as a credit output.

In some embodiments, the process controller is operatively connected to a central determination controller (not shown). In operation, when a wagering sub-controller of the process controller needs to determine a random result, the wagering sub-controller communicates a request to the central determination controller for the random result. The central determination controller receives the random result request and generates a random result in response to the random result request. The central determination controller communicates data of the random result to the process controller. The processing controller receives the data of the random result and utilizes the random result as described herein. In some embodiments, the random result is drawn from a pool of pre-determined random results.

In various embodiments, the wagering process controller may be operatively connected to a progressive controller (not shown) along with one or more other process controllers of one or more other dice collection skill competition wagering systems. The progressive controller provides services for the collection and provision of credits used by the process controller to provide random results that have a progressive or pooling component.

FIG. 2B is a diagram of an electronic gaming table configuration of a dice collection skill competition wagering system that may be used as a single user or a multiuser electronic gaming machine in accordance with various embodiments of the invention. Types of a electronic gaming table configuration a dice collection skill competition wagering system include, but are not limited to, electronic gaming machines, slot machines, table gaming devices, video arcade consoles and the like. A multiuser electronic gaming machine configuration of a dice collection skill competition wagering system 220 includes an interactive controller, such as interactive controller 102 of FIG. 1, a process controller, such as process controller 104 of FIG. 1, and a credit processing controller, such as credit processing controller 105 of FIG. 1, enclosed in an enclosure such as a housing, cabinet, casing or the like. The enclosure may further include one or more user accessible openings or surfaces that may be used to mount one or more user accessible user input devices and user output devices, such as touchscreen 228, one or more user accessible credit input devices 230 and one or more user accessible credit output devices 232.

In some embodiments, two or more sets of credit input devices and credit output devices are provided so that each user of the electronic table game configuration of a dice collection skill competition wagering system 220 can have an associated set of credit input devices and credit output devices.

The interactive controller communicates with the user input devices to detect user interactions with the dice collection skill competition wagering system and commands and controls the user output devices to provide a user interface to one or more users of the dice collection skill competition wagering system as described herein. The process controller communicates with the credit processing controller or user credit processing devices 230 and 232 to transfer credits into and out of the dice collection skill competition wagering system as described herein.

In many embodiments, the process controller is operatively connected to an external session sub-controller (not shown). The session sub-controller may provide session control for a wagering session or may provide services for management of a player account for the storage of player points, application credits and the like.

In various embodiments, the process controller is operatively connected to the credit processing controller. In many embodiments, the credit processing controller is operatively connected to one or more credit input devices 230 for generating incoming credit data from a credit input as described herein. The incoming credit data are communicated to the process controller. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller is operatively connected to the one or more credit output devices 232 for generating a credit output based on outgoing credit data communicated from the process controller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller is operatively connected to, and communicates with, a TITO system, such as TITO system 188 of FIG. 1, or the like to determine incoming credit data representing amounts of credits to be transferred into the dice collection skill competition wagering system 220 and to determine outgoing credit data representing amounts of credits to be transferred out of the dice collection skill competition wagering system 220. In operation, the credit processing controller communicates with one of the one or more connected credit input devices 230, such as a bill validator/ticket scanner, used to scan a credit input in the form of a TITO ticket having indicia of credit account data of a credit account of the TITO system. The credit processing controller communicates the credit account data to the TITO system. The TITO system uses the credit account data to determine an amount of credits to transfer to the credit processing controller of the dice collection skill competition wagering system 220. The TITO system communicates the amount of credits to the credit processing controller. The credit processing controller communicates the amount of credits as incoming credit data to the process controller which credits one or more credit meters with the amount of credits so that the credits can be used when a user makes wagers using the dice collection skill competition wagering system.

In many embodiments, the credit processing controller includes a bill validator/ticket scanner as one of the one or more credit input devices 230. The credit processing controller communicates with the bill validator/ticket scanner to scan currency used as a credit input to determine an amount of credits as incoming credit data to transfer credit to one or more credit meters associated with one or more users. The process controller credits the one or more credit meters with the amount of credits so that the credits can be used when a user makes wagers using the dice collection skill competition wagering system 220.

In some embodiments, the credit processing controller can use the TITO system along with a ticket or voucher printer as one of the one or more credit output devices 232 to generate a TITO ticket as a credit output for a user. In operation, the credit processing controller communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller. The credit processing controller uses the ticket or voucher printer to print indicia of the credit account data onto a TITO ticket as a credit output.

In various embodiments, the credit processing controller provides an interface to an electronic payment system, such as electronic payment system 144 of FIG. 1, that implements an electronic wallet or the like. The electronic payment system provides credit account data that is used for generating incoming credit data as a credit input and outgoing credit data as a credit output.

In some embodiments, the process controller is operatively connected to a central determination controller (not shown). In operation, when a wagering sub-controller of the process controller needs to determine a random result, the wagering sub-controller communicates a request to the central determination controller for the random result. The central determination controller receives the random result request and generates a random result in response to the random result request. The central determination controller communicates data of the random result to the process controller. The processing controller receives the data of the random result and utilizes the random result as described herein. In some embodiments, the random result is drawn from a pool of pre-determined random results.

In various embodiments, the wagering process controller may be operatively connected to a progressive controller along (not shown) with one or more other process controllers of one or more other dice collection skill competition wagering systems. The progressive controller provides services for the collection and provision of credits used by the process controller to provide random results that have a progressive or pooling component.

FIG. 2C is a diagram of virtual reality gaming machine configuration of a variable skill objective wagering system in accordance with various embodiments of the invention. Types of a virtual reality gaming machine configuration of a variable skill objective wagering system include, but are not limited to, virtual reality gaming machines, virtual reality slot machines, virtual reality gaming devices, virtual reality arcade consoles and the like. A virtual reality gaming machine configuration of a variable skill objective wagering system includes an interactive controller, a process controller and a credit processing controller contained in an enclosure such as a housing, cabinet, casing or the like. The enclosure may further include one or more player accessible openings or surfaces that may be used to mount one or more player accessible player input devices and player output devices, one or more player accessible credit input devices and one or more player accessible credit output devices.

A virtual reality gaming machine configuration of a variable skill objective wagering system further includes a player area having virtual reality sensors for sensing player interactions and/or player movements within the player area, a player headset having a stereoscopic visual display for presentation of a stereoscopic presentation to a player, headphones for presenting a stereophonic sound presentation to a player, and one or more subwoofers for providing a hepatic or low frequency auditory presentation to the player.

The interactive controller communicates with the player input devices to detect player interactions with the virtual reality variable skill objective wagering system and commands and controls the player output devices to provide a player interface to one or more players or players of the virtual reality variable skill objective wagering system as described herein. The process controller communicates with the credit processing controller or player credit processing devices and to transfer credits into and out of the variable skill objective wagering system as described herein.

In many embodiments, the process controller is further connected to one or more side betting terminals that enable spectators of a player using the virtual reality variable skill objective wagering system to make side bets based on the performance of the player.

In many embodiments, the process controller is operatively connected to an external session sub-controller (not shown). The session sub-controller may provide session control for a wagering session or may provide services for management of a player account for the storage of player points, application credits and the like.

In various embodiments, the process controller is operatively connected to the credit processing controller. In many embodiments, the credit processing controller is operatively connected to one or more credit input devices for generating incoming credit data from a credit input as described herein. The incoming credit data are communicated to the process controller. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller is operatively connected to the one or more credit output devices for generating a credit output based on outgoing credit data communicated from the process controller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller is operatively connected to, and communicates with, a TITO system or the like to determine incoming credit data representing amounts of credits to be transferred into the variable skill objective wagering system and to determine outgoing credit data representing amounts of credits to be transferred out of the variable skill objective wagering system. In operation, the credit processing controller communicates with one of the one or more connected credit input devices, such as a bill validator/ticket scanner, used to scan a credit input in the form of a TITO ticket having indicia of credit account data of a credit account of the TITO system. The credit processing controller communicates the credit account data to the TITO system. The TITO system uses the credit account data to determine an amount of credits to transfer to the credit processing controller of the variable skill objective wagering system. The TITO system communicates the amount of credits to the credit processing controller. The credit processing controller communicates the amount of credits as incoming credit data to the process controller which credits one or more credit meters with the amount of credits so that the credits can be used when a player makes wagers using the variable skill objective wagering system.

In many embodiments, the credit processing controller includes a bill validator/ticket scanner as one of the one or more credit input devices. The credit processing controller communicates with the bill validator/ticket scanner to scan currency used as a credit input to determine an amount of credits as incoming credit data to transfer credit to one or more credit meters associated with one or more players or players. The process controller credits the one or more credit meters with the amount of credits so that the credits can be used when a player makes wagers using the variable skill objective wagering system.

In some embodiments, the credit processing controller can use the TITO system along with a ticket or voucher printer as one of the one or more credit output devices to generate a TITO ticket as a credit output for a player. In operation, the credit processing controller communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller. The credit processing controller uses the ticket or voucher printer to print indicia of the credit account data onto a TITO ticket as a credit output.

In various embodiments, the credit processing controller provides an interface to an electronic payment system such an electronic wallet or the like. The electronic payment system provides credit account data that is used for generating incoming credit data as a credit input and outgoing credit data as a credit output.

In some embodiments, the process controller is operatively connected to a central determination controller (not shown). In operation, when a wagering sub-controller of the process controller needs to determine a random result, the wagering sub-controller communicates a request to the central determination controller for the random result. The central determination controller receives the random result request and generates a random result in response to the random result request. The central determination controller communicates data of the random result to the process controller. The processing controller receives the data of the random result and utilizes the random result as described herein. In some embodiments, the random result is drawn from a pool of pre-determined random results.

In various embodiments, the wagering process controller may be operatively connected to a progressive controller along (not shown) with one or more other process controllers of one or more other variable skill objective wagering systems. The progressive controller provides services for the collection and provision of credits used by the process controller to provide random results that have a progressive or pooling component.

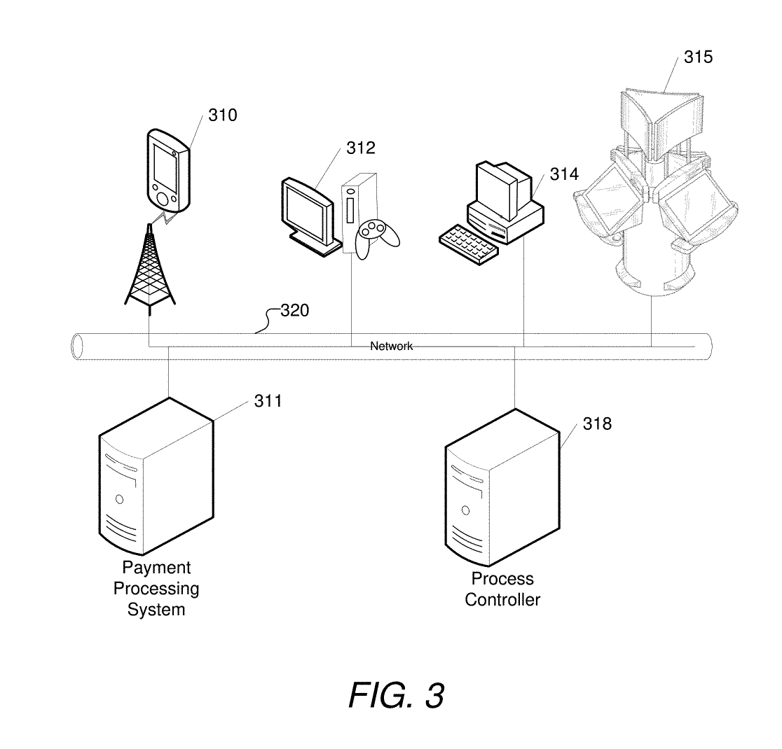

FIG. 3 is a diagram of distributed dice collection skill competition wagering systems in accordance with various embodiments of the invention. An interactive controller, such as interactive controller 102 of FIG. 1, may be constructed from or configured using one or more processing devices that perform the operations of the interactive controller. An interactive controller in a distributed dice collection skill competition wagering system may be constructed from or configured using any processing device having sufficient processing and communication capabilities that may be that perform the processes of an interactive controller in accordance with various embodiments of the invention. In some embodiments, the construction or configuration of the interactive controller may be achieved through the use of an application control interface, such as application control interface 122 of FIG. 1, and/or through the use of an interactive application, such as interactive application 110 of FIG. 1.

In some embodiments, an interactive controller may be constructed from or configured using an electronic gaming machine 315, such as a slot machine or the like. The electronic gaming machine 315 may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a gaming console 312.

In various embodiments, an interactive controller may be constructed from or configured using a personal computer 314.

In some embodiments, one or more processing devices, such as devices 310, 312, 314 and 315, may be used to construct a complete dice collection skill competition wagering system and may be operatively connected using a communication link to a session and/or management controller.

Some dice collection skill competition wagering systems in accordance with many embodiments of the invention can be distributed across a plurality of devices in various configurations. One or more interactive controllers of a distributed dice collection skill competition wagering system, such as but not limited to, a mobile or wireless device 310, a gaming console 312, a personal computer 314, and an electronic gaming machine 315, are operatively connected with a process controller 318 of a distributed dice collection skill competition wagering system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a process controller as described herein are executed on the individual interactive controllers 310, 312, 314 and 315 while one or more processes of a process controller as described herein can be executed by the process controller 318.

In many embodiments, a distributed dice collection skill competition wagering system and may be operatively connected using a communication link to a session controller (not shown), that performs the processes of a session controller as described herein.

In several embodiments, a distributed dice collection skill competition wagering system and may be operatively connected using a communication link to credit processing system 311, that performs the processes of one or more credit processing systems as described herein.

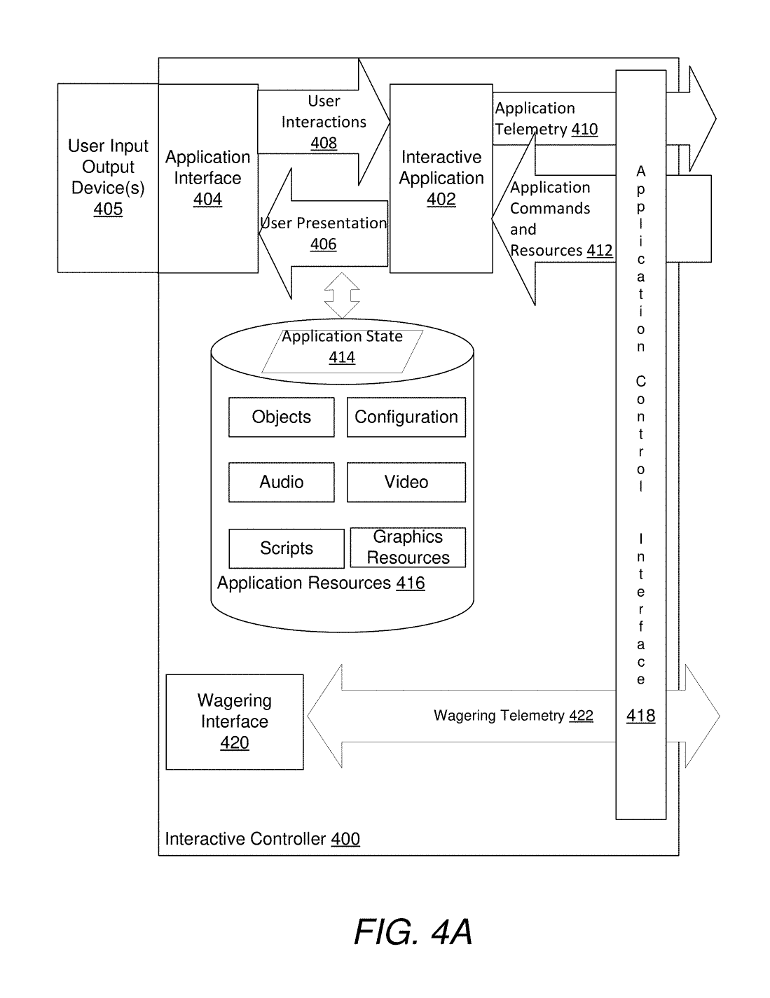

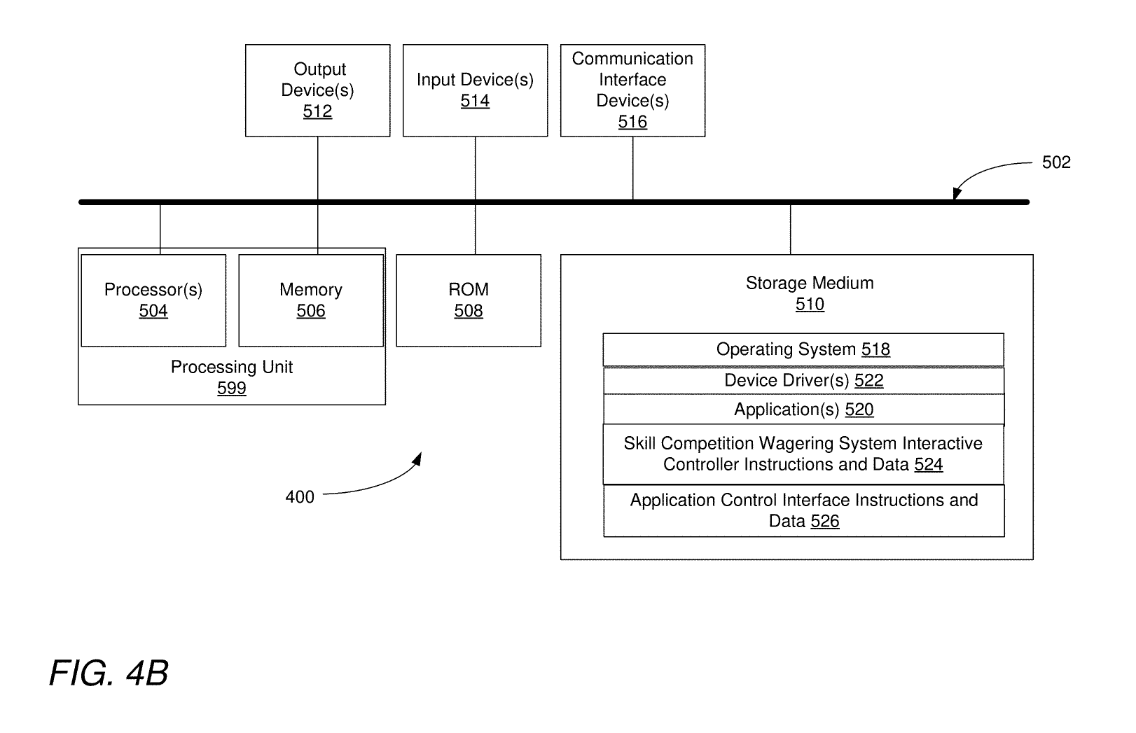

Referring now to FIG. 4A, an interactive controller 400, suitable for use as interactive controller 102 of FIG. 1, provides an execution environment for an interactive application 402 of a dice collection skill competition wagering system. In several embodiments, an interactive controller 400 of a dice collection skill competition wagering system provides an interactive application 402 that generates an application interface 404 for interaction with by a user. The interactive application 402 generates a user presentation 406 that is presented to the user through the application interface 404 using one or more user input and output devices 405. The user presentation 406 may include audio features, visual features or tactile features, or any combination of these features. In various embodiments, the application interface 404 utilizes one or more user interface input and output devices 405 so that a user can interact with the user presentation 406. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The user's interactions 408 are included by the interactive application 402 in application telemetry data 410 that is communicated by interactive controller 400 to various other components of a dice collection skill competition wagering system as described herein. The interactive application 402 receives application commands and resources 412 communicated from various other components of a dice collection skill competition wagering system as described herein. In some embodiments, the application telemetry data 410 may include user interactions with objects of the interactive application and a skill outcome for a skill proposition presented to the user by the interactive application 402.

In some embodiments, various components of the interactive application 402 can read data from an application state 414 in order to provide one or more features of the interactive application. In various embodiments, components of the interactive application 402 can include, but are not limited to: a physics engine; a rules engine; an audio engine; a graphics engine and the like. The physics engine is used to simulate physical interactions between virtual objects in the interactive application 402. The rules engine implements the rules of the interactive application and a random number generator that may be used for influencing or determining certain variables and/or outcomes to provide a randomizing influence on the operations of the interactive application. The graphics engine is used to generate a visual representation of the interactive application state to the user. The audio engine is used to generate an audio representation of the interactive application state to the user.

During operation, the interactive application reads and writes application resources 416 stored on a data store of the interactive controller host. The application resources 416 may include objects having graphics and/or control logic used to provide application environment objects of the interactive application. In various embodiments, the resources may also include, but are not limited to, video files that are used to generate a portion of the user presentation 406; audio files used to generate music, sound effects, etc. within the interactive application; configuration files used to configure the features of the interactive application; scripts or other types of control code used to provide various features of the interactive application; and graphics resources such as textures, objects, etc. that are used by a graphics engine to render objects displayed in an interactive application.

In operation, components of the interactive application 402 read portions of the application state 414 and generate the user presentation 406 for the user that is presented to the user using the user interface 404. The user perceives the user presentation and provides user interactions 408 using the user input devices. The corresponding user interactions are received as user actions or inputs by various components of the interactive application 402. The interactive application 402 translates the user actions into interactions with the virtual objects of the application environment stored in the application state 414. Components of the interactive application use the user interactions with the virtual objects of the interactive application and the interactive application state 414 to update the application state 414 and update the user presentation 406 presented to the user. The process loops continuously while the user interacts with the interactive application of the dice collection skill competition wagering system.

The interactive controller 400 provides one or more interfaces 418 between the interactive controller 400 and other components of a dice collection skill competition wagering system, such as, but not limited to, a process controller. The interactive controller 400 and the other dice collection skill competition wagering system components communicate with each other using the interface. The interface may be used to pass various types of data, and to communicate and receive messages, status data, commands and the like. In certain embodiments, the interactive controller 400 and a process controller communicate application commands and resources 412 and application telemetry data 410. In some embodiments, the communications include requests by the process controller that the interactive controller 400 update the application state 414 using data provided by the process controller.

In many embodiments, communications between a process controller and the interactive controller 400 includes a request that the interactive controller 400 update one or more resources 416 using data provided by the process controller. In a number of embodiments, the interactive controller 400 provides all or a portion of the application state to the process controller. In some embodiments, the interactive controller 400 may also provide data about one or more of the application resources 416 to the process controller. In some embodiments, the communication includes user interactions that the interactive controller 400 communicates to the process controller. The user interactions may be low level user interactions with the user interface 404, such as manipulation of an input device, or may be high level interactions with game objects as determined by the interactive application. The user interactions may also include resultant actions such as modifications to the application state 414 or game resources 416 resulting from the user's interactions taken in the dice collection skill competition wagering system interactive application. In some embodiments, user interactions include, but are not limited to, actions taken by entities such as non-user characters (NPC) of the interactive application that act on behalf of or under the control of the user.

In various embodiments, the application commands and resources 412 include skill proposition application commands and/or resources used by the interactive application to generate a presentation of a skill proposition presented to a user and to determine a skill outcome based on the user's skillful interaction with the presentation of the skill proposition.

In some embodiments, the interactive controller 400 includes a wagering user interface 420 used to provide dice collection skill competition wagering system telemetry data 422 to and from the user. The dice collection skill competition wagering system telemetry data 422 from the dice collection skill competition wagering system includes, but is not limited to, data used by the user to configure credit, application credit and interactive element wagers, and data about the chance-based proposition credits, application credits and interactive element wagers such as, but not limited to, credit, application credit and interactive element balances and credit, application credit and interactive element amounts wagered.

In some embodiments, the interactive controller includes one or more sensors (not shown). Such sensors may include, but are not limited to, physiological sensors that monitor the physiology of the user, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data to one or more components of the dice collection skill competition wagering system.

Referring now to FIG. 4B, interactive controller 400 includes a bus 502 that provides an interface for one or more processors 504, random access memory (RAM) 506, read only memory (ROM) 508, machine-readable storage medium 510, one or more user output devices 512, one or more user input devices 514, and one or more communication interface devices 516.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

Examples of output devices 512 include, but are not limited to, display screens; light panels; and/or lighted displays. In accordance with particular embodiments, the one or more processors 504 are operatively connected to audio output devices such as, but not limited to: speakers; and/or sound amplifiers. In accordance with many of these embodiments, the one or more processors 504 are operatively connected to tactile output devices like vibrators, and/or manipulators.

Examples of user input devices 514 include, but are not limited to: tactile devices including but not limited to, keyboards, keypads, foot pads, touch screens, and/or trackballs; non-contact devices such as audio input devices; motion sensors and motion capture devices that the interactive controller can use to receive inputs from a user when the user interacts with the interactive controller; physiological sensors that monitor the physiology of the user; environmental sensors that monitor the physical environment of the interactive controller; accelerometers that monitor changes in motion of the interactive controller; and location sensors that monitor the location of the interactive controller such as global positioning sensors.

The one or more communication interface devices 516 provide one or more wired or wireless interfaces for communicating data and commands between the interactive controller 400 and other devices that may be included in a dice collection skill competition wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and dice collection skill competition wagering system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of a dice collection skill competition wagering system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many such embodiments, an interactive controller of a dice collection skill competition wagering system includes an interactive application server operatively connected to an interactive client using a communication link. The interactive application server and interactive application client cooperate to provide the features of an interactive controller as described herein.

In various embodiments, the interactive controller 400 may be used to construct other components of a dice collection skill competition wagering system as described herein.

In some embodiments, components of an interactive controller and a process controller of a dice collection skill competition wagering system may be constructed from or configured using a single device using processes that communicate using an interprocess communication protocol. In other such embodiments, the components of an interactive controller and a process controller of a dice collection skill competition wagering system may communicate by passing messages, parameters or the like.

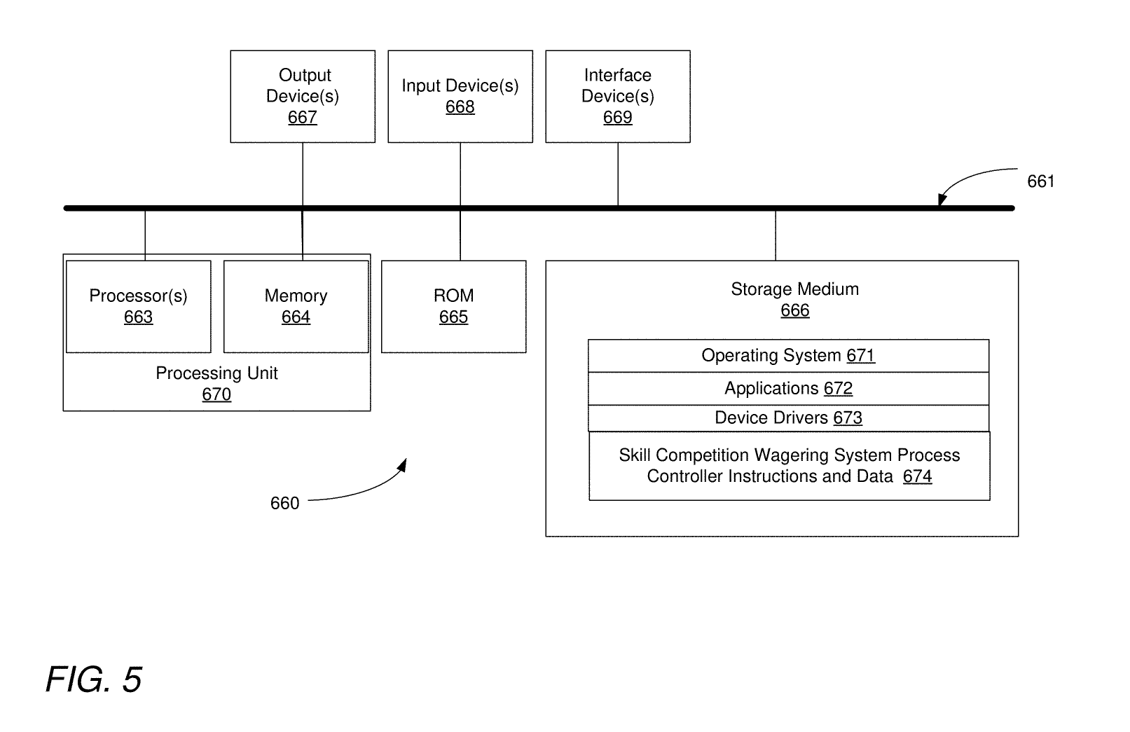

FIG. 5 is a diagram of a structure of a process controller, suitable for use as process controller 104 of FIG. 1, of a dice collection skill competition wagering system in accordance with various embodiments of the invention. A process controller may be constructed from or configured using one or more processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 660 includes a bus 661 providing an interface for one or more processors 663, random access memory (RAM) 664, read only memory (ROM) 665, machine-readable storage medium 666, one or more user output devices 667, one or more user input devices 668, and one or more communication interface and/or network interface devices 669.

The one or more processors 663 may take many forms, such as, but not limited to: a central processing unit (CPU); a multi-processor unit (MPU); an ARM processor; a programmable logic device; or the like.

Examples of output devices 667 include, include, but are not limited to: display screens; light panels; and/or lighted displays. In accordance with particular embodiments, the one or more processors 663 are operatively connected to audio output devices such as, but not limited to: speakers; and/or sound amplifiers. In accordance with many of these embodiments, the one or more processors 663 are operatively connected to tactile output devices like vibrators, and/or manipulators.

In the example embodiment, the one or more processors 663 and the random access memory (RAM) 664 form a process controller processing unit 670. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

Examples of user input devices 668 include, but are not limited to: tactile devices including but not limited to, keyboards, keypads, foot pads, touch screens, and/or trackballs; non-contact devices such as audio input devices; motion sensors and motion capture devices that the process controller can use to receive inputs from a user when the user interacts with the process controller 660.

The one or more communication interface and/or network interface devices 669 provide one or more wired or wireless interfaces for exchanging data and commands between the process controller 660 and other devices that may be included in a dice collection skill competition wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 666 stores machine-executable instructions for various components of the process controller 660 such as, but not limited to: an operating system 671; one or more applications 672; one or more device drivers 673; and dice collection skill competition wagering system process controller instructions and data 674 for use by the one or more processors 663 to provide the features of a process controller as described herein.

In various embodiments, the machine-readable storage medium 670 is one of a (or a combination of two or more of) a hard drive, a flash drive, a DVD, a CD, a flash storage, a solid state drive, a ROM, an EIEPROM, and the like.

In operation, the machine-executable instructions are loaded into memory 664 from the machine-readable storage medium 666, the ROM 665 or any other storage location. The respective machine-executable instructions are accessed by the one or more processors 663 via the bus 661, and then executed by the one or more processors 663. Data used by the one or more processors 663 are also stored in memory 664, and the one or more processors 663 access such data during execution of the machine-executable instructions. Execution of the machine-executable instructions causes the one or more processors 663 to control the process controller 660 to provide the features of a dice collection skill competition wagering system process controller as described herein.

Although the process controller 660 is described herein as being constructed from or configured using one or more processors and instructions stored and executed by hardware components, the process controller can be composed of only hardware components in accordance with other embodiments. In addition, although the storage medium 666 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 666 may be accessed by processor 663 through one of the interfaces or using a communication link. Furthermore, any of the user input devices or user output devices may be operatively connected to the one or more processors 663 via one of the interfaces or using a communication link.

In various embodiments, the process controller 660 may be used to construct other components of a dice collection skill competition wagering system as described herein.

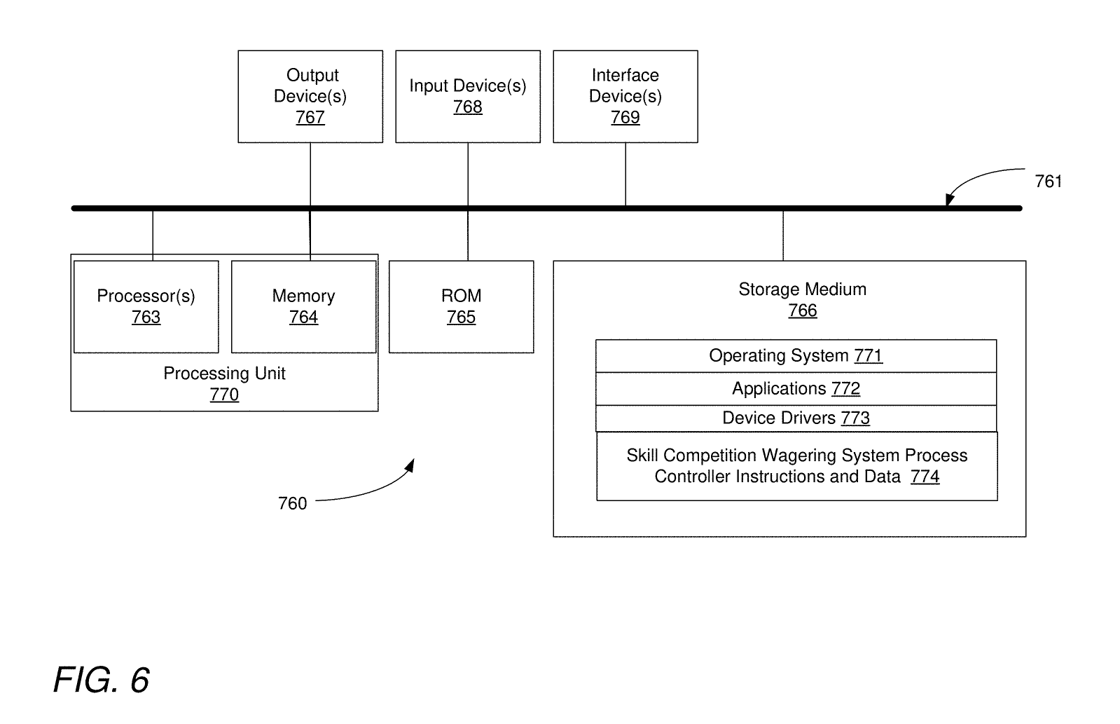

FIG. 6 is a diagram of a structure of a credit processing controller, suitable for use as credit processing controller 105 of FIG. 1, of a dice collection skill competition wagering system in accordance with various embodiments of the invention. A credit processing controller may be constructed from or configured using one or more processing devices that perform the operations of the credit processing controller. In many embodiments, a credit processing controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Credit processing controller 760 includes a bus 761 providing an interface for one or more processors 763, random access memory (RAM) 764, read only memory (ROM) 765, machine-readable storage medium 766, one or more user output devices 767, one or more user input devices 768, and one or more communication interface and/or network interface devices 769.

The one or more processors 763 may take many forms, such as, but not limited to: a central processing unit (CPU); a multi-processor unit (MPU); an ARM processor; a programmable logic device; or the like.

Examples of output devices 767 include, include, but are not limited to: display screens; light panels; and/or lighted displays. In accordance with particular embodiments, the one or more processors 763 are operatively connected to audio output devices such as, but not limited to: speakers; and/or sound amplifiers. In accordance with many of these embodiments, the one or more processors 763 are operatively connected to tactile output devices like vibrators, and/or manipulators.

In the example embodiment, the one or more processors 763 and the random access memory (RAM) 764 form a credit processing controller processing unit 770. In some embodiments, the credit processing controller processing unit includes one or more processors operatively connected to one or more of a RAM, ROM, and machine-readable storage medium; the one or more processors of the credit processing controller processing unit receive instructions stored by the one or more of a RAM, ROM, and machine-readable storage medium via a bus; and the one or more processors execute the received instructions. In some embodiments, the credit processing controller processing unit is an ASIC (Application-Specific Integrated Circuit). In some embodiments, the credit processing controller processing unit is a SoC (System-on-Chip).

Examples of user input devices 768 include, but are not limited to: tactile devices including but not limited to, keyboards, keypads, foot pads, touch screens, and/or trackballs; non-contact devices such as audio input devices; motion sensors and motion capture devices that the credit processing controller can use to receive inputs from a user when the user interacts with the credit processing controller 760.

The one or more communication interface and/or network interface devices 769 provide one or more wired or wireless interfaces for exchanging data and commands between the credit processing controller 760 and other devices that may be included in a dice collection skill competition wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 766 stores machine-executable instructions for various components of the credit processing controller 760 such as, but not limited to: an operating system 771; one or more applications 772; one or more device drivers 773; and dice collection credit processing controller instructions and data 774 for use by the one or more processors 763 to provide the features of a credit processing controller as described herein.

In various embodiments, the machine-readable storage medium 770 is one of a (or a combination of two or more of) a hard drive, a flash drive, a DVD, a CD, a flash storage, a solid state drive, a ROM, an EIEPROM, and the like.

In operation, the machine-executable instructions are loaded into memory 764 from the machine-readable storage medium 766, the ROM 765 or any other storage location. The respective machine-executable instructions are accessed by the one or more processors 763 via the bus 761, and then executed by the one or more processors 763. Data used by the one or more processors 763 are also stored in memory 764, and the one or more processors 763 access such data during execution of the machine-executable instructions. Execution of the machine-executable instructions causes the one or more processors 763 to control the credit processing controller 760 to provide the features of a dice collection skill competition wagering system credit processing controller as described herein.

Although the credit processing controller 760 is described herein as being constructed from or configured using one or more processors and instructions stored and executed by hardware components, the credit processing controller can be composed of only hardware components in accordance with other embodiments. In addition, although the storage medium 766 is described as being operatively connected to the one or more processors through a bus, those skilled in the art of credit processing controllers will understand that the storage medium can include removable media such as, but not limited to, a USB memory device, an optical CD ROM, magnetic media such as tape and disks. Also, in some embodiments, the storage medium 766 may be accessed by processor 763 through one of the interfaces or using a communication link. Furthermore, any of the user input devices or user output devices may be operatively connected to the one or more processors 763 via one of the interfaces or using a communication link.

In various embodiments, the credit processing controller 760 may be used to construct other components of a dice collection skill competition wagering system as described herein.

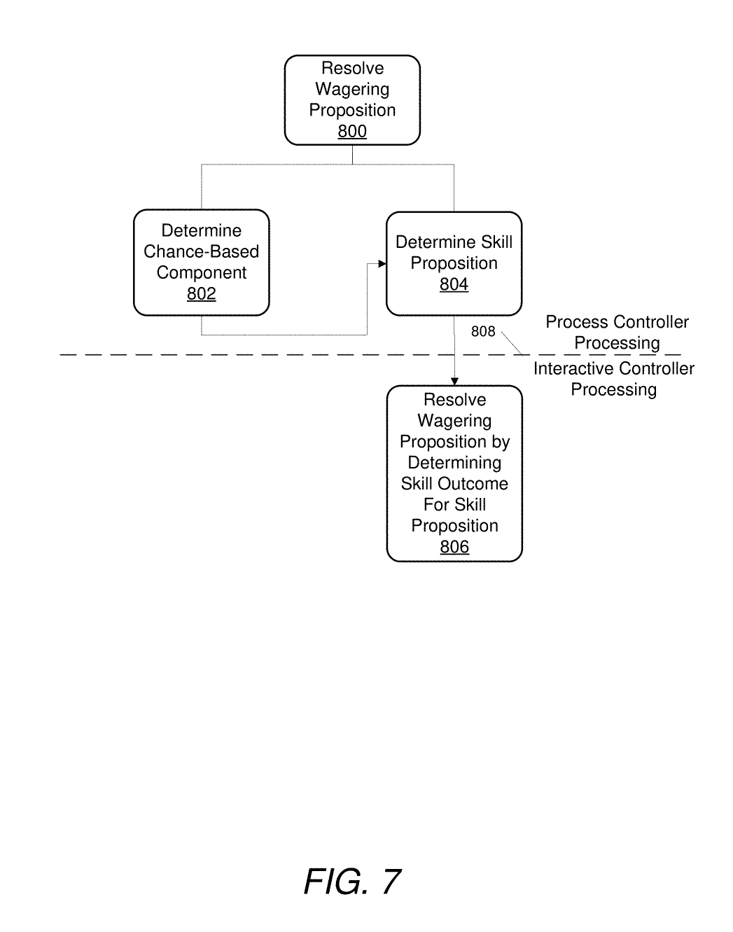

FIG. 7 is a block diagram of a process of a dice collection skill competition wagering system during a wagering session in accordance with various embodiments of the invention. A dice collection skill competition wagering system resolves 800 a wager proposition by determining 802 a chance-based component using one or more random outcomes. The random component is then used to determine 804 a skill proposition that will be presented to one or more users. The wager is resolved 806 by determining a skill outcome for the skill proposition.

In some embodiments, as indicated by dashed line 808, a process controller of the dice collection skill competition wagering system performs processing for determining 802 the chance-based component and determining 804 the skill proposition while an interactive controller performs processing for determining 806 the skill outcome.

In an example embodiment, a wagering proposition of a skill competition wagering system is a head-to-head electronic card game played competitively by two players using a set of electronic cards. Each player wagers an amount of credits and the winning player receives all of the wagered credits minus an amount of credits for a hold of an operator of the skill competition wagering system. A process controller of the skill competition wagering system determines a random order of the electronic cards in the set of electronic cards as a chance-based component of the wagering proposition. The resultant randomized set of electronic cards are included in a skill proposition of the wagering proposition. The skill proposition may optionally includes instructions in accordance with the electronic card game. Data of the skill proposition is communicated to an interactive controller of the skill competition wagering system. The interactive controller receives the data of the skill proposition. The interactive controller resolves the wagering proposition by determining a skill outcome by executing the electronic card game using skill outcome logic specific to the electronic card game, the randomized set of electronic cards, and optionally any instructions in accordance with the electronic card game received from the process controller. The skill outcome includes information about which player has won the electronic card game.

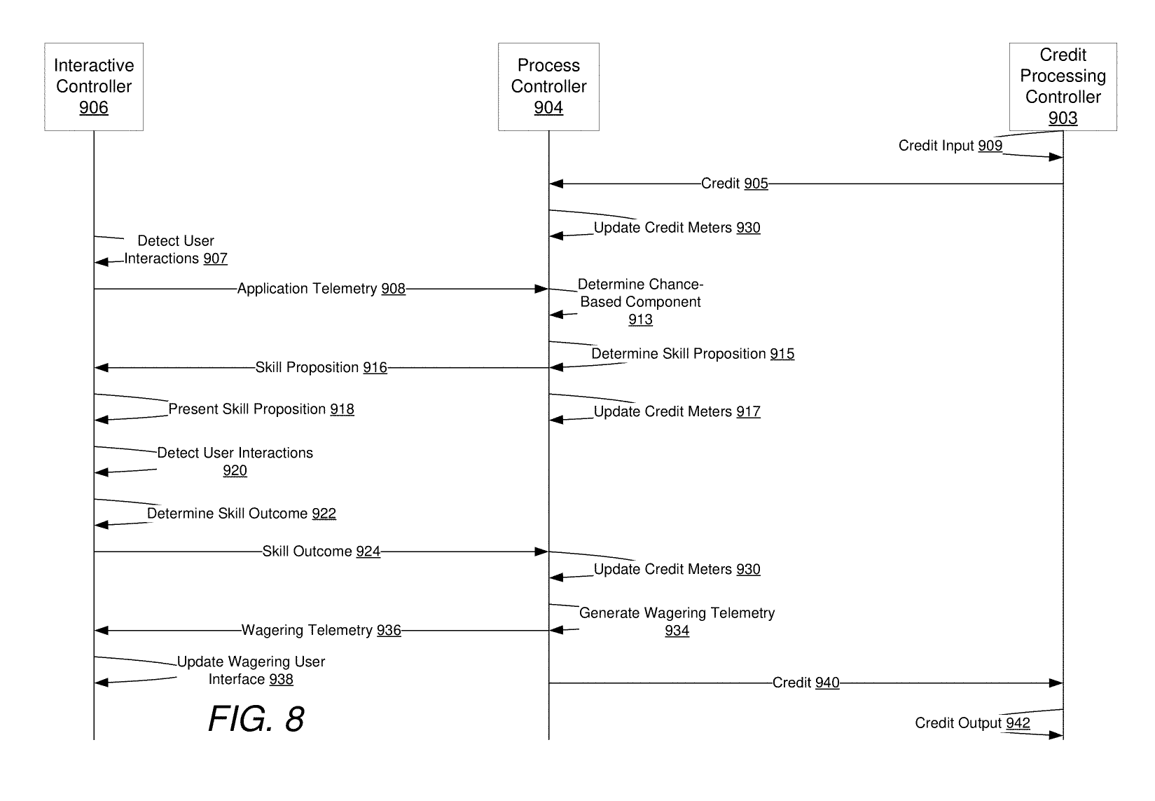

FIG. 8 is a sequence diagram of interactions between components of a dice collection skill competition wagering system during a wagering session in accordance with various embodiments of the invention. The components of the dice collection skill competition wagering system include a process controller 904, such as process controller 104 of FIG. 1, an interactive controller 906, such as interactive controller 102 of FIG. 1, and a credit processing controller 903, such as credit processing controller 105 of FIG. 1.

In some embodiments, at a beginning of the wagering session, the process includes a credit input 909 to the dice collection skill competition wagering system with process controller 904 communicating with the credit processing controller 903 to receive incoming credit data 905. The process controller 904 uses the incoming credit data to transfer credits onto one or more credit meters associated with one or more users of the dice collection skill competition wagering system, thus transferring credits into the dice collection skill competition wagering system and on to the one or more credit meters.

In many embodiments, the interactive controller 906 detects 907 one or more users performing a user interaction in an application interface of an interactive application provided by the interactive controller 906. The interactive controller 906 communicates application telemetry data 908 to the process controller 904. The application telemetry data 908 includes, but is not limited to, the user interaction detected by the interactive controller 906.

The process controller 904 receives the application telemetry data 908. Upon determination by the process controller 904 that the user interaction indicates a wagering event in accordance with a wagering proposition, the process controller 904 determines 913 a chance-based component of the wagering proposition and uses the chance-based component to determine 915 a skill proposition of the wagering proposition. The process controller 904 communicates data of the skill proposition 916 to the interactive controller 906. The process controller 904 updates 917 one or more credit meters associated with the one or more users based on amounts of credits wagered in the wagering event.

The interactive controller 906 receives the skill proposition data 916 from the process controller 904 and uses the skill proposition data 916 to generate and present 918 to the one or more users a skill proposition. The presentation of the skill proposition is presented to the one or more users in the user interface of the interactive application of the interactive controller 906. The interactive controller 906 detects 920 user interactions of the one or more users with the presentation of the skill proposition and determines 922 a skill outcome based on the detected user interactions and the skill proposition data 916. The interactive controller 906 communicates data of the skill outcome 924 to the process controller 904.

The process controller 904 receives the skill outcome data 924 and updates the one or more credit meters associated with the one or more users using the skill outcome data 924 and an amount of credits used for the wager and stores amounts of credits awarded from the executed wager in one or more intermediate data stores. The wagering sub-controller 902 communicates data of the chance outcome 914 of the executed wager to the process controller 904.

The process controller 904 receives the chance outcome data 914 and determines 915 a skill proposition based in part on the chance outcome data 914. The skill proposition includes interactive application command and resource data that the process controller 904 uses to command the interactive controller 906 to present a skill proposition to a user. The process controller 904 communicates data of the skill proposition 916 to the interactive controller 906.

The interactive controller 906 receives the skill proposition data 916. The interactive application executing on the interactive controller 906 uses the skill proposition data to generate and present 918 a skill proposition to the user. The interactive controller 906 detects 920 skillful user interactions with the skill proposition presentation of the interactive application and determines 922 a skill outcome based on the user's skillful interactions. The interactive controller 906 communicates data of the skill outcome 924 to the process controller 904.

The process controller 904 receives the skill outcome data 924 and updates 930 the one or more credit meters associated with the one or more users based on the skill outcome data 924 and the amount of credits wagered. The process controller 904 generates 934 wagering telemetry data 936 using the combined outcome data 928 and data of the updated one or more credit meters. The process controller 904 communicates the wagering telemetry data 936 to the interactive controller 906.

The interactive controller 906 receives the wagering telemetry data 936. The interactive controller 906 updates 936 a wagering user interface on a partial basis of the wagering telemetry data 936.

In many embodiments, upon determining that the wagering session is completed, such as by receiving a cashout communication from one or more users of the dice collection skill competition wagering system, the process controller 904 transfers credits off of the one or more credit meters, generates outgoing credit data 940 on the basis of the credits transferred off of the one or more credit meters, and communicates the outgoing credit data 940 to the credit processing controller 903. The credit processing controller receives the outgoing credit data 940 and generates 942 a credit output as described herein, thus transferring credits off of the one or more credit meters and out of the dice collection skill competition wagering system.

In some embodiments, at a beginning of the wagering session, the process includes an application credit input to the dice collection skill competition wagering system with the process controller 904 communicating with the credit processing controller 903 to receive incoming application credit data. The process controller 902 uses the incoming application credit data to transfer application credits onto one or more application credit meters associated with one or more users of the dice collection skill competition wagering system, thus transferring application credits into the dice collection skill competition wagering system and on to the one or more application credit meters. The process controller 904 uses the skill outcome data 924 to determine an amount of application credit to award to a user based on the user's skillful interactions with an interactive application executed by the interactive controller 905. Upon determining that the wagering session is completed, such as by receiving a cashout communication from one or more users of the dice collection skill competition wagering system, the process controller 904 transfers application credits off of the one or more application credit meters, generates outgoing application credit data on the basis of the application credits transferred off of the one or more application credit meters, and communicates the outgoing application credit data to the credit processing controller 903. The credit processing controller receives the outgoing application credit data and generates an application credit output as described herein, thus transferring application credits off of the one or more application credit meters and out of the dice collection skill competition wagering system.

During the course of an interactive application session, multiple users may compete in a time-sensitive skill competition. The determination of which user acted first can be determinative when awarding points, interactive application pieces, or wins.

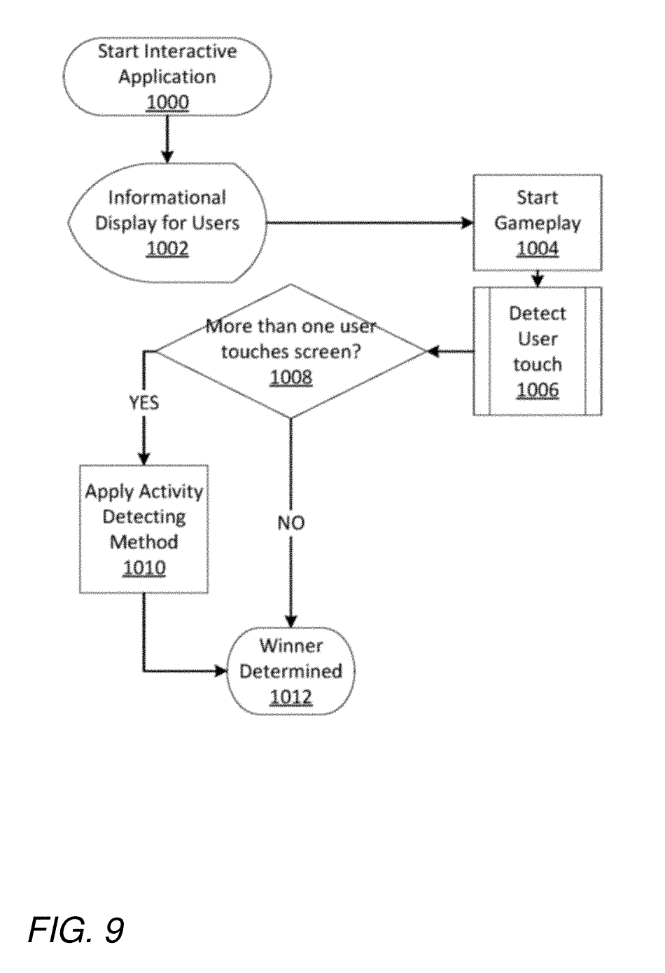

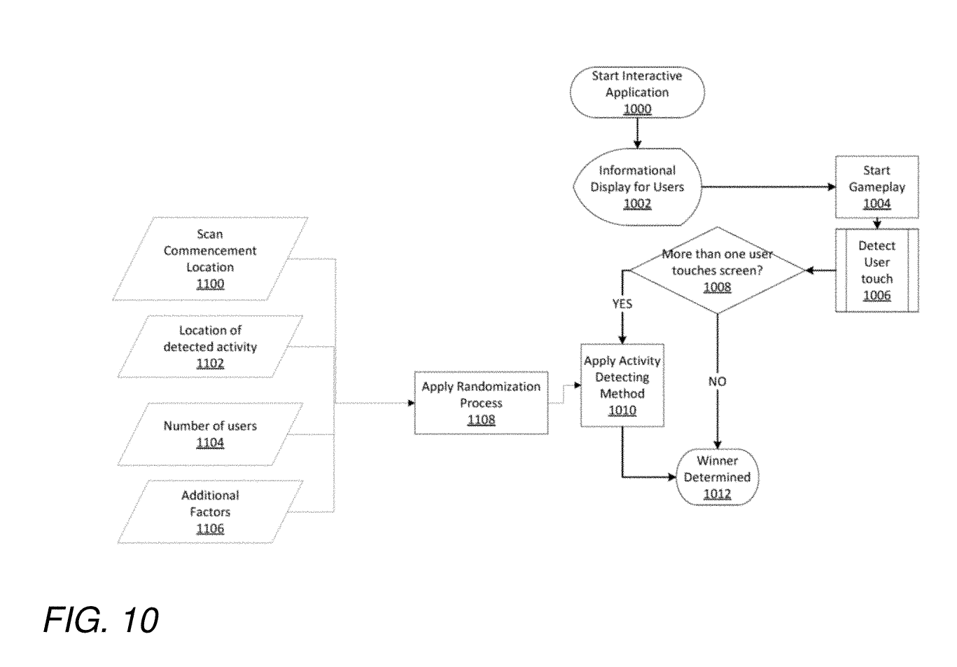

Referring to FIGS. 9 and 10, various embodiments of a dice collection skill competition wagering system include a touchscreen used during the course of a competitive interactive application. Since touches may be nearly simultaneous and beyond the ability of human perception to differentiate, a process is used to determine a first touch. Moreover, since touchscreens may normally scan from one direction, different positions around the screen may provide an advantage to individuals that must be mitigated to promote fair play.

In the process, an interactive application providing a competitive skill proposition in the form of a skill game of a dice collection skill competition wagering system is started 1000. An informational user interface is displayed 1002 to two or more users and the two or more users start 1004 gameplay of the skill game provided by the interactive application. The skill game includes a competitive skill component wherein two or more users compete to touch the touchscreen first in response to certain stimuli. When the dice collection skill competition wagering system detects that a user is touching the touchscreen 1006, the dice-based baccarat skill competition wagering system determines 1008 if two or more users are touching the touchscreen. If only one user is touching the touchscreen, then that user is determined 1012 to be a winner, or the first user to touch the touchscreen. If two or more users are determined to be touching the touchscreen, the dice collection skill competition wagering system applies 1010 an activity detecting method to determine which of the two or more players have touched the touchscreen first in order to determine which of the two or more users is to be determined 1012 the winner.

The determination of which person touched the screen first can be determined in a variety of ways. As seen in FIG. 10, in one embodiment, the system treats the touchscreen as a random number generator (RNG) event such that no player could routinely obtain an advantage, and that the determination of the best position on the table for any given play of the interactive application is impossible. The process includes a randomization process 1108 applied to a scanning process of a touchscreen where multiple players compete or play, the randomization including factors such as whether the matrix scan commences 1100 from one end of the touchscreen or the other (e.g. row 0 or row 999), or one column or the other (e.g. column 0 or column 499), or commences at a location within the matrix (e.g. 200,187 or 55,820, etc.), a location of the touches on the touchscreen 1102, the number of users 1104, and additional factors 1106.

In an alternate embodiment, the system synchronizes the trigger of the randomization process to the commencement of an interactive application, either just prior, simultaneously with the start, during the play or after the completion of the interactive application.

In some embodiments, the interactive application design may take advantage of the inherent randomness of touch scanning. Given a ˜5 ms scan rate for the entire screen, and the realities that if the interactive application involves acuity and dexterity, or at least a dexterity interactive application which requires recognition skills for audio, visual or both, and that such reaction time is likely no better than 150 ms or more, there is an over sampling rate of near 30 time more than necessary. If the scanning runs continually after boot, and its reset somewhere unpredictably in the boot process, it's impossible for any individual to know walking up to the table where the scan actually is at the commencement of a interactive application, and even if they did, the human body couldn't react fast enough to take advantage of it.

However, if the scans are always predictable in the order, there may be a touch soft button position which is disadvantaged on the table, depending on the interactive application design. So the interactive application determines the liquid crystal display matrix scan data and locate trigger points and buttons in such a manner as to balance out the advantage of one position over another. For instance, not putting a button for one position right at the start of the scan row/column, but rather some distance down the scan path, and in turn, pulling the trailing button(s) off of the end of the scan path providing some additional “lead gutter¹” for the first button position.

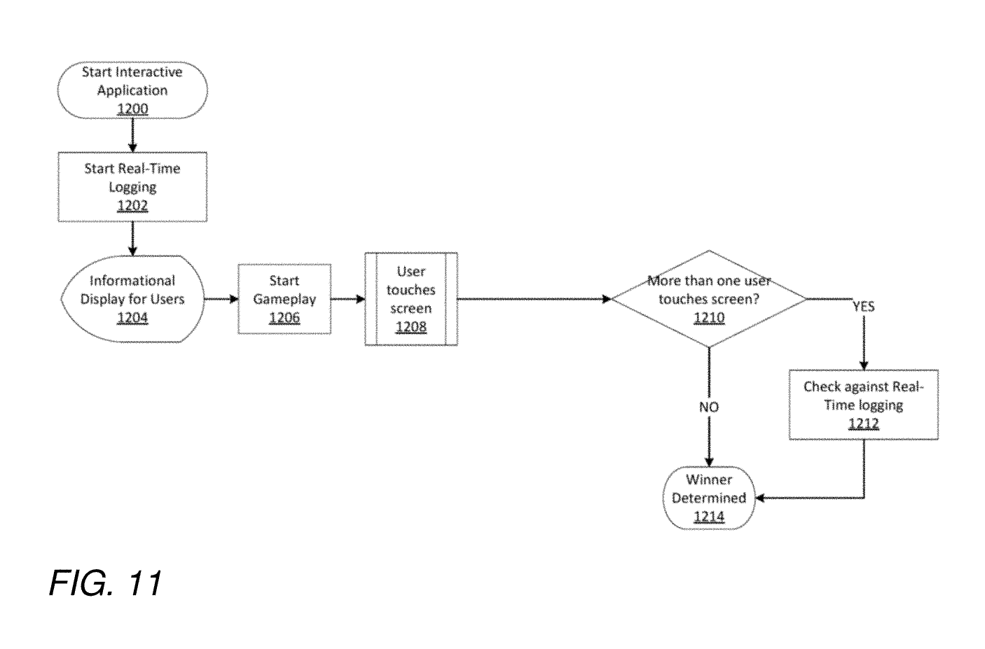

FIG. 11 is a process flow diagram of interactions between components of a dice collection skill competition wagering system in accordance with various embodiments of the invention. In the process, an interactive application providing a competitive skill proposition in the form of a skill game of a dice collection skill competition wagering system is started 1200. An informational user interface is displayed 1202 to two or more users and the two or more users start 1204 gameplay of the skill game provided by the interactive application. The skill game includes a competitive skill component wherein the users compete to touch the touchscreen first in response to certain stimuli. When the dice collection skill competition wagering system detects that a user is touching the touchscreen 1206, the dice-based baccarat skill competition wagering system determines 1208 if two or more users are touching the touchscreen. If only one user is touching the touchscreen, then that user is determined 1214 to be a winner, or the first user to touch the touchscreen. If two or more users are determined to be touching the touchscreen, the dice collection skill competition wagering system applies 1210 a real time logging method to determine which of the two or more players have touched the touchscreen first in order to determine which of the two or more users is to be determined 1214 the winner.

The real time logging method includes using a scan controller or its driver or interface paired to a real time clock to the event of the completed screen touch, or the moment a first signal event is detected which is ultimately determined to be a legal touch, such that information is available to the operating system of the interactive controller executing the interactive application, and used in the determination of a winning touch.

In an alternate embodiment, the real-time log is made available to one or more of the players and/or an authorized attendant. This log file is stored on the interactive application and may be shared with a server or monitoring station.

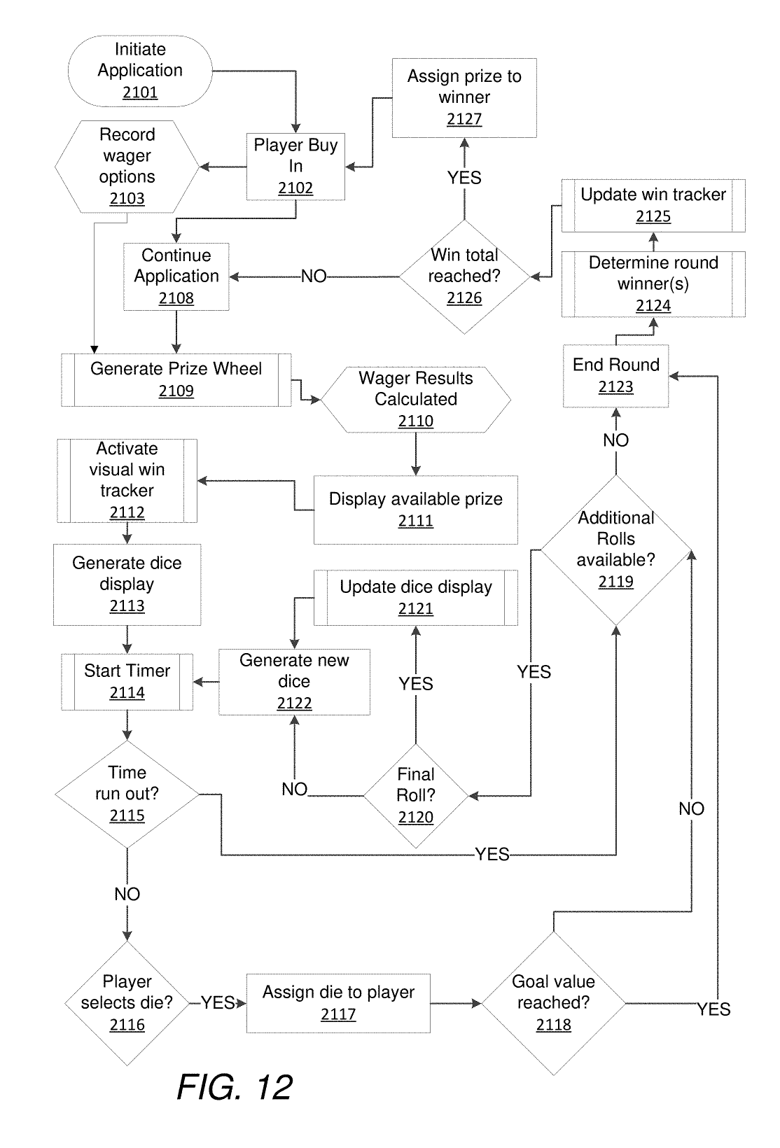

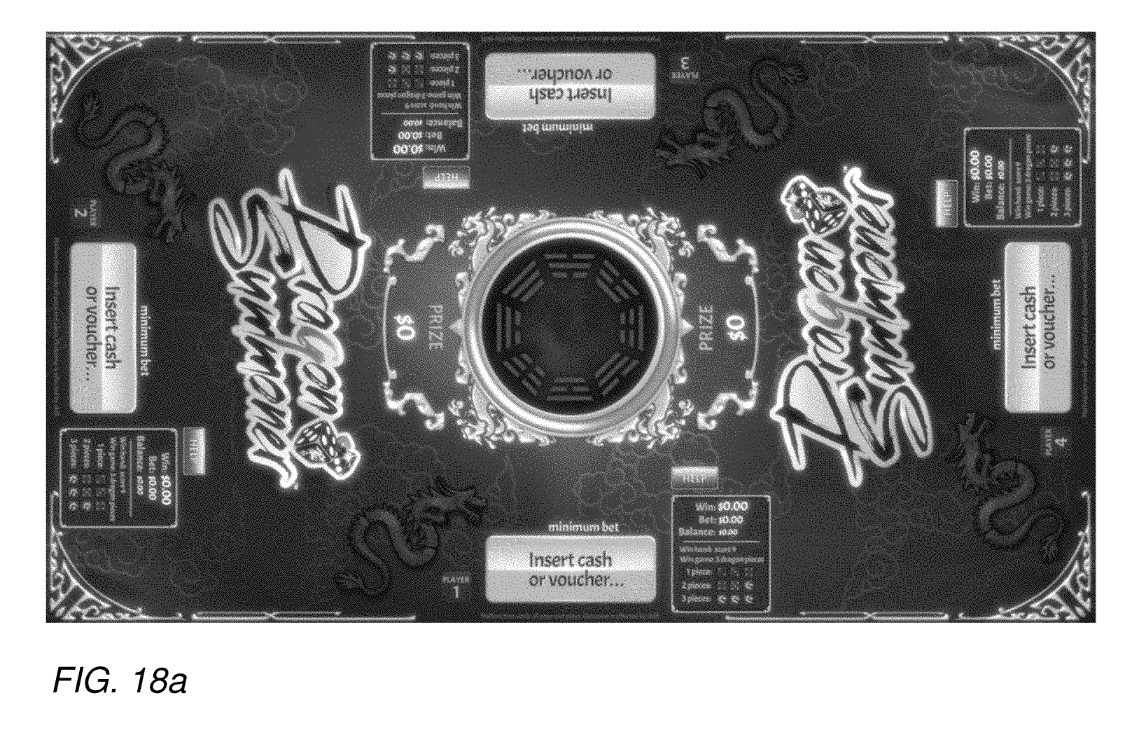

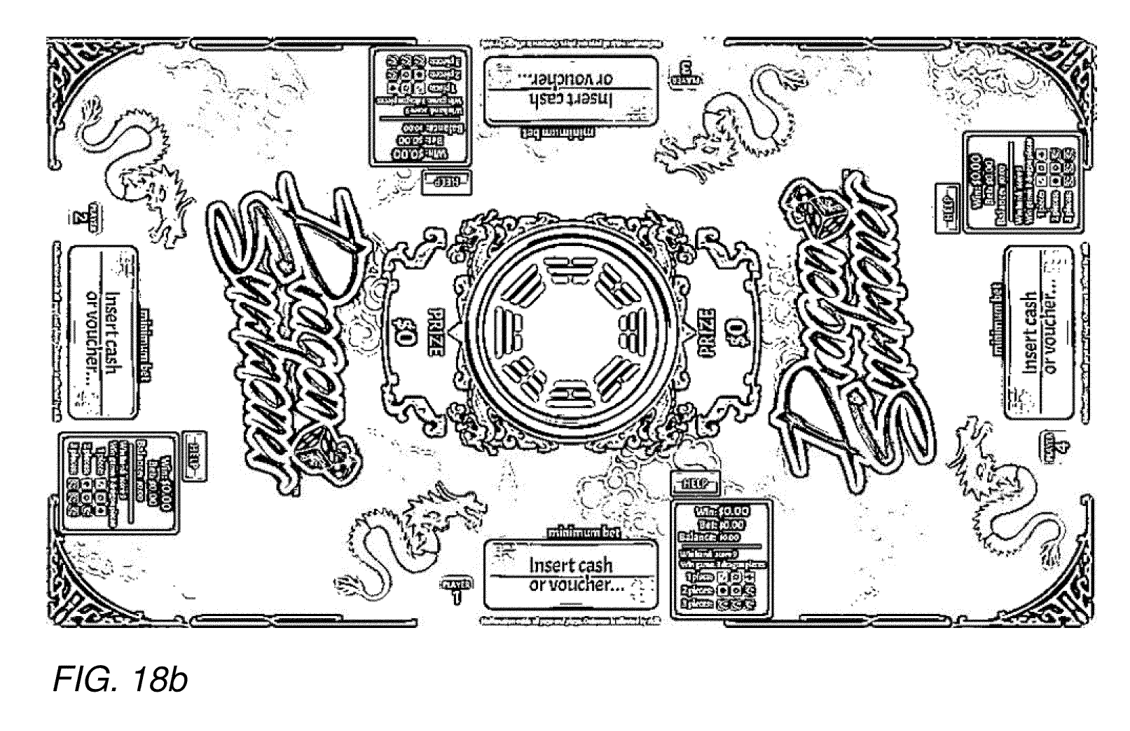

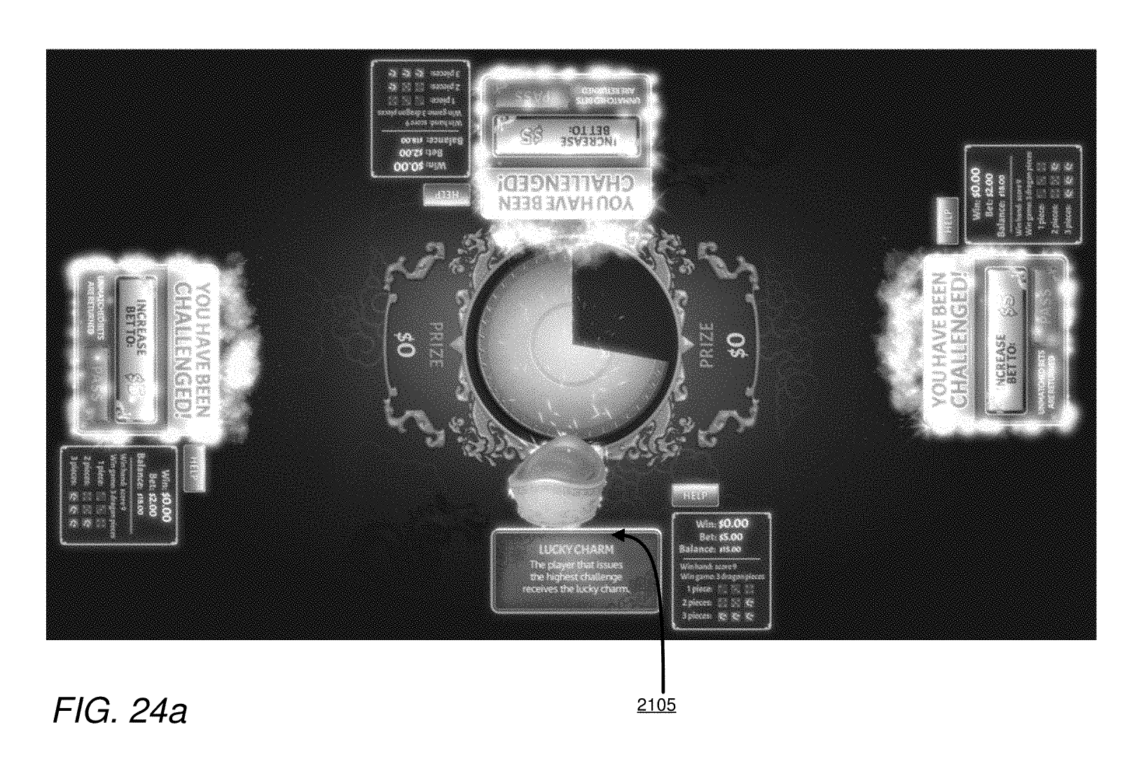

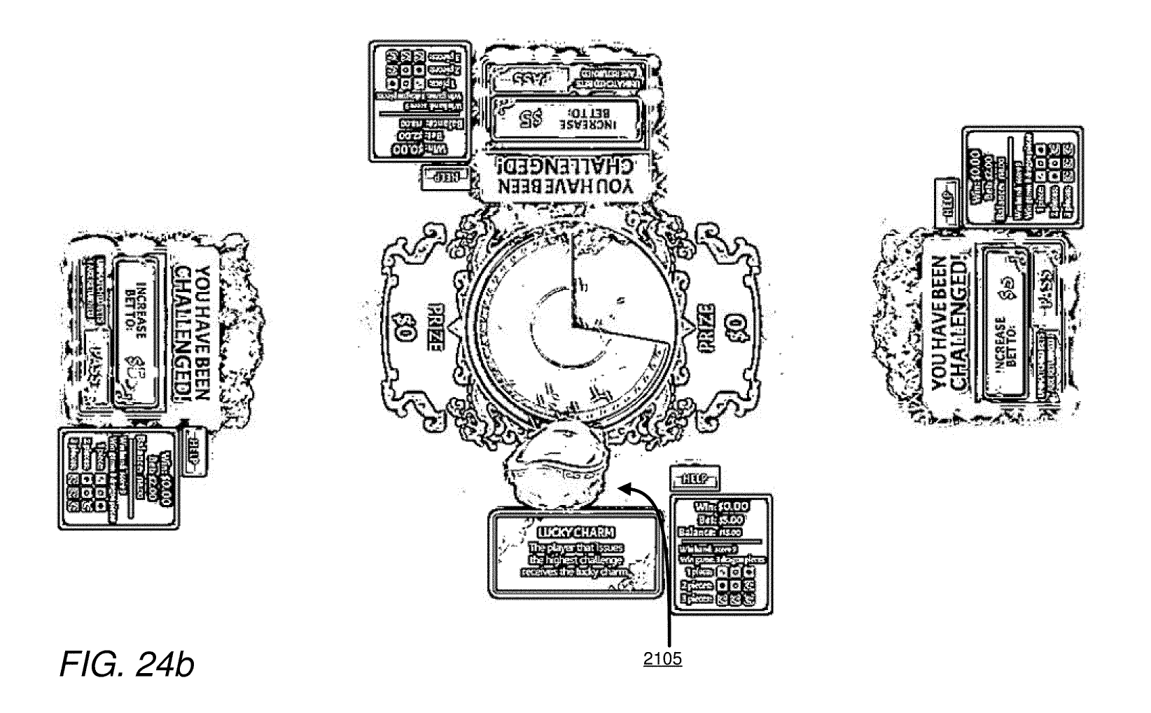

The dice collection skill competition wagering system uses an RNG to determine an outcome from a wager funded by two or more players, and then the two or more players compete head-to-head to secure the outcome. The process for the competition is illustrated in FIGS. 12-14. FIGS. 18a-25b display examples of a graphical user interface for a dice collection skill competition wagering system in accordance with various embodiments of the invention.

FIG. 12 is a program flow diagram of gameplay within a dice collection skill competition wagering system in accordance with various embodiments of the invention.

The application is initiated 2101 by one or more users. FIGS. 18a-b The users then complete a buy in 2102 for the game. The wager parameters and amounts are recorded 2103, and then the application continues 2104 by presenting the dice collection skill competition wagering game.

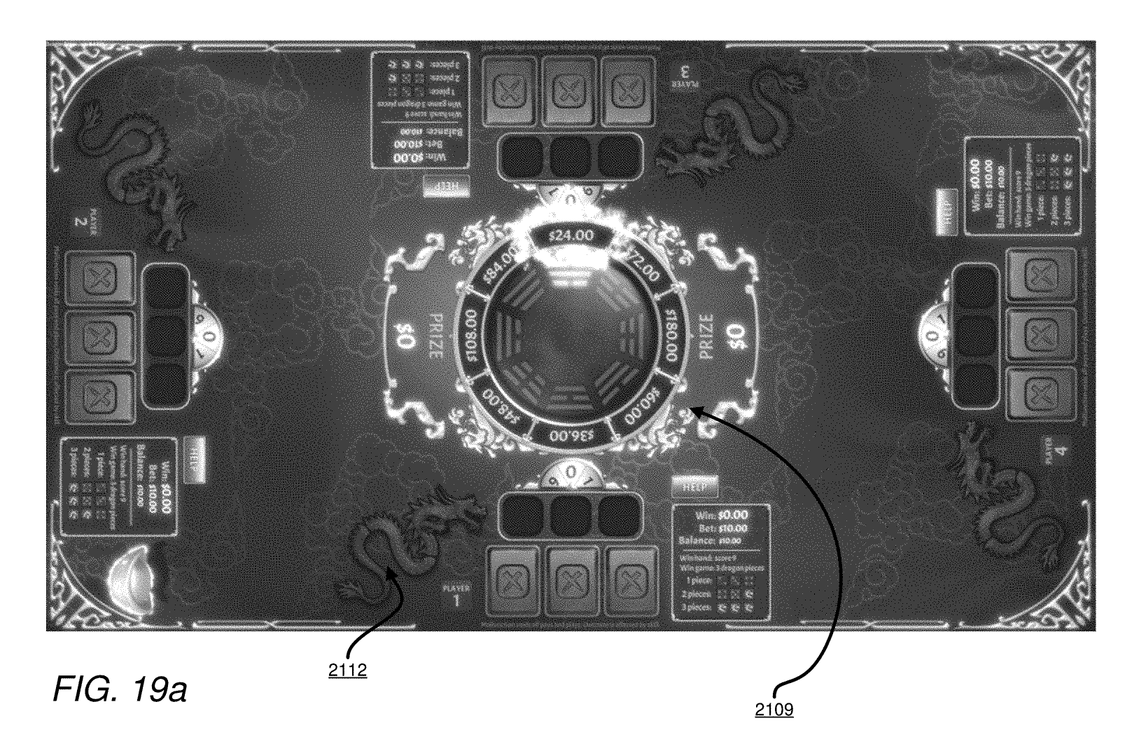

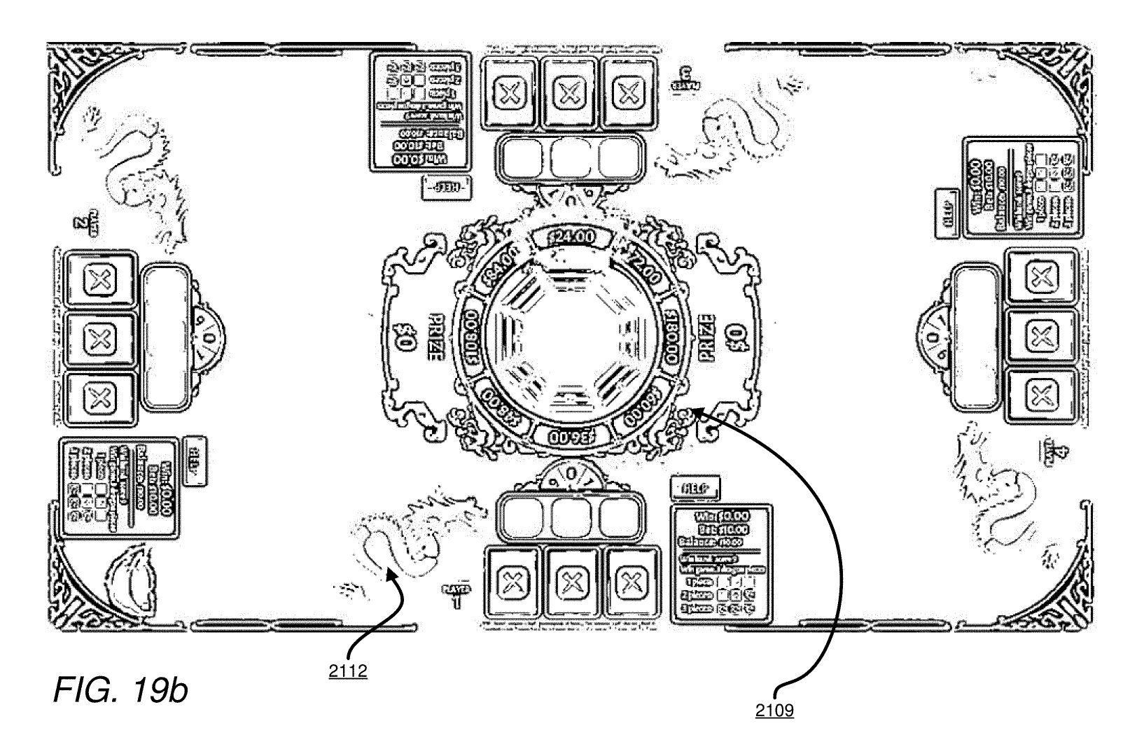

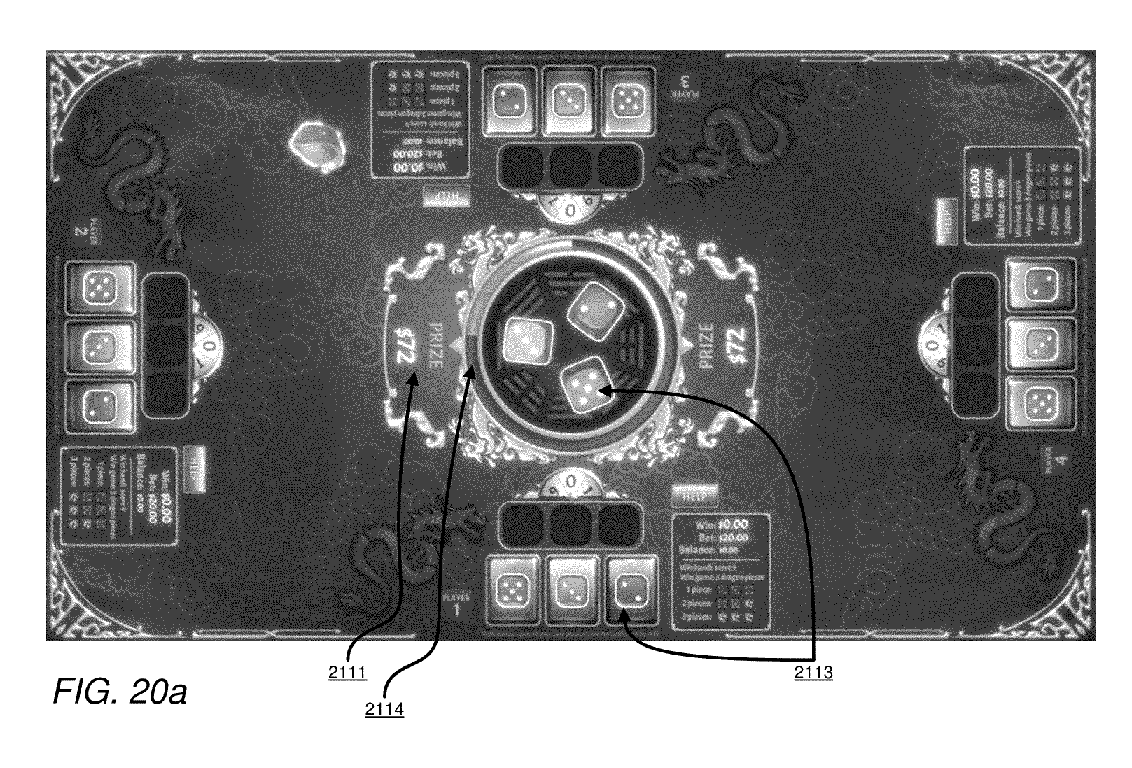

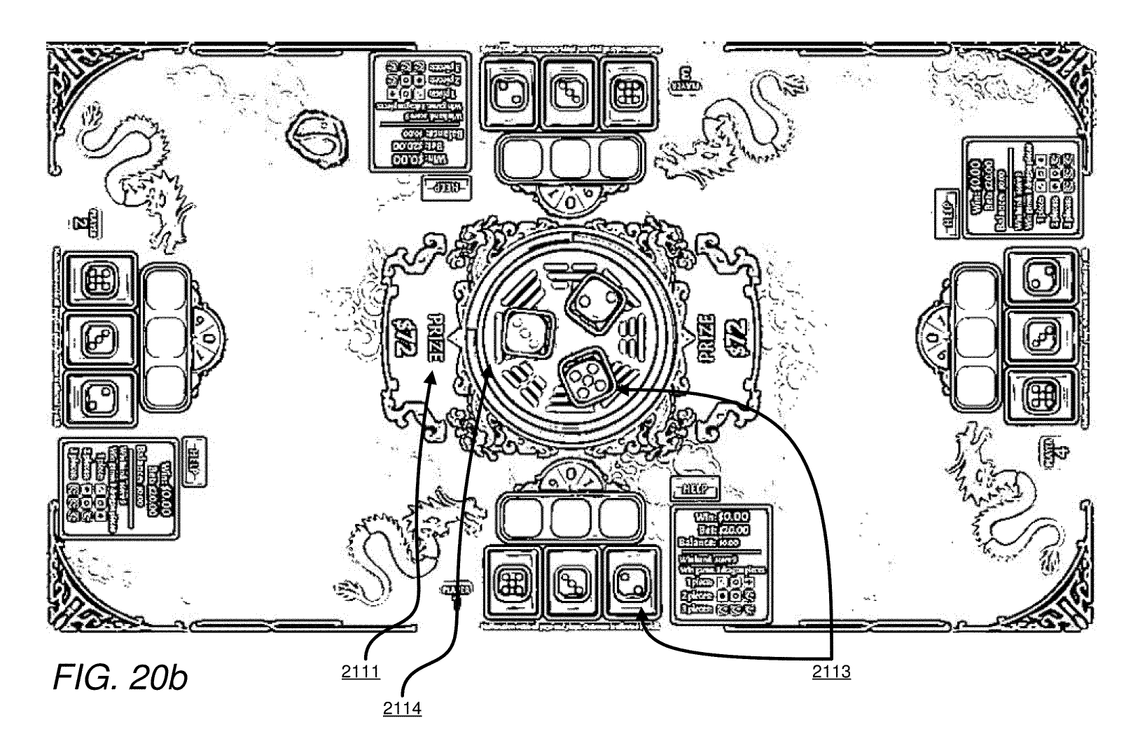

Based on the recorded data, a prize wheel is generated 2109. FIGS. 19a-b. A random number generator is used by the process controller to calculate the wager result(s) 2110. The wager result is the distributed to the interactive controller which instructs the user interface output display to show the prize to the users 2111. FIGS. 20a-b.

A visual win tracker is activated 2112 by the interactive controller. This tracker servers to display the number of rounds an individual has won 2124. A predetermined number of rounds won will result in a player winning the game 2126 and receiving the prize 2127.

In one embodiment, the dice collection skill competition wagering game presents to the players a group pool of dice 2113. In the example graphical user interface FIGS. 20a-b, three dice are displayed. Each round has a goal value for the players to reach. This value is determined by the face value of any dice, and may be modified by wild cards or special symbols on the dice. The value is obtained through a series of rolls or spins, the number of which is determined by the interactive controller.

When the dice have been displayed to the players, a timer is started 2114 by the interactive controller. This timer may be visible to players. In FIGS. 20a-b, the timer is represented by the circular graphic surrounding the dice.

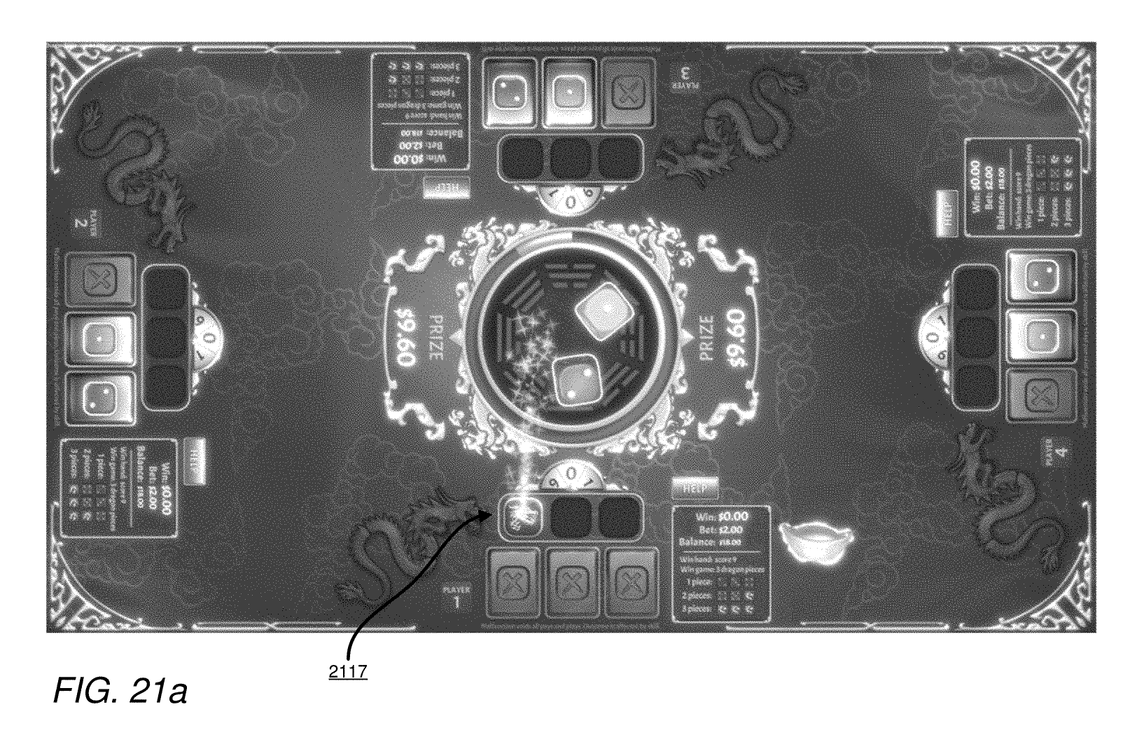

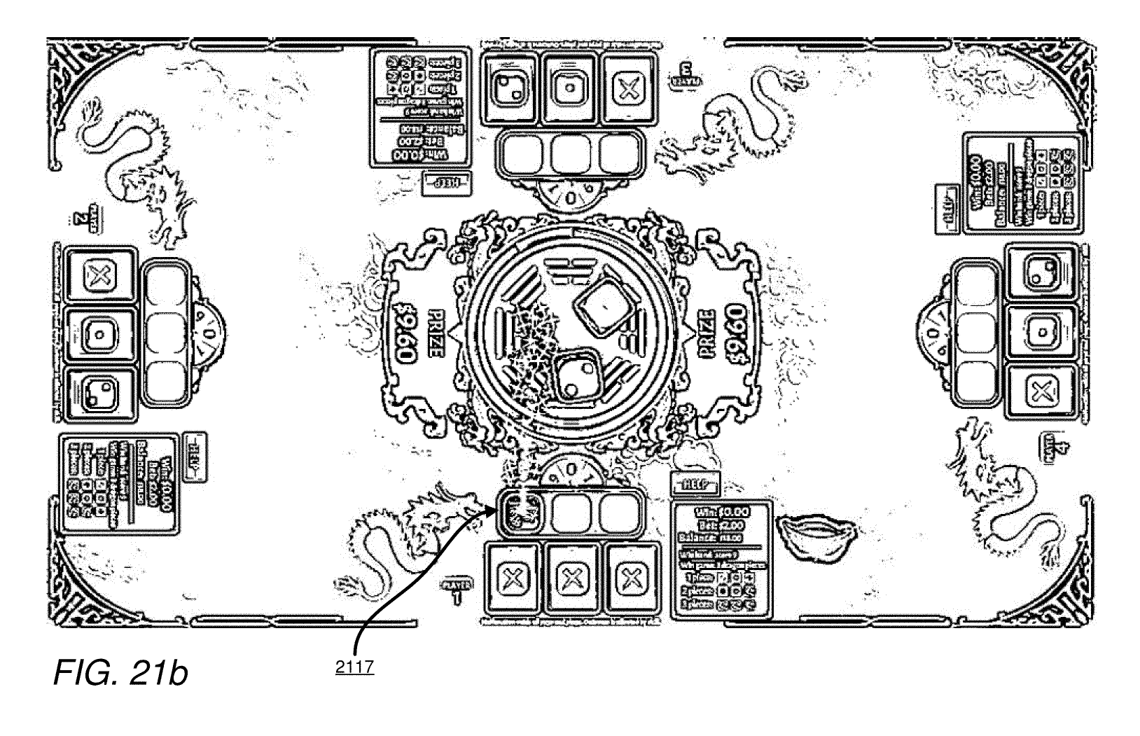

If a player selects a die 2116 before the timer runs out, the die is assigned to the player 2117. FIGS. 21a-b. The interactive controller then determines if the assigned dice causes the player to reach the goal value 2118.

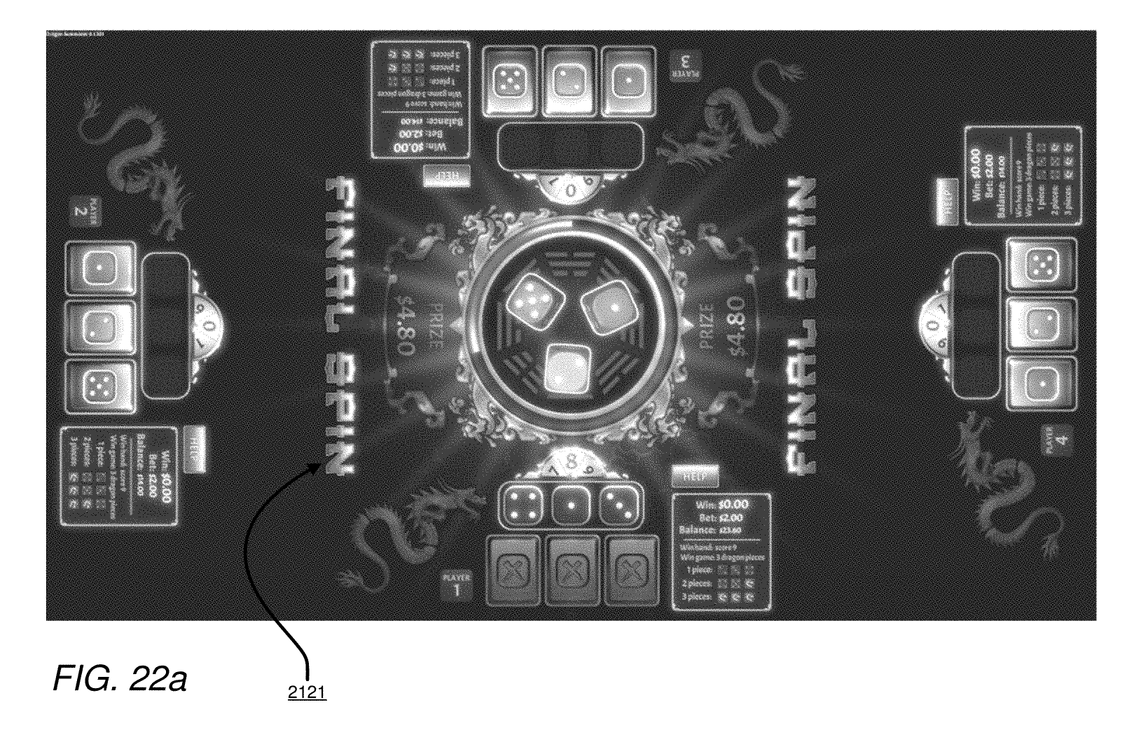

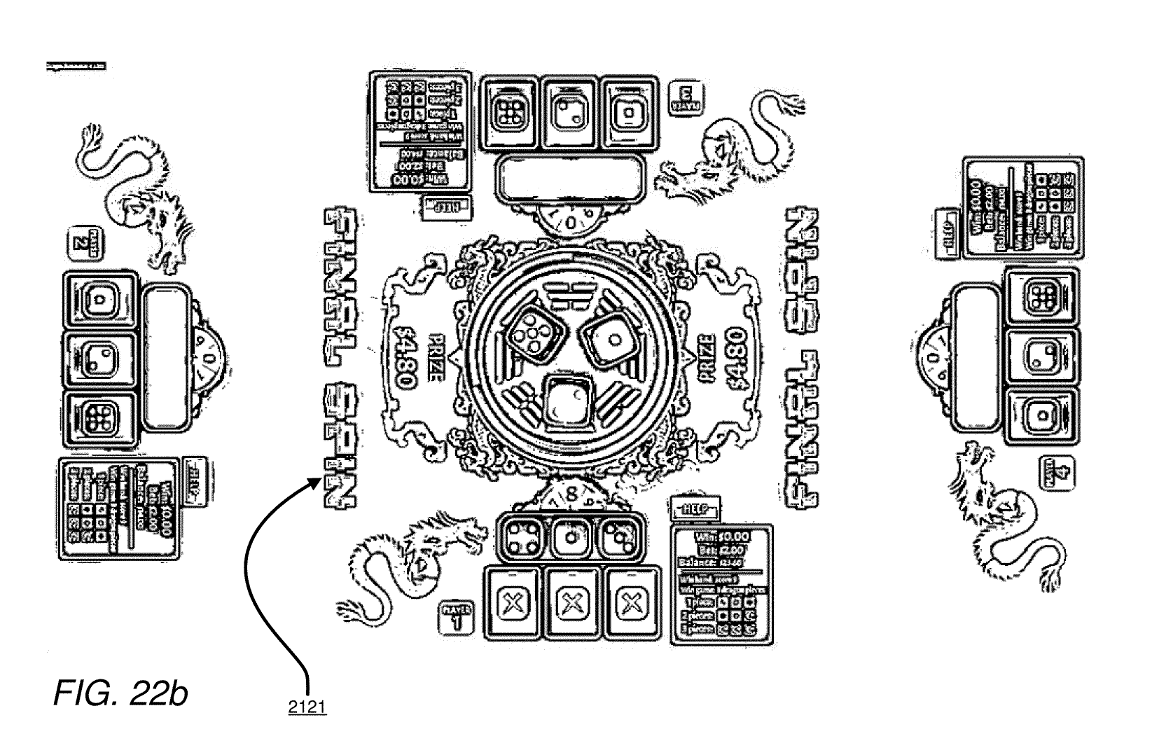

If time runs out 2115, no player receives any of the dice. If the goal value is not reached after the die is assigned to the player or time runs out, the interactive controller will determine if there are any rolls left available to the players 2119. If there are additional rolls available, the interactive controller will determine if there is only 1 remaining roll available 2120. If it is the final roll, then a new display is generated 2121 indicating the final roll. FIGS. 22a-b. Then new dice are generated to display to the users 2122 in order to continue the competition.

If it is not the final roll, then the display is not changed, and new dice are generated within the existing graphical display 2122.

If the goal value is reached 2118 or there are no more rolls available 2119, the round is ended 2123. When the round has ended, the interactive controller determines the winner of the round 2124. The winner of the round is determined by the interactive controller according to the rules available to the player. If a player has reached exactly the goal value, then the round ends and that player is the winner. In one embodiment, the winner is the player who has come closest to the winning value without exceeding it wins the round. In other embodiment, the player closest to the winning value wins the round. In cases of ties, multiple players may be assigned the win. Alternatively, ties may be determined by providing the win to the player using the least number of dice, the player who has a special wild card/bonus dice, or by a randomly generated result by a regulated RNG.

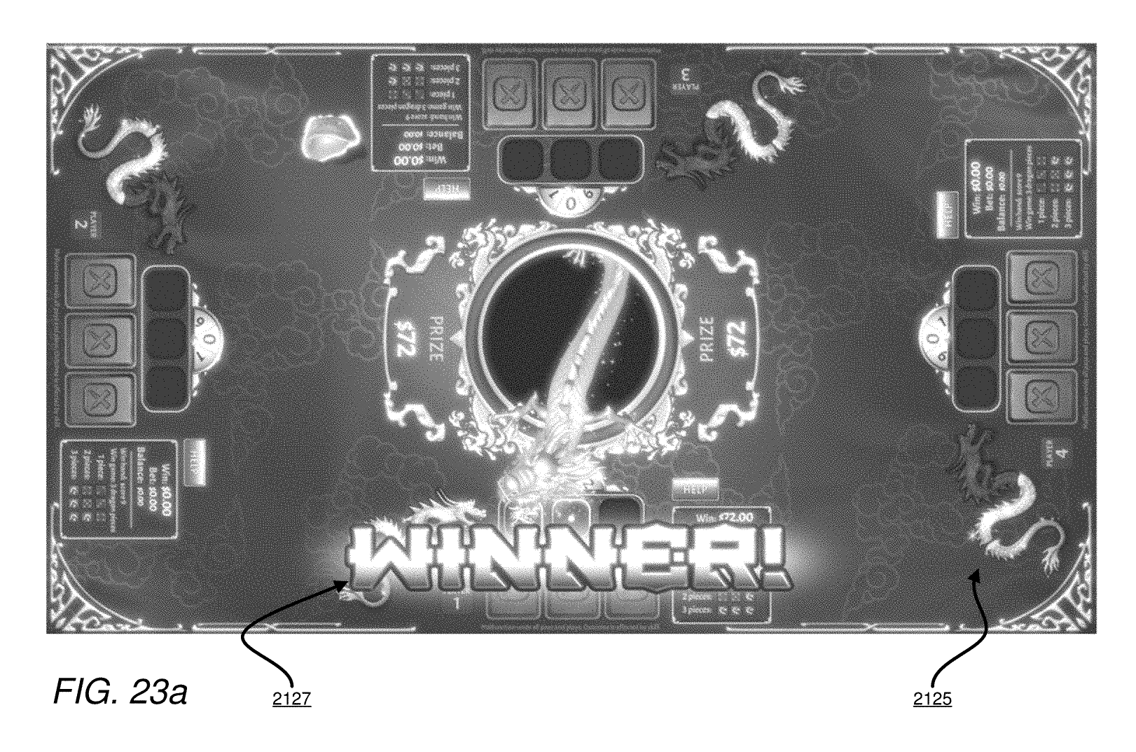

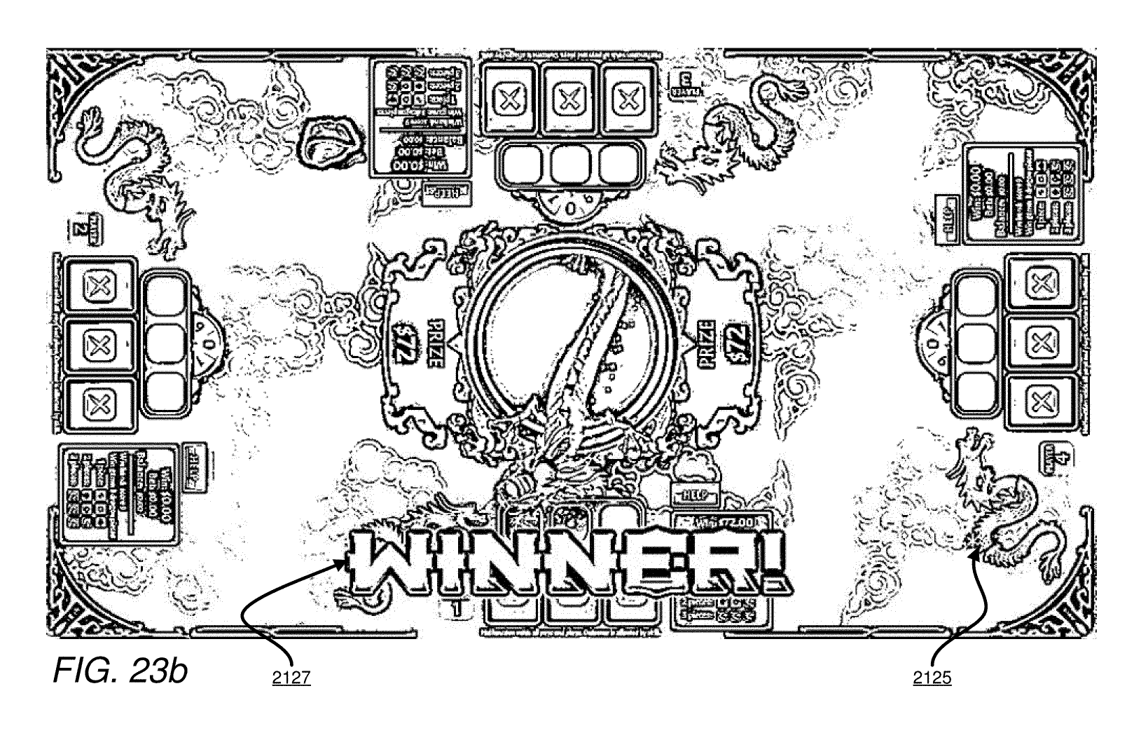

Once a winner of the round is determined, the visual win tracker 2112 is updated 2125 for the individual who has won 2124. FIGS. 23a-b. The interactive controller then determines if the win total has been reached 2126. If it has not, then the application continues 2108.

If the win total has been reached the winning player is determined and the prize generated by the process controller is distributed to that player via the interactive controller 2127. FIGS. 23a-b. After the prize has been distributed, the system continues by allowing player buy in 2102.

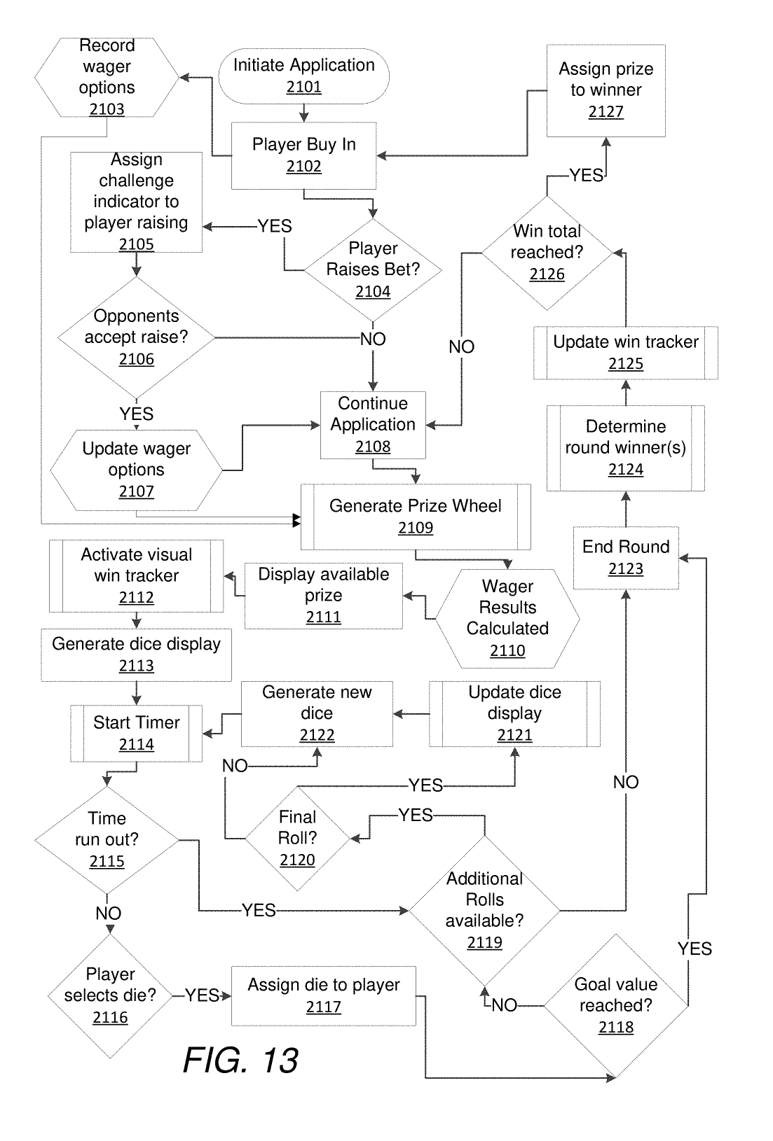

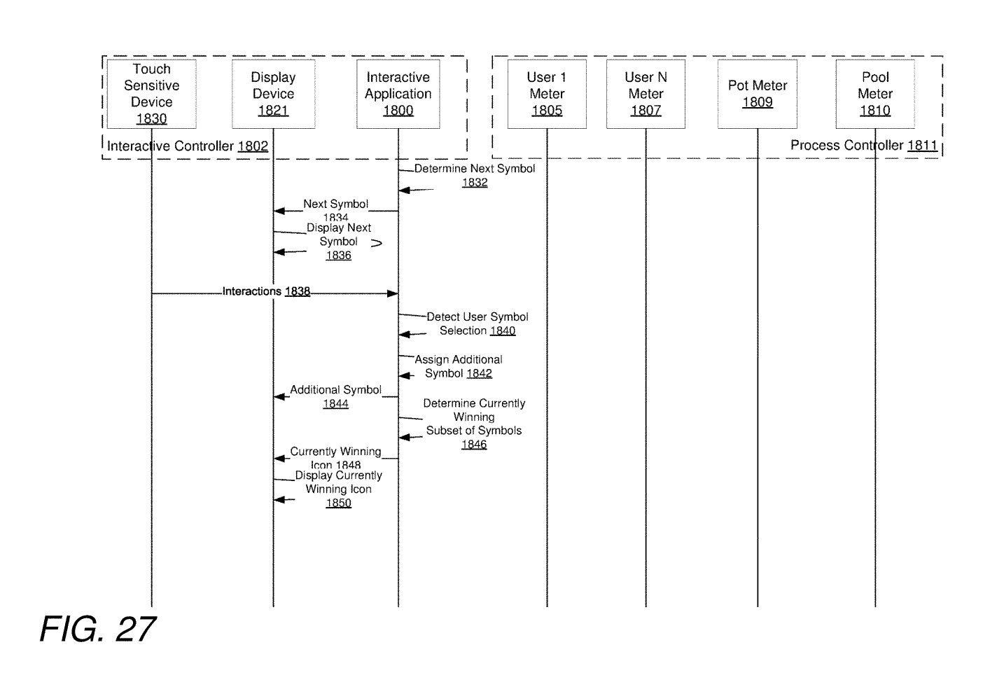

In some embodiments, as shown in FIG. 13, a player may raise or initiate a challenge 2104. A challenge indicator 2105 or lucky token is assigned to the player that initiates the raise, regardless of whether that raise is accepted by the other players. FIGS. 27a-b. If the other player(s) accept the raise 2106, then the interactive controller distributes that raise to the process controller, which updates the wager options or parameters 2107.

In one embodiment using a raise system, two or more players place an equal initial bet 2104. At that point a new UI allows the players to raise the bet. The UI includes what the higher amount would be, and a timer that shows how long they have to decide. In order for the bet raise to occur, all payers must agree to play for the higher amount 2106. If the players do not all agree to the raise, the raise fails and the players play for the amount previously agreed upon. If the players agree, a subsequent raise can be initiated 2107. The process can repeat until a player chooses not to raise. The first player to press “raise” will get to play the skill portion of the interactive application with a “lucky charm” displayed 2105. This is awarded whether or not the raise was accepted.

In another embodiment, players can initiate an additional bet (a side bet) that boosts their bet, and their bet only. If they win the round against the other players, the side bet result is revealed. If they do not win the round, the side bet is resolved against the player.

In one embodiment, the side bet resolution is shown through a GUI in which a new wheel spins after the initial group round to cover the side bet. This could be shown through a thematically appropriate random mechanic such as dice, card deals, etc. Essentially, a player is betting that they will win, and then may get an additional payout.

In another embodiment of the side bet, all participants in the side bet are in a “rake” situation where the house takes a percentage of the side bet pool, and the winner of the round, if they made a side bet, receives the remaining percentage of the side bet pool. If the winner of the round did not make a side bet, the side bet pool stays in place for the next hand, and again is accessible only to the winner of the next hand if that player also made an additional side bet.

In some embodiments, side bet pools may persist for several rounds. A player may enter into a side bet after the initial round of play and become eligible for winning the pool. In some embodiments, a player must participate in the side bet for that specific round of play in order to be eligible to win the side bet pool.

In one embodiment of the side bet, all participants in the side bet are in a “rake” situation where the house takes a percentage of the side bet pool, and the player with the highest score/best hand among those who participated in the side bet, receives the remaining percentage of the side bet pool. If the winner of the round made a side bet, they would automatically win the side bet as well. In this embodiment, the side bet is resolved each round.

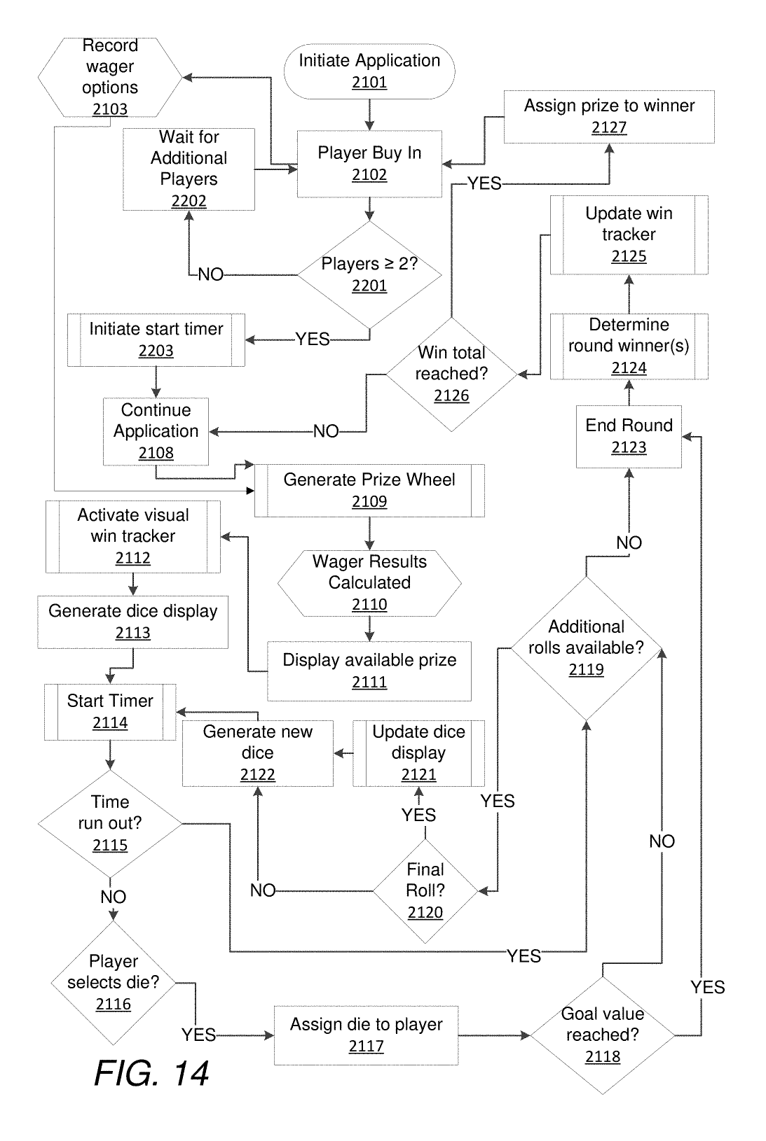

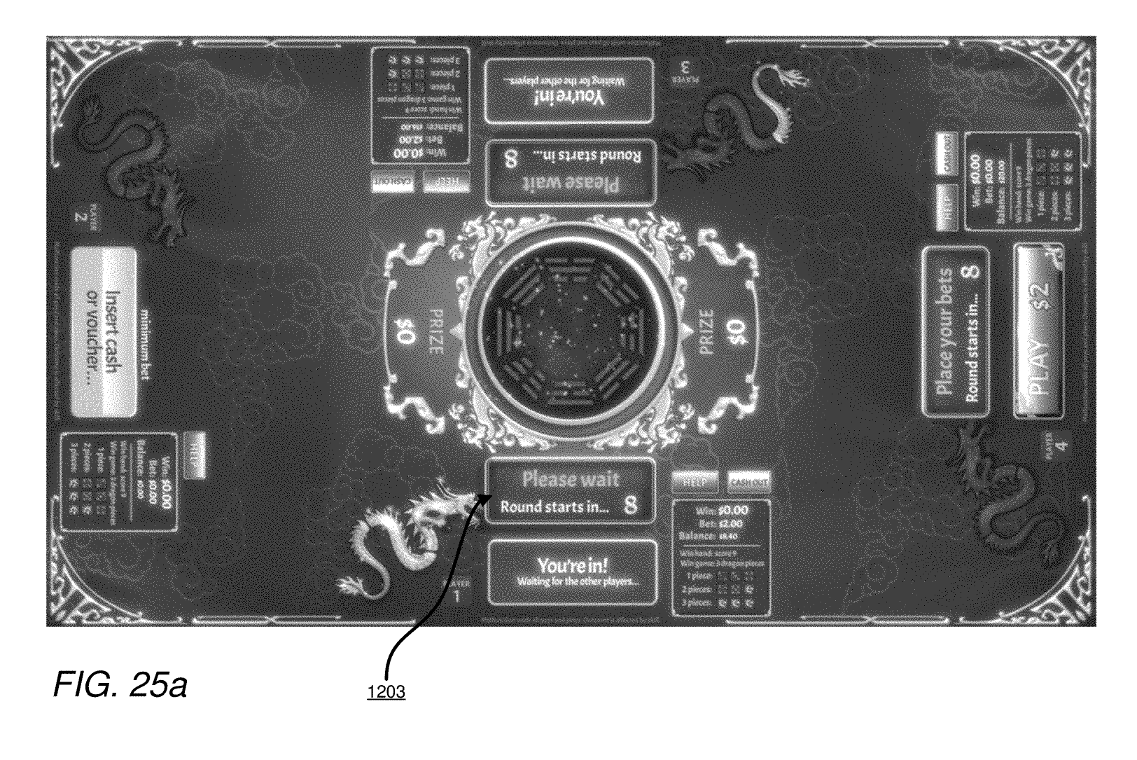

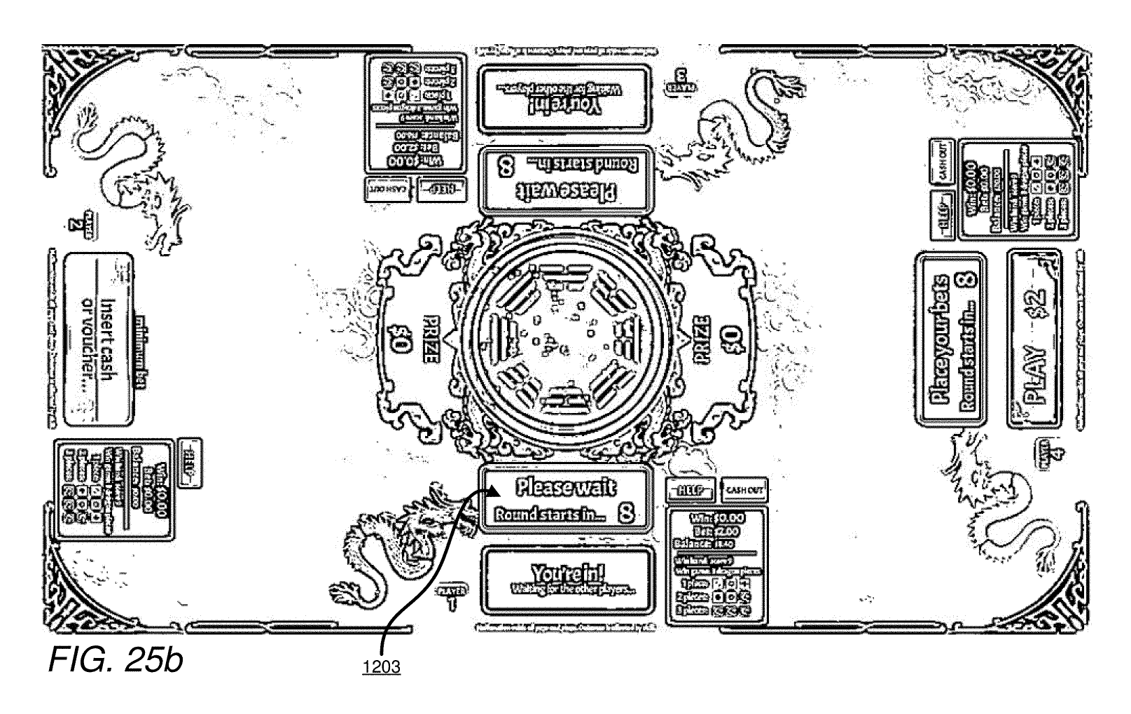

In other embodiments, as shown in FIG. 14, once there are at least 2 players 2201 who have completed a buy in, a timer starts 2203. FIGS. 25a-b. This timer once it reaches zero will start gameplay without waiting for additional players to buy in. In other embodiments, the minimum number by be different or the gameplay may not be initiated without filling every player slot.

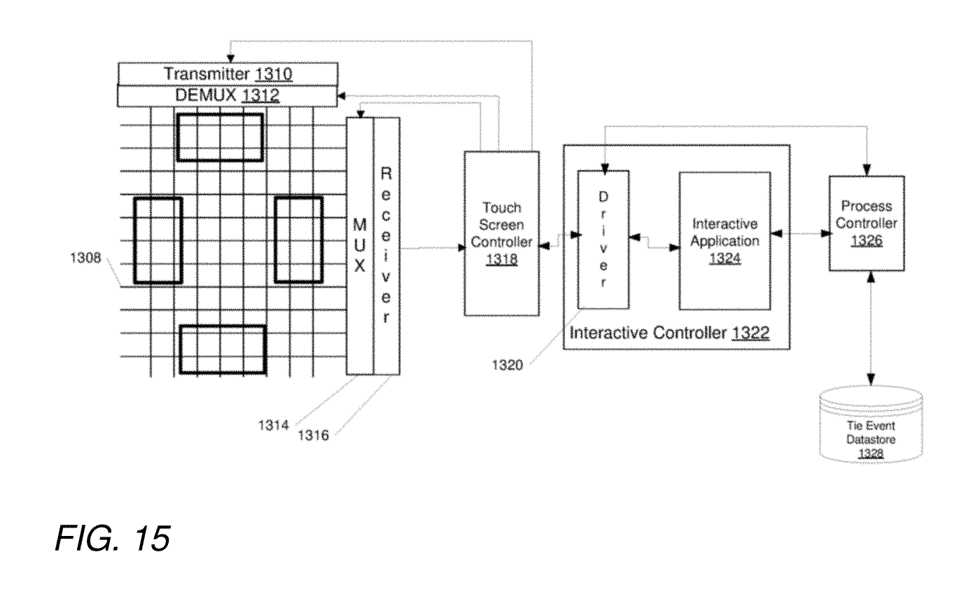

FIG. 15 is a diagram of components of a dice collection skill competition wagering system in accordance with various embodiments of the invention. A user interface is for use by two or more users when competing against each other to win a competitive skill proposition of the dice collection skill competition wagering system. The user interface is displayed on a display screen having a touchscreen with which users may interact. The touchscreen includes one or more selectable portions, that one or more users may use when interacting with the user interface. In some embodiments, two or more users compete to acquire presented symbols that are displayed to the two or more users in a presented symbol display area of the user interface. A user uses the user's respective selectable portion of the touchscreen to indicate that the user wants to acquire the presented symbol. In some instances, two or more users may attempt to acquire the same presented symbol at the same time, whereby the two or more users may interact simultaneously or nearly simultaneously with the user's respective selectable portions of the touchscreen.

Referring now to FIG. 15, in some embodiments, a capacitive touchscreen 1308 is constructed from a grid of conductive elements that are embedded into a non-conductive material. The grid includes a first set of conductive elements that are organized into columns and a second set of conductive elements that are organized into a set of rows that cross the set of conductive elements organized into columns. While the conductive elements cross each other, they are not in electrical communication with each other as they are insulated by the non-conductive material. A transmitter circuit 1310 and demultiplexer circuit 1312 are used to inject an oscillating electrical signal into the first set of conductive elements. The second set of conductive elements are connected to a multiplexer circuit 1314 and a receiver circuit 1316. The transmitter circuit, demultiplexer circuit, muliplexer circuit and receiver are controller by a touchscreen controller 1318. The touchscreen controller is further connected to a device driver 1320 that is a component of an interactive controller 1322. The device driver receives communications of touch events from the touchscreen controller and communicates those touch events to an interactive application 1324. The interactive application is connected to, and is in communication with, a process controller 1326 as described herein.

In operation, to scan the entire grid, the touchscreen controller 1318 instructs the demultiplexer 1312 to connect the transmitter 1310 to one element of the first set of conductive elements of the touchscreen grid 1308 and instructs the transmitter to inject the oscillating electrical signal into the connected conductive element. The touchscreen controller then instructs the multiplexer 1314 to sequentially scan the second set of conductive elements thus connecting each of the second set of conductive elements to the receiver 1316 in sequence. When a conductive object is placed over the touchscreen grid 1308, such as by a user touching an outer surface of the non-conductive material in which the touchscreen grid 1308 is embedded, the conductive object operates as a capacitor coupling a portion of the conductive elements of the first set of conductive elements to a portion of the conductive elements of the second set of conductive elements. If the oscillating signal is being injected into a conductive element included in the portion of the first conductive elements, then the capacitive coupling created by the conductive object will cause a corresponding oscillating electrical signal to be generated in the portion of the second set of conductive elements. This generated signal is detected by the receiver 1316 and the detection event is communicated to the touchscreen controller 1318. As the touchscreen controller 1318 is instructing the demultiplexer 1312 to sequentially connect each of the first set of conductive elements to the transmitter 1310, the touchscreen controller 1318 knows which conductive element of the first set of conductive elements is being excited by the oscillating electrical signal. Furthermore, as the touchscreen controller 1318 is instructing the multiplexer knows which conductive element of the second set of conductive elements is connected to the receiver 1316 via the multiplexer 1314, the touchscreen controller 1318 can determine a set of coordinates, in terms of an index of the first set of conductive elements and an index of the second set of conductive elements, of a location of the conductive object. Furthermore, the touchscreen controller 1318 can also determine if multiple conductive objects are contacting a surface of the non-conductive material.

In various embodiments, touchscreens other than a capacitive touchscreen may be used, such as, but not limited to, a resistive touchscreen, a surface acoustic wave touchscreen, a projected capacitive touchscreen, an optical touchscreen, an infrared touchscreen, a frustrated total internal reflection (FTRI) touchscreen, or the like.

In some embodiments of a touchscreen controller, the touchscreen controller communicates with components of the interactive controller using a serial protocol and formats touch data into data packets grouping data of one or more touch events together in the data packets. In some embodiments, the data packets may include data of one or more touch events grouped together. In various embodiments, data of grouped touch events is associated with a single time stamp. In other embodiments, the data packets may include data of one or more touch events grouped together with unique time stamps for the data of each touch event.

As the scanning process is performed sequentially, the scanning process will take a scanning period of time to detect when one or more conductive objects are touching the outer surface of the non-conductive material. Accordingly, the touchscreen controller might not be able to resolve sequential touches of the touchscreen finer the scanning period of time. That is, if two or more users touch the touchscreen within the scanning period of time, the touchscreen controller might not be able to determine which, if any, of the two or more players touched the touchscreen first.

In various embodiments, the touchscreen controller communicates data of touch events to the driver as one or more data packets. In an embodiment, a model ZXY200 or ZXY300 touchscreen controller from Zytronic in Blaydon upon Tyne, United Kingdom, is used. Table 1 depicts a format of a touchscreen packet communicated from such a touchscreen controller to a driver in accordance with an embodiment of a dice collection skill competition wagering system.

TABLE 1

| Touch | Touch | | | Touch | |
|---|---|---|---|---|---|
| packet | Report | | Byte | Report | |
| Byte Index | Index | Description | Index | Index | Description |
| 0 | NA | Report | 31 | 6 | Contact |
| | | ID = 0x01 | | | Flags |
| 1 | 1 | Contact | 32 | 6 | Contact ID |
| | | Flags | 33 | 6 | X position |
| 2 | 1 | Contact ID | | | LSB |
| 3 | 1 | X position | 34 | 6 | X position |
| | | LSB | | | MSB |
| 4 | 1 | X position | 35 | 6 | Y position |
| | | MSB | | | LSB |
| 5 | 1 | Y position | 36 | 6 | Y position |
| | | LSB | | | MSB |
| 6 | 1 | Y position | 37 | 7 | Contact |
| | | MSB | | | Flags |
| 7 | 2 | Contact | 38 | 7 | Contact ID |
| | | Flags | 39 | 7 | X position |
| 8 | 2 | Contact ID | | | LSB |
| 9 | 2 | X position | 40 | 7 | X position |
| | | LSB | | | MSB |
| 10 | 2 | X position | 41 | 7 | Y position |
| | | MSB | | | LSB |
| 11 | 2 | Y position | 42 | 7 | Y position |
| | | LSB | | | MSB |
| 12 | 2 | Y position | 43 | 8 | Contact |
| | | MSB | | | Flags |
| 13 | 3 | Contact | 44 | 8 | Contact ID |
| | | Flags | 45 | 8 | X position |
| 14 | 3 | Contact ID | | | LSB |
| 15 | 3 | X position | 46 | 8 | X position |
| | | LSB | | | MSB |
| 16 | 3 | X position | 47 | 8 | Y position |
| | | MSB | | | LSB |
| 17 | 3 | Y position | 48 | 8 | Y position |
| | | LSB | | | MSB |
| 18 | 3 | Y position | 49 | 9 | Contact |
| | | MSB | | | Flags |
| 19 | 4 | Contact | 50 | 9 | Contact ID |
| | | Flags | 51 | 9 | X position |
| 20 | 4 | Contact ID | | | LSB |
| 21 | 4 | X position | 52 | 9 | X position |
| | | LSB | | | MSB |
| 22 | 4 | X position | 53 | 9 | Y position |
| | | MSB | | | LSB |
| 23 | 4 | Y position | 54 | 9 | Y position |
| | | LSB | | | MSB |
| 24 | 4 | Y position | 55 | 10 | Contact |
| | | MSB | | | Flags |
| 25 | 5 | Contact | 56 | 10 | Contact ID |
| | | Flags | 57 | 10 | X position |
| 26 | 5 | Contact ID | | | LSB |
| 27 | 5 | X position | 58 | 10 | X position |
| | | LSB | | | MSB |
| 28 | 5 | X position | 59 | 10 | Y position |
| | | MSB | | | LSB |
| 29 | 5 | Y position | 60 | 10 | Y position |
| | | LSB | | | MSB |
| 30 | 5 | Y position | 61 | NA | Number of |
| | | MSB | | | touch |
| | | | | | reports |
| | | | 62 | NA | Scan Time - LSB |
| | | | 63 | NA | Scan Time - MSB |

In accordance with such an embodiment, each packet is 64 bytes long and includes touch event data, as 16 bits of x and y position data, a flag to indicate a type of the touch event, and a unique identifier. The packet also includes 16 bits of time scan data indicating when the data of the touch events was collected.

As data of one or more touch events may be in the same data packet, the driver receives these data packets and scans the data packets to determine if data of two or more touch events are in a single data packet. If so, the driver determines that a tie has occurred between two or more users attempting to touch the touchscreen simultaneously or nearly simultaneously. To resolve the tie, the driver communicates a request for a randomized sequence of elements to the process controller.

In some embodiments, a request for a randomized sequence of elements includes data of the touch events that were communicated from the touchscreen controller to the driver.

The process controller receives the request for the randomized sequence of elements from the driver and generates the randomized sequence of elements. The randomized sequence of elements includes two or more elements, with the number of elements of the randomized sequence of elements corresponding to the number of touch events that are involved in the tie that the driver detected.

In many embodiments, a process controller uses a random number generator to generate a sequence of random numbers that are used to randomize a sequence of elements corresponding to touch events.

In some embodiments, a request for a randomized sequence of elements includes original touch event data communicated from a touchscreen controller to a driver. The process controller receives the original touch event data and stores the original touch event data as well as the randomized sequence of elements generated by the process controller as tie event data in a tie event datastore 1328.

In various embodiments, a request for a randomized sequence of elements includes original touch event data communicated from a touchscreen controller to a driver. A process controller receives the original touch event data and generates the randomized sequence of elements using the original touch event data to generate touch event data that includes data of an ordered set of touch events wherein an order of the data of the touch events in the touch event data is in an order that identifies data of at least one touch event as a first touch event in time and data of one or more touch events as subsequent touch events in time, thus breaking a tie between the touch events by setting which of the touch events is to be considered first in time. In some such embodiments, data of two or more touch events are ordered from first in time to last in time in order to break a tie between the two or more touch events.

The process controller communicates the randomized sequence of elements to the driver. The driver receives the randomized sequence of elements and uses the randomized sequence of elements along with the touch event data to generate data of an ordered set of touch events that identifies data of one touch event as data of a first touch event in time and data of one or more touch events as data of subsequent touch events in time, thus breaking a tie between the touch events by determining which of the touch events is to be considered first in time. In some such embodiments, data of two or more touch events are ordered from first in time to last in time in order to break a tie between the two or more touch events. The driver communicates data of the ordered set of touch events to the interactive application.

In some embodiments, a request for a randomized sequence of elements includes original touch event data communicated from a touchscreen controller to a driver. A process controller receives the original touch data and generates the randomized sequence of elements using the original touch data to generate touch data that includes data of an ordered set of touch events wherein an order of data of the touch events in the touch event data is in an order that identifies data of at least one touch event as data of a first touch event in time and data of one or more touch events as data of subsequent touch events in time, thus breaking a tie between the touch events by determining which of the touch events is to be considered first in time. In some such embodiments, data of two or more touch events are ordered from first in time to last in time in order to break a tie between the two or more touch events. In such embodiments, the driver forwards the touch event data received from the process controller to the interactive application.

Various embodiments may use different thematic elements. The user interface illustrated in FIGS. 18a-25b present a Chinese themed board. Dragons are used as a visual win tracker 2112, and a gold ingot is used as the lucky token 2105.

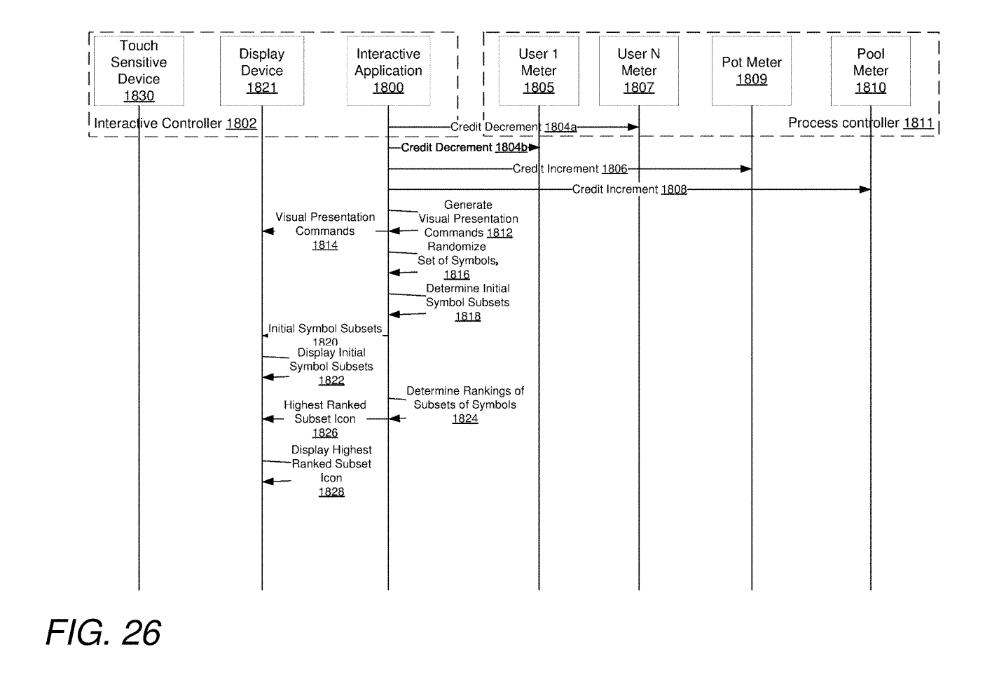

FIGS. 26 to 29 are illustrations of a process of a dice collection skill competition wagering system in accordance with various embodiments of the invention. Referring now to FIGS. 26 and 27, an interactive application 1800 executed by an interactive controller 1802 of the dice collection skill competition wagering system decrements credits, such as credit decrements 1804a and 1804b, from one or more user credit meters, such as credit meters 1805 and 1807, of a metering subcontroller of a process controller 1811, as described herein, the one or more user credit meters associated with one or more users respectively, and adds 1806 the decremented credits as a credit increment to a pool credit meter of the metering subcontroller. In some embodiments, some of the credits decremented from the users are added 1808 to a pool credit meter 1810.

The interactive application generates 1812 the visual presentation of the user interface and commands 1814 a display device 1821 of the interactive controller to display the visual presentation. The display device displays the visual presentation. The interactive application generates 1816 a set of symbols in a randomized sequence. In some embodiments, the interactive application uses services of a process controller to generate the set of symbols in the randomized sequence.

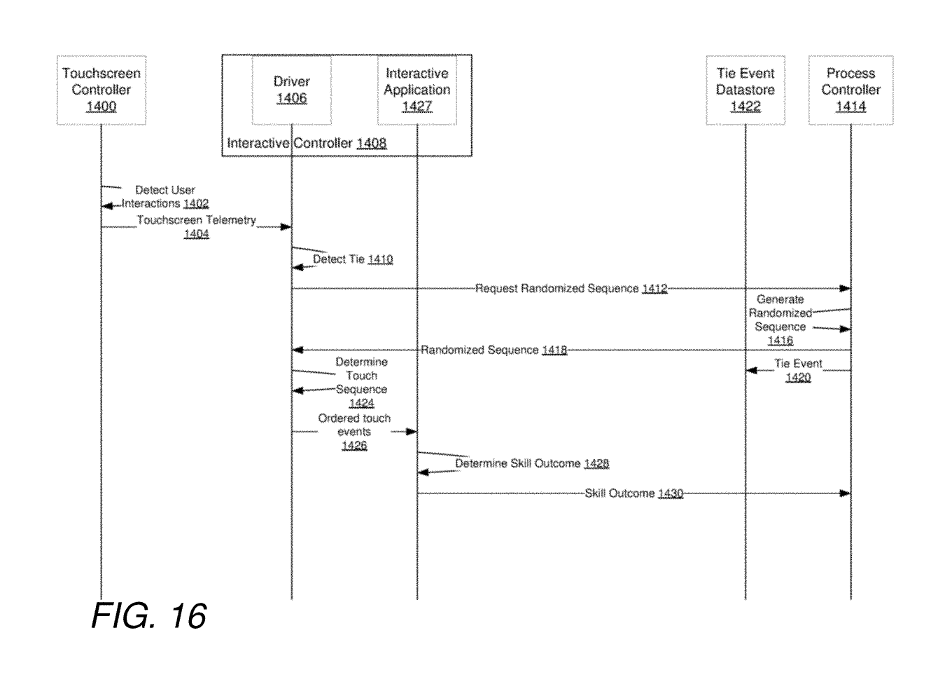

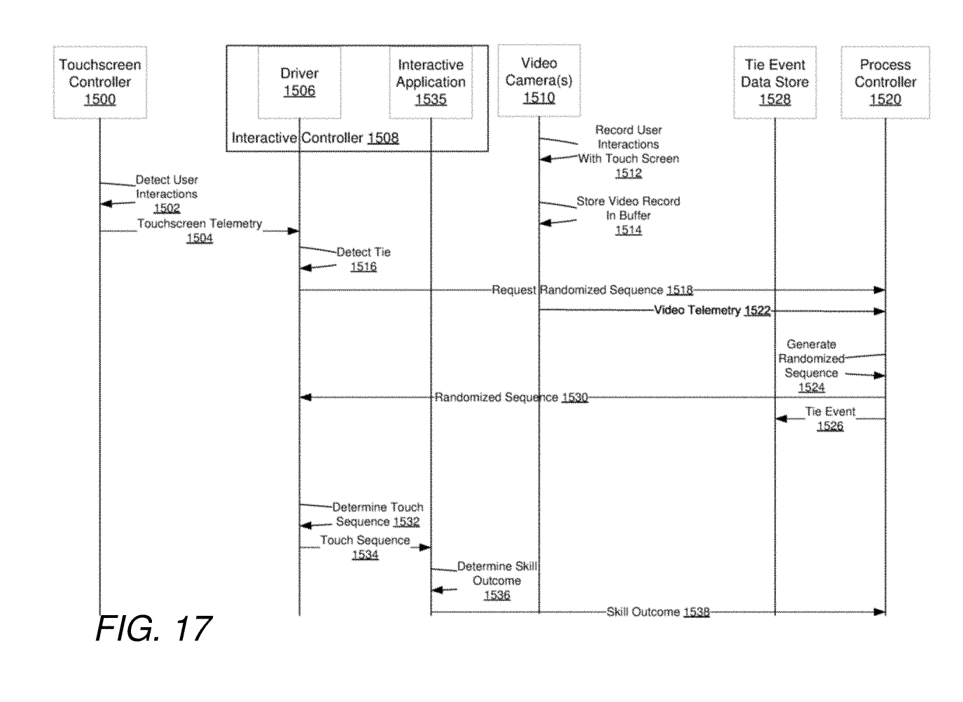

The interactive application determines 1818 and assigns one or more initial subsets of the set of symbols without replacement respectively to each of the one or more users. The interactive application commands 1820 the display to display 1822 the initial subsets in each user's respective user interface portion. The interactive application determines 1824 a ranking of the subsets of symbols associated with the users and commands 1826 the display to display 1828 a highest ranked symbol subset icon (1718 if FIG. 16) in the user interface portion of the user with the highest ranked subset of symbols.

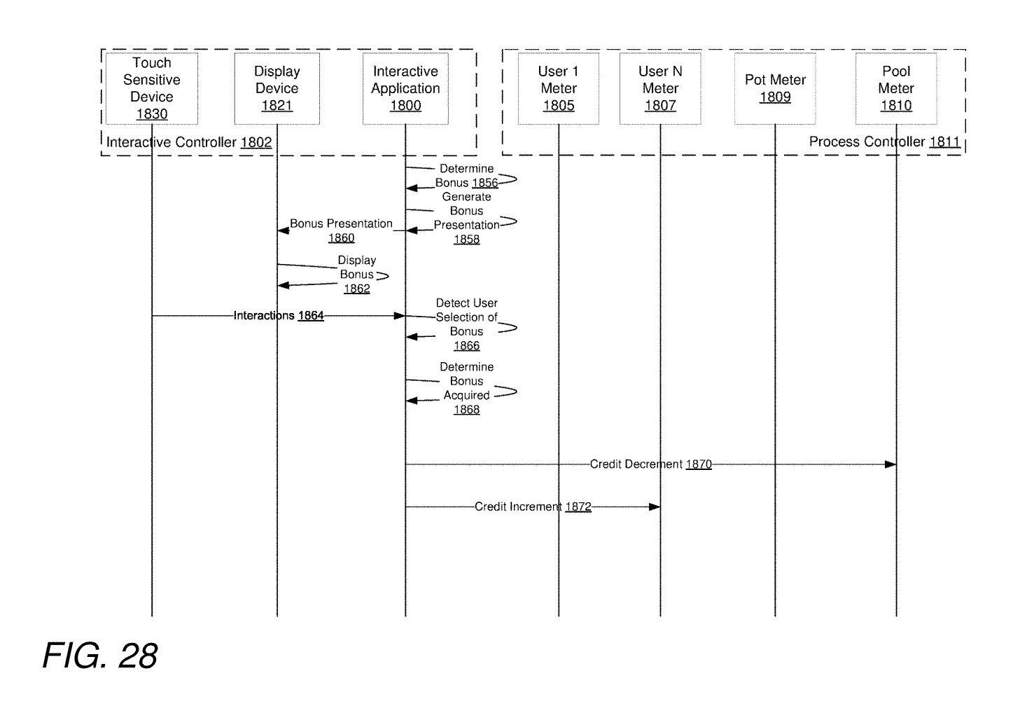

Referring now to FIGS. 27 and 28, the interactive application 1800 determines 1832 a next symbol from the set of symbols and commands 1834 the display device 1821 to display 1836 the next symbol in the next symbol display portion of the visual presentation of the user interface (1714 of FIG. 25). The interactive application continuously monitors user interactions 1838 with the touch sensitive device 1830 of the user interface to detect 1840 that a user has selected the next symbol for inclusion in the user's subset of symbols.

In some embodiments, if two or more users are utilizing the interactive controller, the interactive application does not accept any other user's attempted selection of the next symbol after the interactive application has detected that one of the user's has selected the next symbol, thus locking all of the other users out of the selection process.

In some embodiments, if the dice collection skill competition wagering system detects that there is a tie between users attempting to select the same symbol, the dice collection skill competition wagering system breaks the tie as described herein.

The interactive application assigns 1842 the selected symbol to the successful user's subset of symbols and communicates data of the selected symbol 1844 to the display device for display in the successful user's respective portion of the user interface. The interactive application determines 1846 a ranking of the subsets of symbols assigned to the one or more users and commands 1848 the display device to display 1850 a highest ranked subset winning icon as described herein.

In various embodiments of a dice collection skill competition wagering system, the symbol set represents a deck of virtual playing cards, and the set of symbols are a deck of virtual playing cards including 4 suits (spades, clubs, hearts, and diamonds) with each suit having face values of ace, two to ten, jack, king and queen. In some embodiments, each subset of the set of symbols represents a virtual card hand held by a user. In various embodiments, each player can have at most five symbols in their subset of symbols, and the subsets of symbols are ranked based on the rules for evaluating poker hands.

In some embodiments of a dice collection skill competition wagering system, each user receives two symbols as the initial subset of symbols. Subsequently, the next symbol from the set of symbols is displayed to all of the users for a fixed amount of time and each of the users is allowed to attempt to grab or select the next symbol, using the player's respective a selector display portion, such as a selector display portion 1712 of FIG. 25, to add to their respective subset of the set of symbols by being the first in time to select the next symbol. The process of presenting and selecting next symbols continues until the set of symbols is exhausted or each user has selected a specified number of symbols.

FIG. 28 is an illustration of a process of a dice collection skill competition wagering system in accordance with various embodiments of the invention. In some embodiments, the interactive application 1800 determines 1852 that one or more of the users has acquired the specified number of symbols in their respective subsets and then the interactive application deletes 1854 all but another specified number of remaining symbols from the remaining symbols in the set of symbols to implement a burndown process as described herein. The current stage of the competitive skill proposition continues using the specified number of remaining symbols until all of the symbols in the set of symbols have been presented to the users, or until all of the users have filled their subset of the set of symbols.

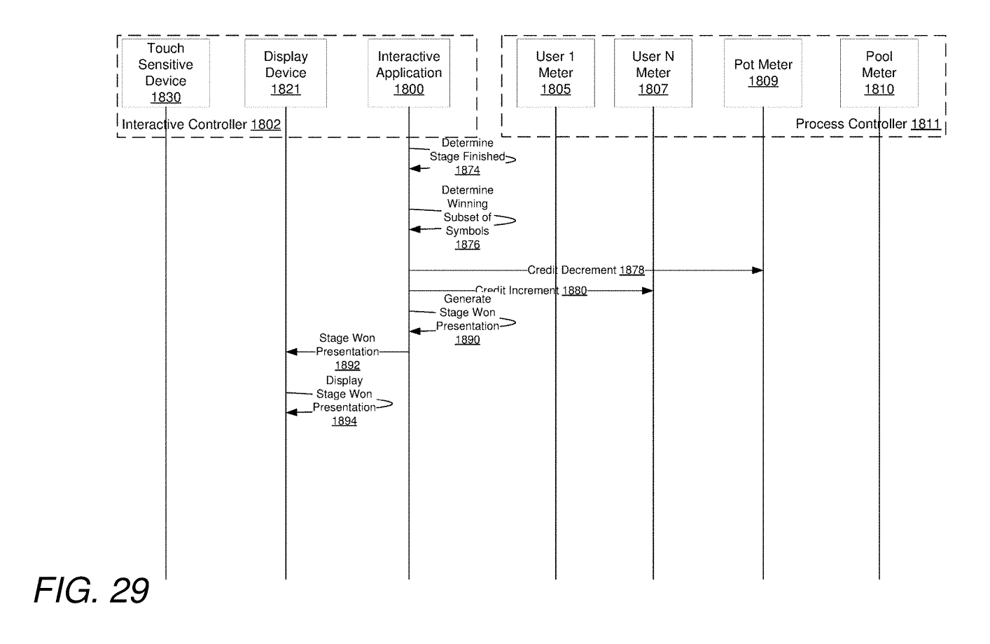

FIG. 29 is an illustration of a process of a dice collection skill competition wagering system in accordance with various embodiments of the invention. In some embodiments, the interactive application 1800 determines 1856 to provide a bonus to be randomly displayed to the one or more users. The first user to select to receive the bonus will receive the bonus. The interactive application generates 1858 a bonus presentation and commands 1860 the display device 1821 to display 1862 the bonus presentation. The interactive application then continuously monitors user interactions 1864 with the touchscreen device 1830 to detect 1866 selection of the bonus by a user. If the interactive application determines 1868 that the bonus was selected, the interactive application debits 1870 the pool credit meter 1810 to provide an amount of credits for the bonus, and increments 1872 a credit meter 1807 of the user that acquired the bonus.

In some embodiments, if the dice collection skill competition wagering system detects that there is a tie between users attempting to select the bonus, the dice collection skill competition wagering system breaks the tie as described herein.

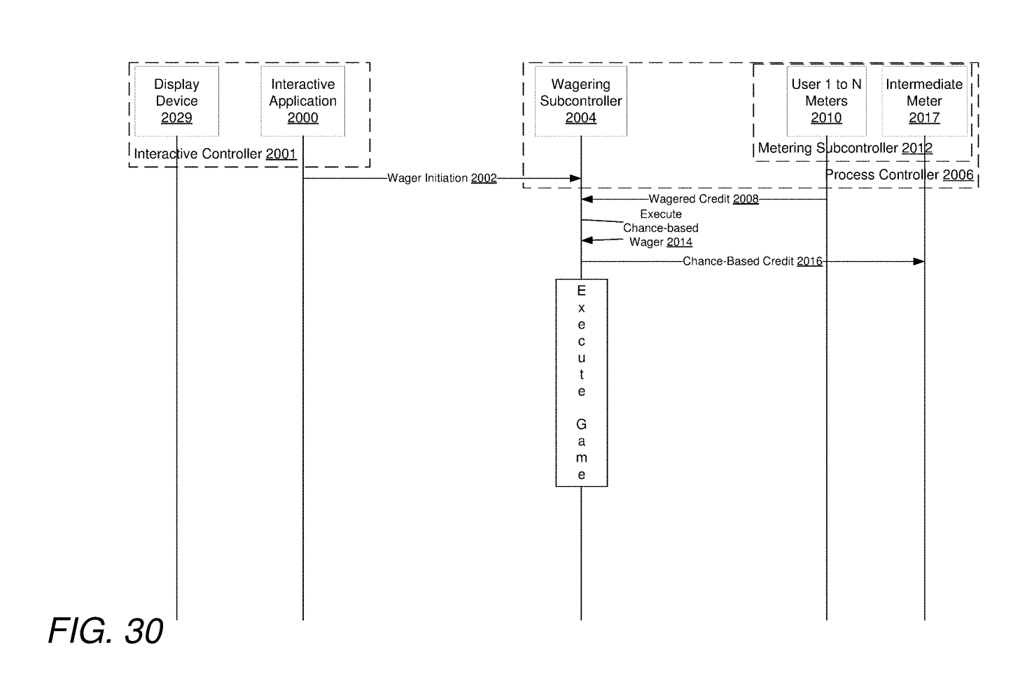

FIG. 30 is an illustration of a process of a dice collection skill competition wagering system in accordance with various embodiments of the invention. An interactive application 1800 of an interactive controller of the dice collection skill competition wagering system determines 1874 that a stage of the competitive skill proposition is complete, either because the set of symbols to be presented to the users has been depleted, or that each user has filled their respective subset of symbols of the set of symbols. The interactive application then determines 1876 a winning subset of symbols by ranking each subset of symbols and determining a winning subset of symbols as the subset of symbols having the highest ranking. The interactive application, using services of the interactive controller, commands 1878 the metering subcontroller to decrement the pot credit meter 1809 and increment 1880 the credit meter 1807 of the user having the highest ranked subset of symbols. The interactive application generates 1890 a presentation indicating that a user has won the stage of the competitive skill-proposition and commands 1892 the display device 1821 to display 1894 the presentation and the display device displays the stage won presentation.

In some embodiments, in a house-backed competitive skill proposition, two or more users provide an amount of credits that are wagered against the house and a random number generator and a paytable are used to determine an amount of credits that user compete to acquire. In such embodiments, a visual presentation of the user interface further includes a prize indicator that indicates a chance-based outcome of an amount of credit that a winner of a stage of a skill competition will earn. The amount of credit of the chance-based outcome is determined through the use of a random number generator and a paytable to determine the chance-based outcome for a wagered amount of credit. The wagered amount of credit is taken equally from respective credit balances of the two or more users. In some embodiments, the paytable is structured such that a minimum credit amount of the chance-based outcome is greater than or equal to the wagered amount of credit taken from a single user, whereby a winning user of the stage of the skill competition will be ensured of winning back at least their wagered amount of credit.

In some embodiments, the prize indicator incorporates a wagering process indicator that indicates that a chance-based wager has been conducted. The indicator includes a circular dial face and a spinner indicator that spins or rotates within the circular face. To indicate that a chance-based wager of credits has been made, the spinner indicator spins or rotates and comes to rest on an amount of credit that a user can win by winning a round of the competitive skill proposition.

In an embodiment, the visual representation of the user interface is for a competitive skill proposition that is a virtual poker game-style card game utilizing a set of symbols in the form of a deck of virtual cards where the virtual poker game-style card game is played by two or more users. Each user of the two or more users is provided with a starting hand of two virtual cards that are provided face up to the two or more users such that each user may see the hand of each other user. Additional virtual cards are provided face up in a center portion of the user interface such that each user may see the virtual card when provided. The virtual card is provided for a specified amount of time. User's compete with each other to add the virtual card to their respective hands to make the best poker hand that each user can. If a user wants to add the virtual card to their hand, they select the virtual card using a respective selector display portion of the user interface respective to that user. Each user may select virtual cards to add to their hand until they have five cards in their hand. The virtual cards are presented to the users until there are no more virtual cards left in the virtual deck. A winner is determined by which user has the best poker hand.

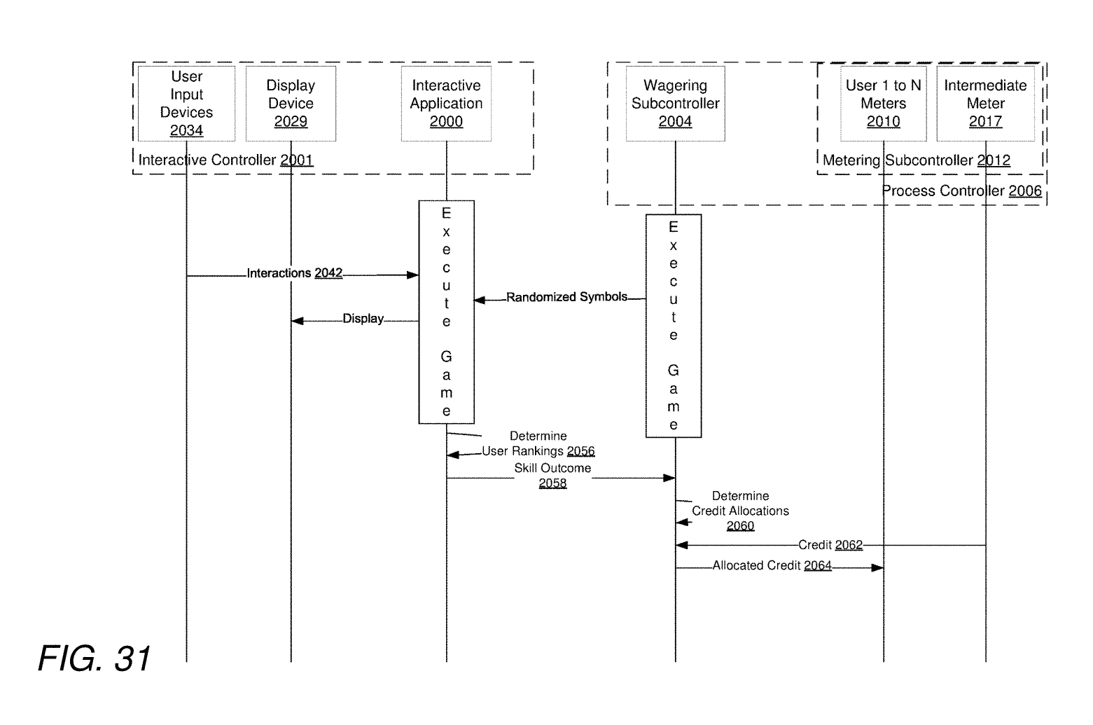

FIG. 31 is a sequence diagram of a wagering and skill competition process of a multi-user dice collection skill competition wagering system in accordance with various embodiments of the invention. In this illustrated embodiments, a random number generator and a paytable are used to determine an amount of credits that two or more users play for when playing a dice collection skill competition game as described herein. An interactive application 2000 executed by an interactive controller 2001 of the multi-user dice collection skill competition wagering system communicates data of a wager initiation request 2002 to a wagering subcontroller 2004 of a process controller 2006. The wagering subcontroller, utilizing a metering subcontroller 2012, decrements 2008 a wagered amount of credit from respective credit meters of one or more users 2010. The wagering subcontroller executes 2014 a chance-based wager of the wagered amount of credit using a random number generator and a paytable to determine a chance-based amount of credit 2016 that is stored in an intermediate credit meter. The chance-based amount of credit is displayed to users utilizing the prize indicator.

The system then executes a dice collection game as described herein.

When the interactive application determines that a stage of the competitive skill proposition is complete, either because the set of symbols to be presented to the users has been depleted, or that each user has filled their respective subset of symbols of the set of symbols, the interactive application then determines a winning subset of symbols by ranking 2056 each subset of symbols and determines a winning subset of symbols as the subset of symbols having the highest ranking. The interactive application of the interactive controller communicates data of the user with the highest ranked subset of symbols to the wagering subcontroller as data of a skill outcome 2058. The wagering subcontroller receives the data of the skill outcome and determines 2060 credit allocations between the two or more users based on the data of the skill outcome. The wagering subcontroller decrements 2062 credits from the intermediate credit meter 2017 and allocates 2064 credits to the credit meters 2010 of the two or more users based on the credit allocations determined from the skill outcome.

In some embodiments, if the dice collection skill competition wagering system detects that there is a tie between users attempting to select the same symbol, the dice collection skill competition wagering system breaks the tie as described herein.

In some embodiments, the paytable is structured such that a minimum credit amount of the chance-based outcome is greater than or equal to the wagered amount of credit taken from a single user, whereby a winning user of the stage of the skill competition will be ensured of winning back at least their wagered amount of credit.

In some embodiments, the prize indicator incorporates a wagering process indicator that indicates that a chance-based wager has been conducted. The indicator includes a circular dial face and a spinner indicator that spins or rotates within the circular face. To indicate that a chance-based wager of credits has been made, the spinner indicator spins or rotates and comes to rest on an amount of credit that a user can win by winning a round of the competitive skill proposition.

The interactive application generates a presentation indicating that the user has won the round of the competitive skill proposition and commands the display device to display the presentation.

In some embodiments, for each other user currently using the multi-user wagering system, each of the other user's avatar's respective damage levels are incremented thus decrementing each other user's avatar's health. If a user's avatar has reached a maximum damage level, the avatar is determined to be destroyed and any credits associated with the destroyed avatar are decremented from the avatar's credit meter and credited or incremented to the credit meter of the user who has won the current stage of the competitive skill proposition.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. A dice collection skill competition wagering system, comprising:
an interactive controller;
a credit processing controller; and
a process controller constructed to communicate with the interactive controller and the credit processing controller,
wherein the interactive controller is constructed to detect a skill outcome of a player's skillful play of a skill-based game based on a player interacting with a user input device, and communicate the skill outcome to the process controller,
wherein the process controller is further constructed to receive the skill outcome,
wherein a metering sub controller is constructed to receive the skill outcome of the player, determine an application state, generate a unique identifier for the player associated with the skill outcome, and communicate the application state and the unique identifier to the process controller,
wherein the process controller is further constructed to receive the application state and the unique identifier, and communicate the application state and the unique identifier to the credit processing controller, and
wherein the credit processing controller is constructed to receive the application state and the unique identifier, and generate a credit output using the application state and the unique identifier.

2. The dice collection skill competition wagering system of claim 1, wherein the interactive controller and the process controller are constructed from the same device.

3. The dice collection skill competition wagering system of claim 1, wherein the process controller is operatively connected to the interactive controller using a communication link.

4. The dice collection skill competition wagering system of claim 1, further comprising:
an enclosure constructed to mount:
a user input device operatively connected to the interactive controller;
a user output device operatively connected to the interactive controller;
a credit input device operatively connected to the process controller; and
a credit output device operatively connected to the process controller

5. The dice collection skill competition wagering system of claim 4, further comprising a random number generator, wherein the process controller is further constructed to:
communicate with the credit input device to receive a credit input;
credit a credit meter with credits based on the incoming credit data;
generate a chance-based component based on a random result generated by the random number generator;
determine a skill proposition based on the chance-based component;
communicate the skill proposition to the interactive controller;
receive a skill outcome from the interactive controller;
update the credit meter based on a chance outcome of the wager; and
communicate with the credit output device to generate a credit output based on credits transferred off of the credit meter, and
wherein the interactive controller is further constructed to:
receive the skill proposition from the process controller;
generate a user presentation based on the skill proposition;
detect user interactions with the user presentation;
determine a skill outcome based on the user interactions and the skill proposition; and
communicate the skill outcome to the process controller.
